(19) United States
(12) Patent Application Publication
(10) Pub. No.: US 2023/0310130 A1
(43) Pub. Date: Oct. 5, 2023

(54) ORAL APPLIANCE ASSEMBLY USING CUSTOM AND NON-CUSTOM TECHNIQUES

(71) Applicant: AirWay Technologies, LLC, Farmers Branch, TX (US)

(72) Inventors: Charles F. COLLINS, Jr., Dallas, TX (US); Alastair E. MCAULEY, Auckland (NZ); W. Keith THORNTON, Dallas, TX (US)

(21) Appl. No.: 18/245,231

(22) PCT Filed: Sep. 27, 2021
(86) PCT No.: PCT/US2021/071605

§ 371 Date: Mar. 14, 2023

Related U.S. Application Data
(60) Provisional application No. 63/085,251, filed on Sep. 30, 2020.
(60) Provisional application No. 63/189,356, filed on May 17, 2021.

(51) Int. Cl. A61C 13/34

(52) U.S. Cl. CPC A61C 13/34

(57) ABSTRACT

A method includes inserting an irradiated, cross-linked thermoplastic polymer into a pressure chamber of a pressure molding machine, positioning an oral model on a molding platform of the pressure molding machine, applying heat using a heat element to soften the thermoplastic polymer, and applying pressure to form the thermoplastic polymer over the oral model to produce a tray. The method also includes scanning the tray to produce a scanned surface and milling a frame based on the scanned surface. The frame includes a channel that fits the tray. The method further includes inserting the tray into the channel of the frame and coupling the tray to the frame.

### CROSS-REFERENCE TO RELATED APPLICATIONS

This application claims priority to and the benefit of U.S. Provisional Patent Application Ser. No. 63/085,251, entitled “Oral Appliance Assembly Using Custom and Non-Custom Techniques” and filed on Sep. 30, 2020, and U.S. Provisional Patent Application Ser. No. 63/189,356, entitled “Oral Appliance Assembly Using Custom and Non-Custom Techniques” and filed on May 17, 2021, both of which are incorporated herein by reference in their entirety.

### TECHNICAL FIELD OF THE INVENTION

This invention relates generally to the assembly of oral appliances (e.g., bruxing guards, mouth guards, whitening trays, etc.).

### BACKGROUND

Many people experience difficulty sleeping because of breathing problems. These problems may result in snoring, or the more serious condition of sleep apnea. One treatment for sleep breathing disorders involves the use of oral appliances for extending forward the lower jaw of the patient. These oral appliances operate to more fully open the breathing passageway, thereby allowing for easier breathing, whether that breathing be through the nose or through the mouth.

These oral appliances may be created in labs after a dentist sends in a patient's dental impressions. The dentist creates a dental impression and then the lab creates the oral appliance after the dentist sends in the dental impression. The lab then sends the oral appliance back to the dentist. In some instances, because the oral appliance was formed using a dental impression rather than the patient's actual teeth, the oral appliance may not fit comfortably over the patient's teeth or within the patient's mouth. Additionally, it can be difficult to adjust the fit of these lab-created oral appliances to the patient because the dentist has few options to reshape the oral appliances.

To avoid the fitting issues with these lab-created devices, dentists and patients have started using another line of devices that can be shaped and fit directly on the patients' teeth. Generally, the devices include a moldable tray coupled to a frame. The dentist puts a device into hot water to soften the moldable tray. Then, the dentist positions the tray and the frame in the patient's mouth. The dentist or the user then applies pressure so that the tray takes on the shape of the user's dentition. This process can be repeated whenever the patient feels that the device needs to be refit. The dentist, however, may not have access to some of the lab machinery, and as a result, the dentist may not be able to perform some processes that can help provide a better fit for the patient.

### SUMMARY OF THE INVENTION

This disclosure contemplates a process for creating an oral appliance that uses techniques employed by labs and techniques employed by dentists. Generally, the process involves forming a thermoplastic polymer over an oral model in a pressure molding machine to produce a tray. The tray and an arch of an oral appliance are then heated, and the tray is inserted into a channel of the arch. The tray and the arch bond such that the tray adheres to the arch within the channel. The oral appliance may then be positioned within a patient's mouth. The arch may even be trimmed according to the patient's gumline for a more comfortable fit.

According to an embodiment, a method includes inserting an irradiated, cross-linked thermoplastic polymer into a pressure chamber of a pressure molding machine and positioning an oral model on a molding platform of the pressure molding machine. The method also includes applying heat using a heat element to soften the thermoplastic polymer and applying pressure to form the thermoplastic polymer over the oral model to produce a tray. The method further includes heating a frame to soften the frame, the frame comprising a channel and inserting the tray into the channel such that the frame adheres to the tray.

According to another embodiment, a method includes applying heat to soften an irradiated, cross-linked thermoplastic polymer positioned in a pressure chamber of a pressure molding machine, forming the softened thermoplastic polymer over an oral model positioned on a molding platform of the pressure molding machine to produce a tray, and inserting the tray into an arch such that the arch adheres to the tray.

According to another embodiment, an apparatus includes a first arch, a first tray, a post, a second arch, a second tray, and a receiving mechanism. The first tray is coupled to the first arch and includes an irradiated, cross-linked thermoplastic polymer shaped according to a first oral model. The post is coupled to the first arch by a snap-fit connector such that the post is rotatable about the snap-fit connector and such that the post extends from the first arch in an anterior direction and an inferior direction when the first arch is positioned in a user's mouth. The second tray is coupled to the second arch and includes an irradiated, cross-linked thermoplastic polymer shaped according to a second oral model. The receiving mechanism extends from the second arch in an anterior direction when the second arch is positioned in the user's mouth. The receiving mechanism engages the post such that the post extends through the receiving mechanism. The post engages an adjustment mechanism when the post is extending through the receiving mechanism such that operating the adjustment mechanism adjusts a forward position of the first arch relative to the second arch when the first arch and the second arch are positioned in the user's mouth.

### BRIEF DESCRIPTION OF THE DRAWINGS

FIG. 1AA is a flowchart of an example process for forming an oral appliance.

FIG. 1AB illustrates an example oral appliance.

FIG. 1AC illustrates an example oral appliance.

FIG. 1AD illustrates an example oral appliance.

FIG. 1AE illustrates an example oral appliance.

FIG. 1 illustrates an example arched frame.

FIG. 2A illustrates an example arched frame comprising an adjustment mechanism.

FIG. 2B illustrates an example arched frame comprising a receiving mechanism.

FIG. 2C illustrates an example arched frame comprising a receiving mechanism.

FIG. 3A illustrates an example arched frame comprising an adjustment mechanism, and an example moldable tray.

FIG. 3B illustrates an example arched frame comprising a receiving mechanism, and an example moldable tray.

FIG. 3C illustrates an example arched frame comprising an adjustment mechanism, and an example moldable tray.

FIG. 3D illustrates an example arched frame comprising a receiving mechanism, and an example moldable tray.

FIG. 4 illustrates an example dental device in a user's mouth.

FIG. 5A illustrates an example universal oral appliance comprising a universal coupler.

FIG. 5B illustrates an example universal oral appliance comprising a universal coupler.

FIG. 5C illustrates an example universal oral appliance comprising a universal coupler.

FIG. 5D illustrates an example universal oral appliance comprising a universal coupler comprising a guided channel.

FIG. 5E illustrates an example universal oral appliance comprising a universal coupler comprising a raised surface.

FIG. 6 illustrates an example universal oral appliance comprising a universal coupler, and an example plurality of dental attachments.

FIG. 7 illustrates an example dental device in a user's mouth.

FIGS. 8A through 8E illustrate an example arched frame.

FIGS. 9A through 9D illustrate an example moldable tray.

FIGS. 10A through 10C illustrate an example arched frame disposed within an example moldable tray.

FIGS. 11A and 11B illustrate an example moldable tray and an example post.

FIG. 12 illustrates example moldable trays, an example post, and an example mask.

FIG. 13 illustrates example moldable trays, an example post, and an example mask.

FIG. 14A illustrates an example post.

FIG. 14B illustrates an example arched frame and tension element.

FIGS. 15A and 15B illustrate example flanges.

FIGS. 16A and 16B illustrate an example post.

FIGS. 17A through 17F illustrate example flanges engaged with an example post.

FIG. 18 illustrates an example post.

FIGS. 19A and 19B illustrate an example mask.

FIG. 20 illustrates an example mask, post, and oral appliance.

FIG. 21A illustrates an example mask and post.

FIG. 21B illustrates an example mask, post, and oral appliance.

FIG. 22A illustrates an example mask including a strap.

FIG. 22B illustrates an example tension element, oral appliance, and mask.

FIGS. 23A and 23B illustrate an example mask comprising a strap.

FIG. 24 illustrates an example tension element, oral appliance, and mask.

FIGS. 25A and 25B illustrate an example mask and adapter.

FIGS. 26A and 26B illustrate an example adapter.

FIG. 27 illustrates an example dental device comprising a universal coupler and an example dental attachment.

FIG. 28 illustrates an example dental device comprising a universal coupler and an example dental attachment.

FIG. 29 illustrates an example arch comprising a dental attachment.

FIG. 30 illustrates an example arch comprising a tension element.

FIG. 31 illustrates an example dental device comprising a dental attachment and a tension element.

FIG. 32 illustrates an example dental attachment and tension element.

FIG. 33 illustrates an example dental device in a user's mouth.

FIG. 34 illustrates an example process for creating a dental device.

FIG. 35 illustrates a top view of a thermoplastic polymer disk, according to one embodiment.

FIGS. 36 and 37 illustrate a front view of a pressure molding machine at a first and a second stage of a molding process, according to certain embodiments.

FIG. 38 illustrates an isometric view of the pressure molding machine of FIGS. 36 and 37 at a third stage of a molding process, according to certain embodiments.

FIGS. 39A-C illustrate a seal.

FIGS. 40A-D show a seal and an oral appliance.

FIG. 41 shows an oral appliance.

FIGS. 42A through 42K illustrate an example oral appliance and/or components of the example oral appliance.

FIG. 43 is a flowchart of an example method.

### DETAILED DESCRIPTION OF THE INVENTION

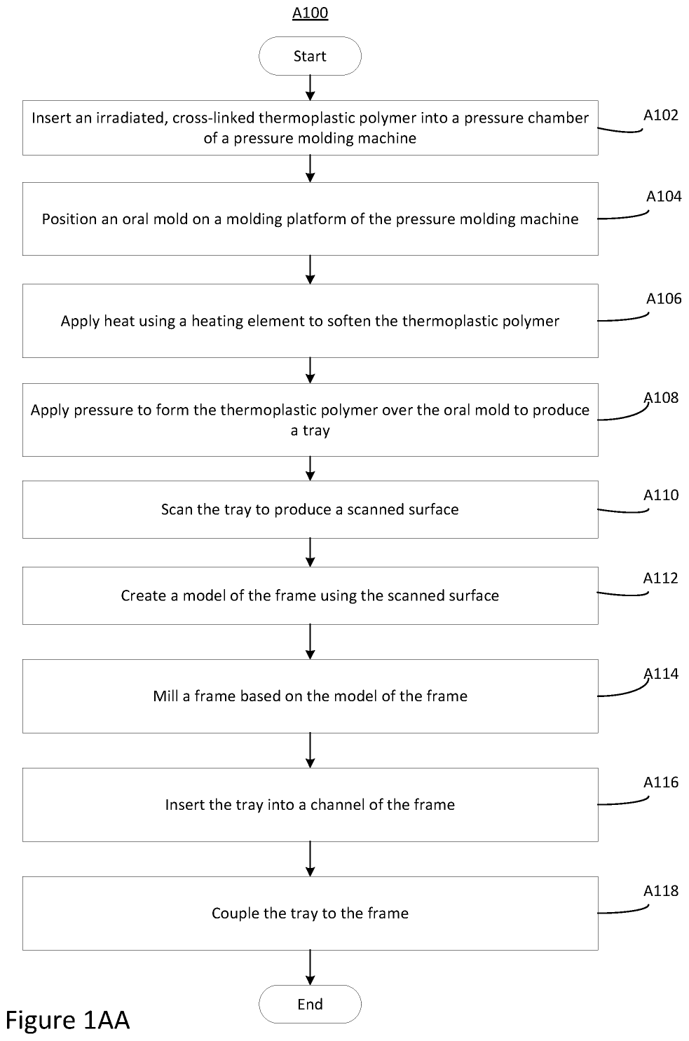

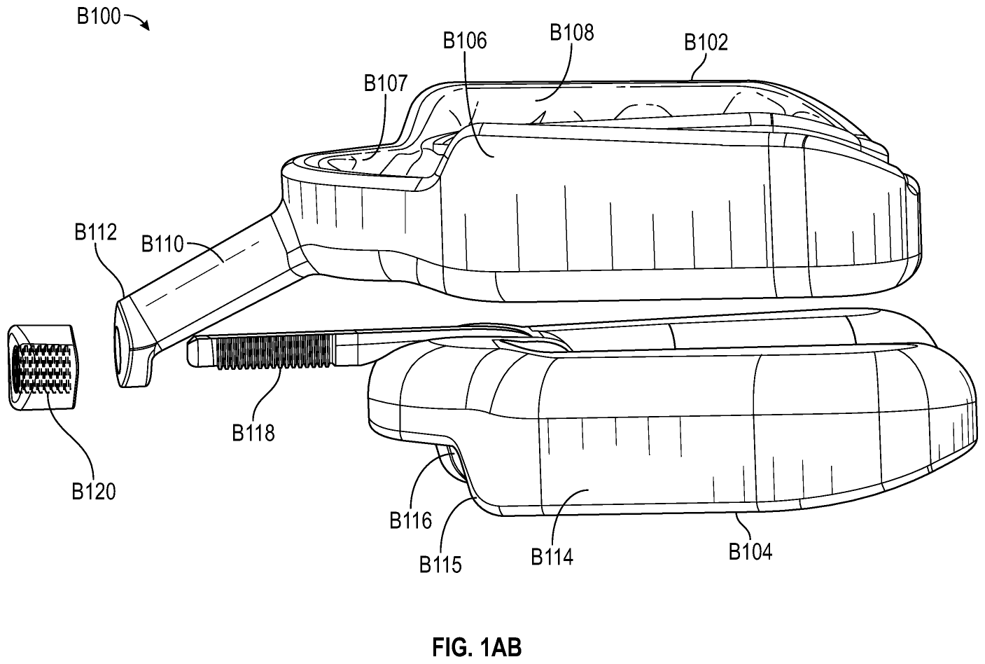

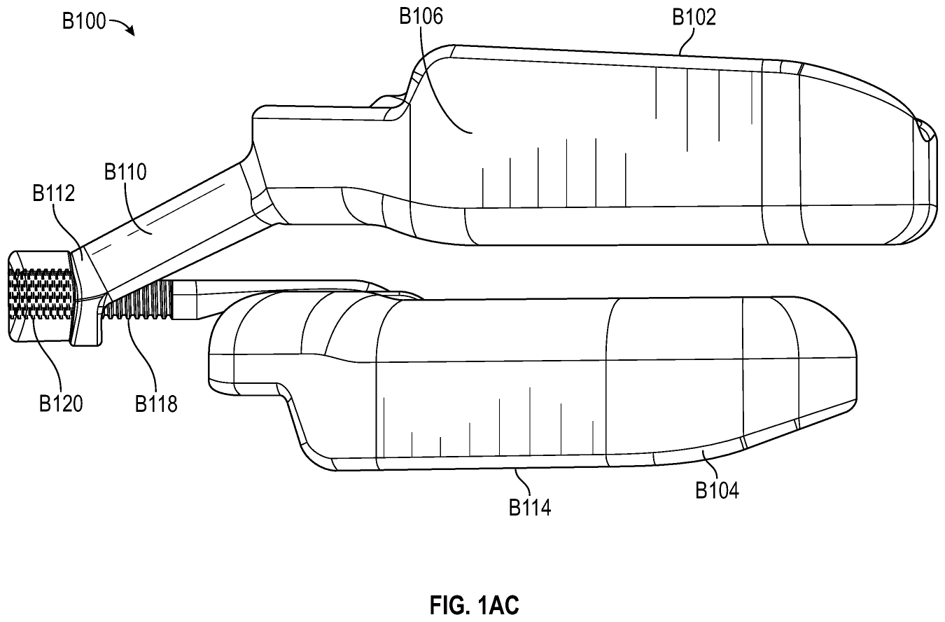

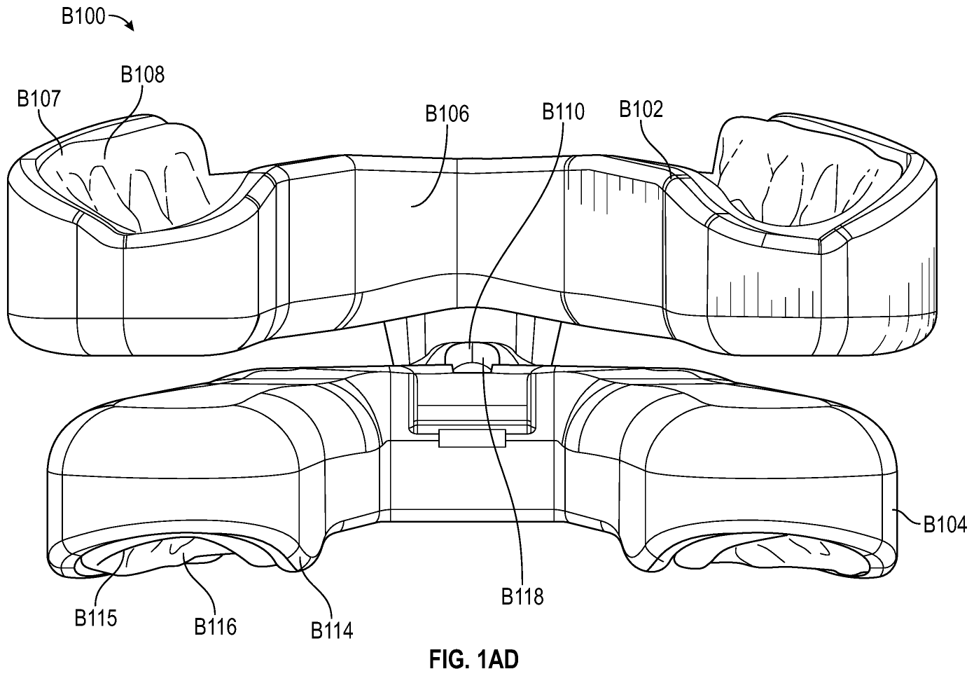

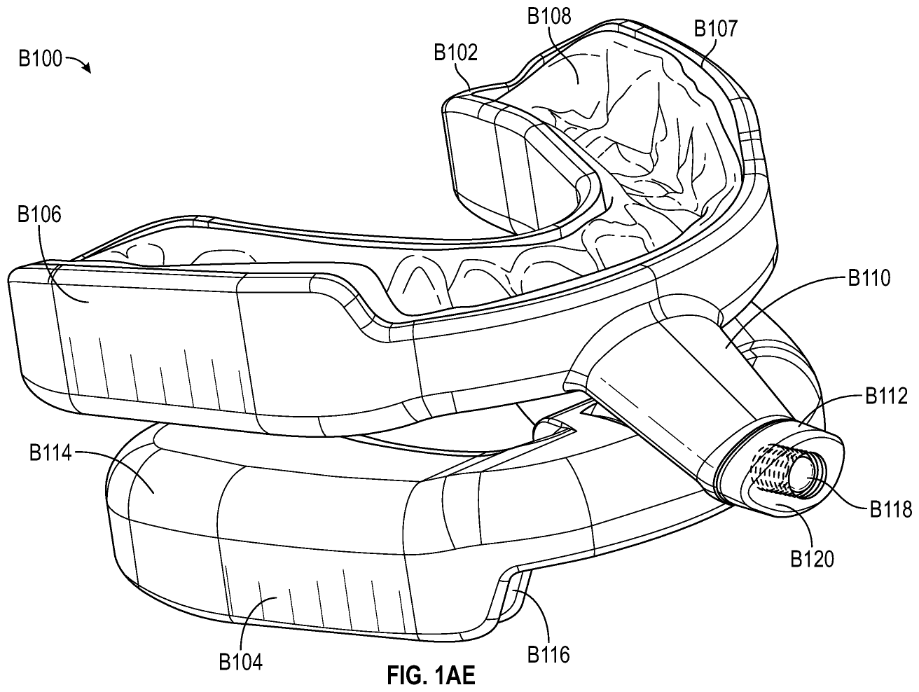

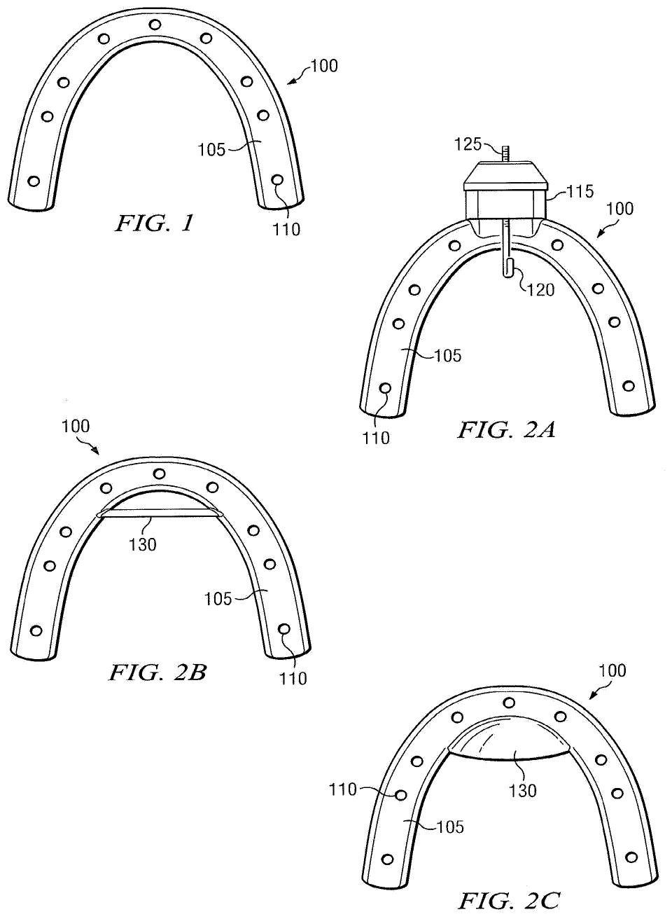

FIG. 1AA is a flowchart illustrating an example process A100 for forming an oral appliance. Generally, process A100 may be performed by an operator in a dental lab or dentist office. In particular embodiments, the oral appliance resulting from process A100 has improved stain resistance and durability and can be easily reshaped or refit to a user's teeth.

In step A102, the operator inserts an irradiated, cross-linked thermoplastic polymer into a pressure chamber of a pressure molding machine. The thermoplastic polymer may be polycaprolactone (PCL) and may soften to be moldable when heated to between 40 and 80 degrees Celsius. The thermoplastic polymer may be in the form of a disk or a sheet with a thickness between 0.5 mm and 2.0 mm. In step A104, the operator positions an oral model on a molding platform of the pressure molding machine. The oral model may be a mold of a user's teeth or dentition. The oral model may be created by a dentist taking the user's dental impression. Alternatively, the oral model may be created by a dental lab shaping plaster based on a dental impression. The oral model may be cast or printed.

In step A106, the operator applies heat using a heating element to soften the thermoplastic polymer. The operator then applies pressure (e.g., through vacuum or blowdown) on the thermoplastic polymer to form the thermoplastic polymer over the oral model to produce a tray in step A108. In this manner, the thermoplastic polymer is shaped to fit over the oral model of the user's dentition to form the tray.

In step A110, the operator scans the tray to produce a scanned surface. For example, the operator may use a camera to perform a scanning technique to form a three-dimensional, digital scan or model of the tray. The scan or model may be of an occlusal surface of the tray (e.g., a non-teeth contacting surface of the tray). The operator then takes the scanned surface and creates a model of a frame using the scanned surface in step A112. For example, the model of the frame may be created in a software application like 3Shape Appliance Designer. The model of the frame may include features that accommodate the tray. For example, the frame may include a channel in which the tray may be inserted. As another example, the shape and size of the frame and/or channel may be customized to fit the tray.

The operator then mills a frame based on the scanned surface in step A114. The frame may be milled from any suitable material such as polycarbonate. The frame may include a channel that is sized to fit the tray. The scanned surface is used to determine the size and shape of the channel and the frame so that they are properly sized to fit the tray. The channel may cover all or most of the outer tray surface. In some embodiments, the channel may be minimal and not contact all or most of the outer tray surface. For example, the channel may include side walls in some but not all locations along the tray to provide support for the tray. In this manner, the channel is open along certain areas of the tray, which reduces the weight and bulk of the frame.

The operator then inserts the tray into the channel in step A116 and couples the tray to the frame in step A118. For example, the operator may bond the tray to the frame using an adhesive. As a result of using the thermoplastic tray and the milled frame, the resulting oral appliance has improved durability and stain resistance while allowing a user to reshape or refit the oral appliance easily. For example, the user may place the oral appliance into hot water to soften the thermoplastic tray. The user then may position the oral applicant in the user's mouth and apply pressure to reshape or refit the oral appliance to the user's teeth.

FIG. 1AB illustrates an example oral appliance B100 that was formed using the process A100 of FIG. 1AA. As seen in FIG. 1AB, oral appliance B100 includes an upper arch B102 and a lower arch B104. The upper arch B102 and the lower arch B104 may be coupled together to form the oral appliance B100. The oral appliance B100 may be positioned in a user's mouth to adjust a forward position of the user's jaw. In certain embodiments, by adjusting the user's jaw forward, the oral appliance B100 opens the user's air passages, which treats snoring and/or sleep apnea.

The upper arch B102 includes a frame B106, a tray B108, and a receiving mechanism B110. The tray B108 is set within a channel B107 within the frame B106. The receiving mechanism B110 is coupled to the frame B106 along a midline of the frame B106 such that the receiving mechanism B110 extends from the frame B106 in an anterior direction when the oral appliance B100 and/or upper arch B102 is positioned within a user's mouth.

The lower arch B104 includes a frame B114, a tray B116, and a post B118. The tray B116 is set within a channel B115 within the frame B114. The post B118 includes a threaded portion. The post B118 may be coupled to the frame B114 after the frame B114 and/or the tray B116 have been formed. For example, the post B118 may be snapped onto a portion of the frame B114 after the frame B114 and/or tray B116 have been formed.

The upper arch B102 may couple to the lower arch B104 by engaging the post B118 with a ring B112 of the receiving mechanism B110 such that the post extends through the ring B112 and/or the receiving mechanism B110. As seen in FIG. 1AB, the ring B112 is positioned at an end of the receiving mechanism B110 opposite the frame B106. A forward position of the lower arch B104 relative to the upper arch B102 may be adjusted by extending more or less of the post B118 through the ring B112.

An adjustment nut B120 may be coupled to the threaded portion of the post B118 to prevent the post B118 from disengaging the ring B112 and/or receiving mechanism B110. Turning the adjustment nut B120 may adjust a position of the adjustment nut B120 on the post B118 such that more or less of the post B118 extends through the adjustment nut B120. In this manner, more or less of the post B118 extends through the receiving mechanism B110 and/or ring B112, and the forward position of the lower arch B104 relative to the upper arch B102 is adjusted.

As discussed above, the trays B108 and B116 may be formed by heating a thermoplastic polymer and then forming the thermoplastic polymer over a mold of a user's teeth using a pressure molding machine. As seen in FIG. 1AB, the trays B108 and B116 are shaped to receive a user's dentition or teeth. After the trays B108 and B116 are formed, the trays B108 and B116 are scanned to form digital scans of the trays. A milling machine then mills the frames B106 and B114 based on the digital scans. For example, the milling machine may shape and size the frames B106 and B114 and the channels B107 and B115 in the frames B106 and B114. By using the digital scans, the channels B107 and B115 and the frames B106 and B114 may be milled to fit the trays B108 and B116. After the frames B106 and B114 are milled, the trays B108 and B116 are inserted into the channels B107 and B115. For example, the tray B108 may be inserted into the channel B107 and the tray B116 may be inserted into the channel B115. An adhesive may be applied to bond the trays B108 and B116 to the channels B107 and B115 and the frames B106 and B114.

In certain embodiments, the frames B106 and B114 may be formed using a hard material such as polycarbonate that does not soften like the thermoplastic in the trays B108 and B116 when heated to between 40 and 80 degrees Celsius. As a result, a user can reshape one or more of the trays B108 and B116 without affecting the shape and size of the frames B106 and B114 by placing one or more of the arches B102 and B104 into hot water. Because the thermoplastic is cross-linked, the trays B108 and B116 may return to a partially smooth or uncustomized state (e.g., not customized for any user's dentition or teeth) when heated. After one or more of the trays B108 and B116 soften, the user positions one or more of the arches B102 and B104 inside the user's mouth and applies pressure to reshape or refit one or more of the trays B108 and B116 to the user's teeth.

FIG. 1AC illustrates a side view of the example oral appliance B100 of FIG. 1AB with the upper arch B102 and the lower arch B104 coupled together. FIG. 1AD illustrates a back view of the example oral appliance B100 of FIG. 1AB with the upper arch B102 and the lower arch B104 coupled together. FIG. 1AE illustrates an isometric view of the example oral appliance B100 of FIG. 1AB with the upper arch B102 and the lower arch B104 coupled together. As discussed previously and as seen in FIGS. 1AC, 1AD, and 1AE, the upper arch B102 and the lower arch B104 couple together by engaging post B118 with the receiving mechanism B110 and/or the ring B112 such that the post B118 extends through the receiving mechanism B110 and/or the ring B112. The adjustment nut B120 then couples to a threaded portion of the post B118 to prevent the post B118 from disengaging the receiving mechanism B110 and/or the ring B112. Turning the adjustment nut B120 adjusts a position of the adjustment nut B120 on the post B118. In this manner, how far the post B118 extends through the receiving mechanism B110 and/or the ring B112 can be adjusted, which adjusts a forward position of the lower arch B104 relative to the upper arch 1042. As a result, the forward position of a user's jaw can be adjusted when the oral appliance B100 is positioned in the user's mouth.

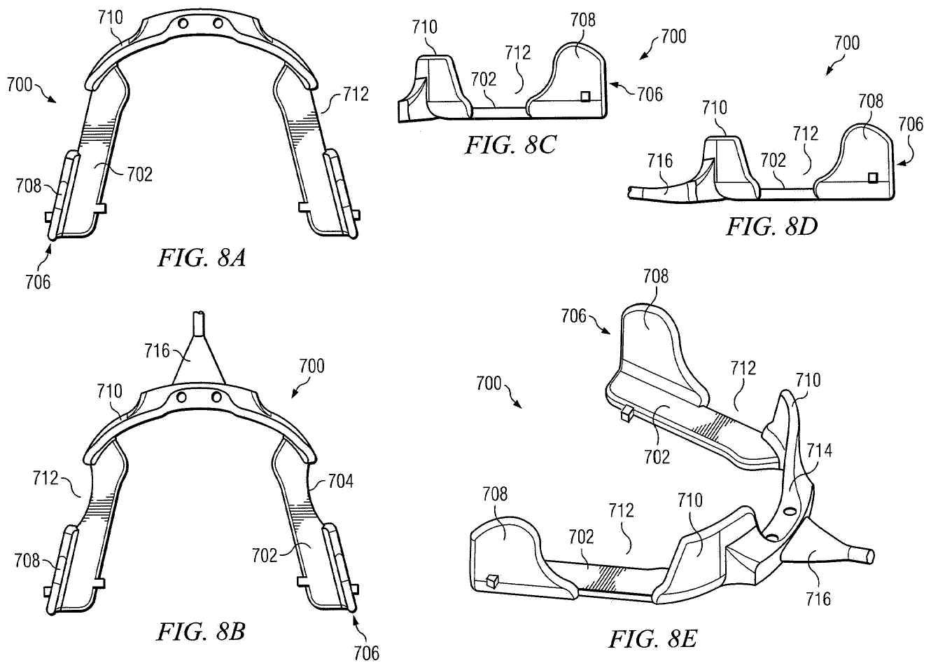

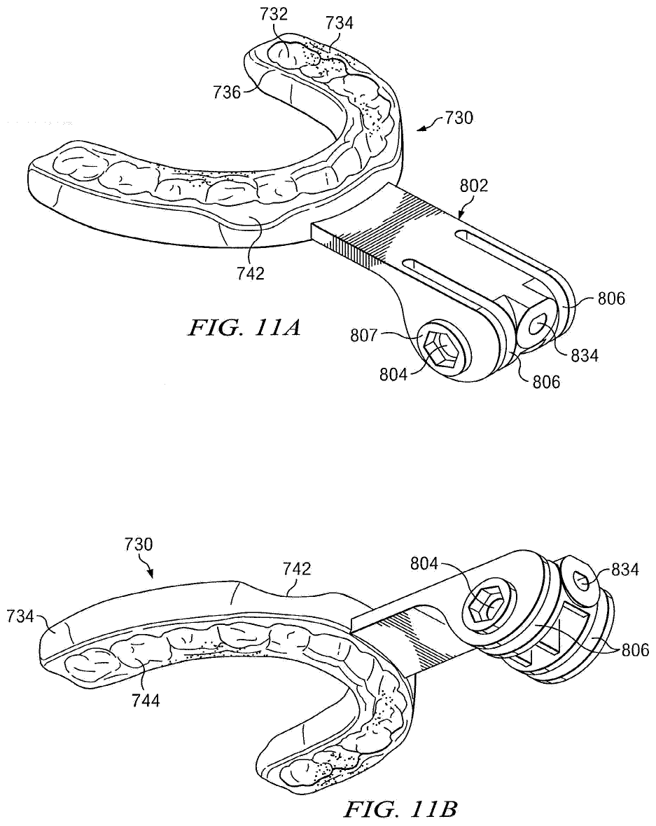

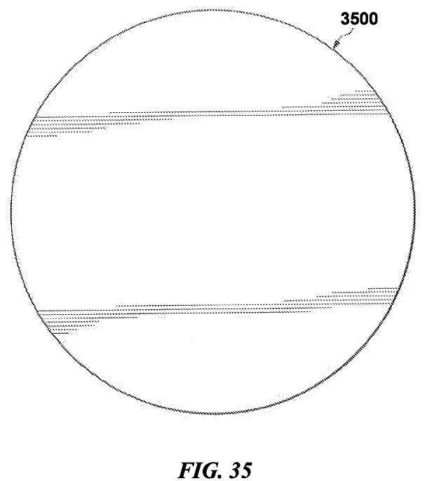

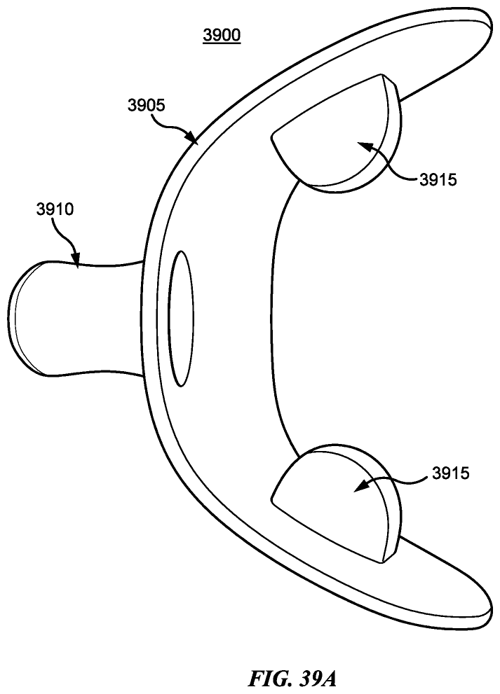

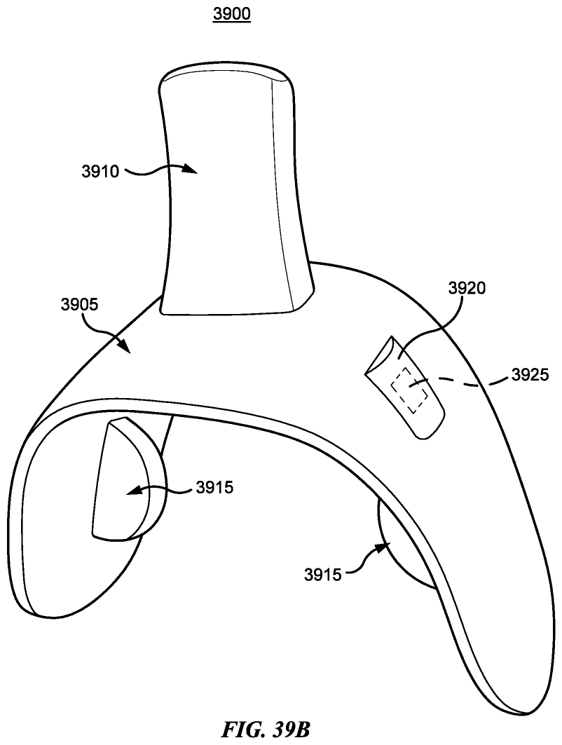

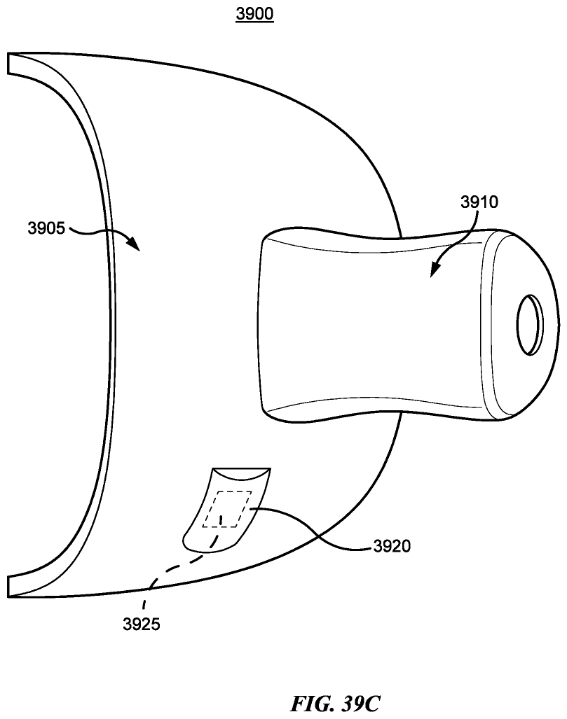

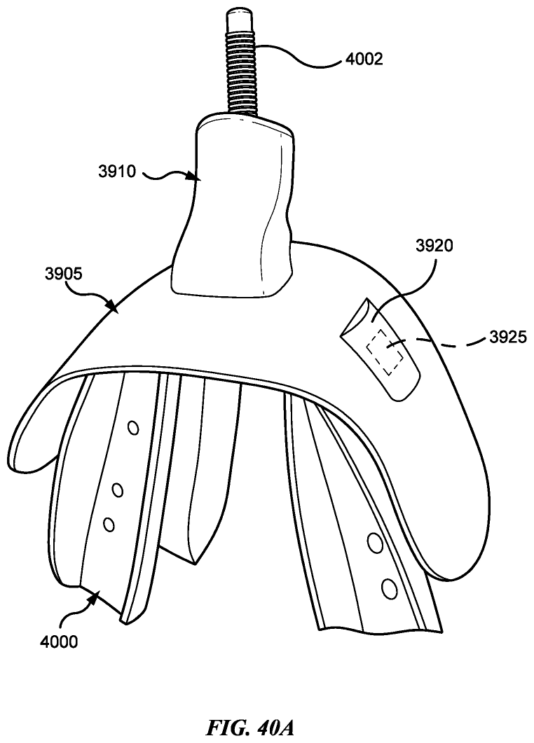

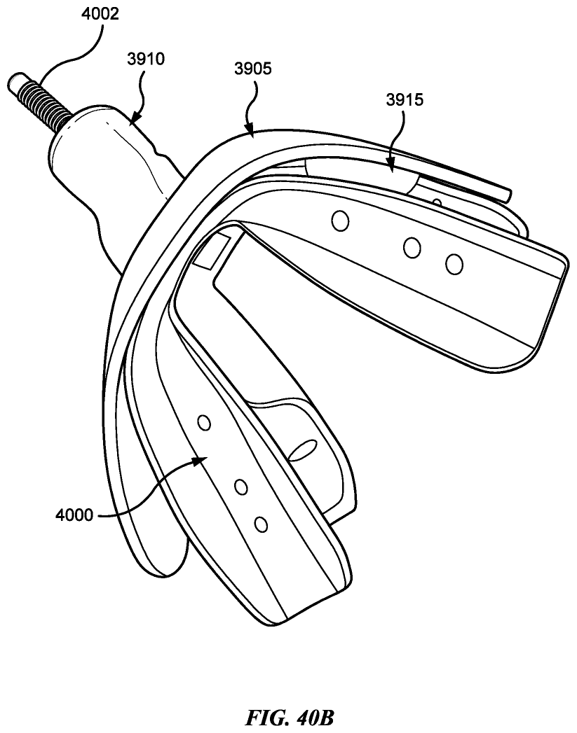

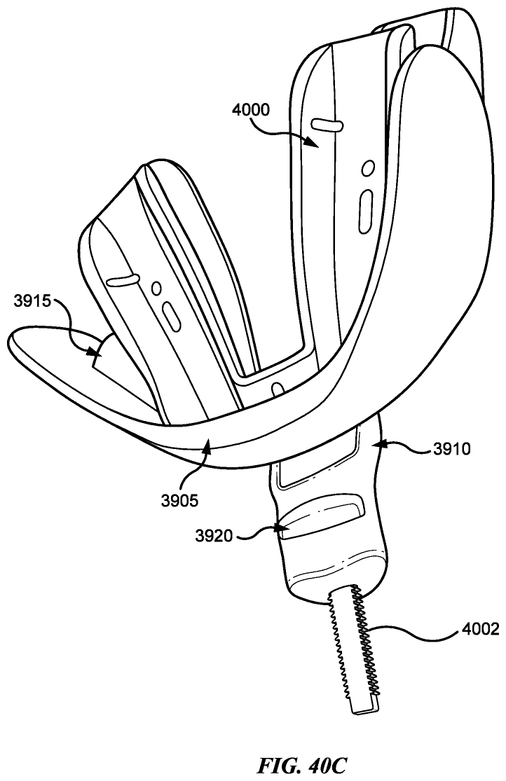

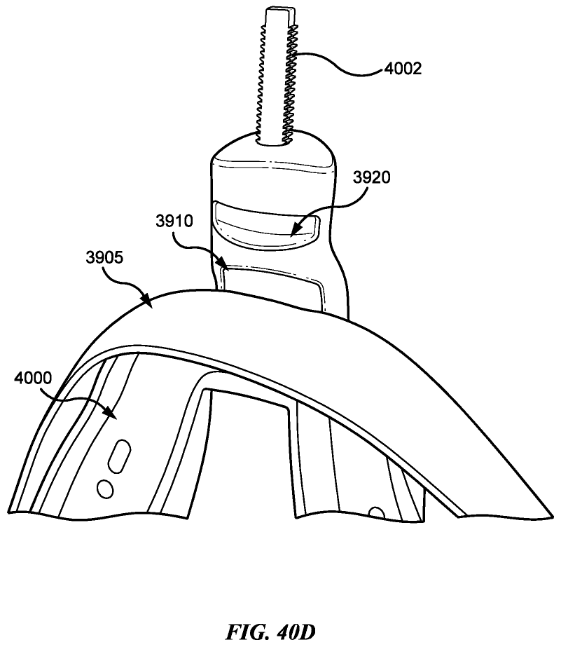

Examples of the arch B102, arch B104, and/or oral appliance B100 along with various details, features, and enhancements are provided in the subsequent figures. Although the item labels in the subsequent figures may differ from those in FIGS. 1AA, 1AB, 1AC, 1AD, and 1AE, it should be understood that the structures discussed in the subsequent figures may be the same as the structures discussed in FIGS. 1AA, 1AB, 1AC, 1AD, and 1AE. For example FIGS. 8A-8E illustrate embodiments of the milled frames B106 and B114. As another example, FIGS. 11A-21B illustrate embodiments of the receiving mechanism B110 and post B118, which may be configured to couple the oral appliance B100 to a mask to deliver gas to the user. These embodiments show how the mask couples to the oral appliance B100, specifically using the example receiving mechanism B110 and post B118. As another example, FIGS. 35-38 show embodiments of how the trays B108 and B116 are formed, specifically using a pressure molding machine. As yet another example, FIGS. 39A-41 illustrate embodiments of the oral appliance B100 that include a seal. As seen in those figures, the seal can engage the post B118 and/or receiving mechanism B110 of the oral appliance B100. The seal can be positioned in the oral vestibule of the user to inhibit breathing through the user's mouth.

FIG. 1 illustrates an example arched frame 100. Arched frame 100 may comprise an arched body 105 that defines a plurality of apertures 110 through arched frame 100. In particular embodiments, arched frame 100 may be configured to be positioned proximate to the occlusal surface of a user's dental arch. In some embodiments, arched frame 100 may extend beyond the cuspids of the user's dental arch when arched frame 100 is inserted in the user's mouth. In some embodiments, arched frame 100 may have a consistent thickness between 1.5 and 2 millimeters. FIG. 2A illustrates an example arched frame comprising an adjustment mechanism. As shown in FIG. 2A, an arched frame 100 is provided comprising an arched body 105 defining a plurality of apertures 110 and an adjustment mechanism 115. In particular embodiments, arched body 105 may define a plurality of grooves, or a slot. Adjustment mechanism 115 may be coupled to arched body 105 along the midline of arched frame 100. In certain embodiments, Adjustment mechanism 115 may comprise a hook 120 and a threaded adjustor 125. FIGS. 2B and 2C illustrate arched frames each comprising a receiving mechanism. As shown in FIGS. 2B and 2C, an arched frame 100 is provided comprising an arched body 105 defining a plurality of apertures 110 and a receiving mechanism 130. In particular embodiments, receiving mechanism 130 may be a bar spanning a portion of the arch of arched body 105. In other embodiments, receiving mechanism 130 may be a surface coupled to the lingual portion of arched frame 100. In some embodiments, the surface may be rounded.

In particular embodiments, arched frame 100 may be formed from any material suitable for dental uses, for example, a hard plastic. Arched frame 100 may be formed from poly methyl methacrylate or a polycarbonate resin thermoplastic such as that sold under the Registered Trademark Lexan. Such materials are known to those familiar with dental devices, and other suitable materials may be used to form arched frame 100 without departing from the intended scope of the present invention. Poly(methyl methacrylate) ((C₅O₂H₈)ₙ), also known as acrylic, acrylic glass, or plexiglass, as well as by the trade names Crylux, Plexiglas, Acrylite, Astariglas, Lucite, Perclax, and Perspex, among several others, is a transparent thermoplastic often used in sheet form as a lightweight or shatter-resistant alternative to glass. It may have a density around 1.18 g/cm³ and a melting point around 160 degrees Celsius. It has an IUPAC ID of Poly(methyl 2-methylpropenoate) and has a refractive index around 1.4905 at 589.3 nm.

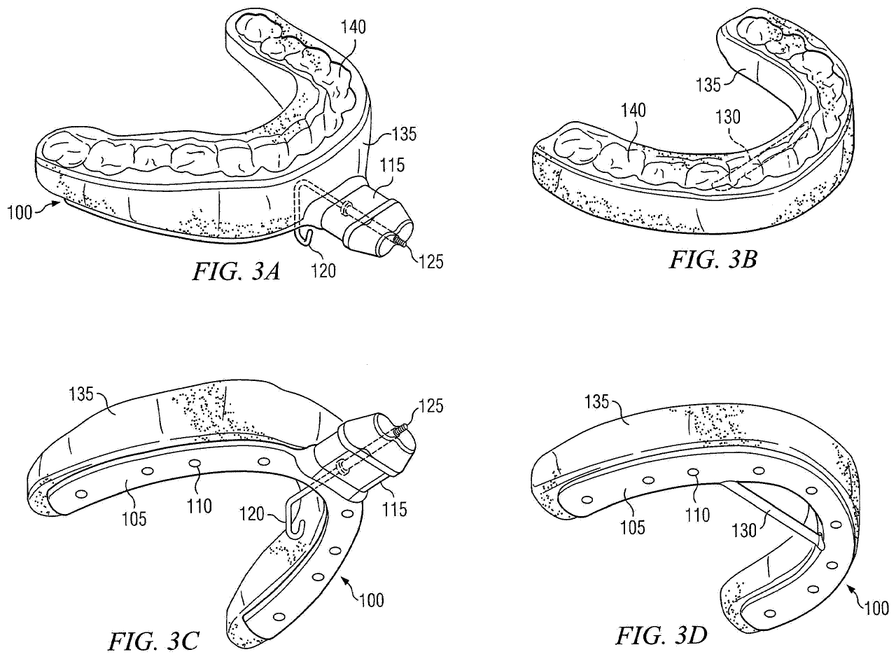

FIGS. 3A and 3C illustrate example arched frames each comprising an adjustment mechanism and example moldable trays. As shown in FIGS. 3A and 3C, an arched frame 100 and a moldable tray 135 are provided. Arched frame 100 may comprise an arched body 105 defining a plurality of apertures 110 and an adjustment mechanism 115. Moldable tray 135 may be coupled to arched frame 100 and may engage the plurality of apertures 110. In particular embodiments, moldable tray 135 may form through plurality of apertures 110 to couple to two sides of arched body 105. In some embodiments, moldable tray 135 may form into a plurality of grooves defined by arched body 105. In some embodiments, moldable tray 135 may be secured to arched frame 100 by forming through a slot defined by arched body 105. Moldable tray 135 may further comprise a channel 140 that is configured to engage at least some of a user's dental arch. In particular embodiments, channel 140 may engage the incisors and cuspids of the user's dental arch. In some embodiments, channel 140 may engage the incisors, cuspids, and some of the molars of the user's dental arch. In some embodiments, channel 140 may engage the incisors, cuspids, and all the molars of the user's dental arch. In particular embodiments, channel 140 may be shaped to conform to a generic user's teeth. In other embodiments, channel 140 may be a smooth channel that covers a user's teeth. In particular embodiments, channel 140 may be further shaped to conform to a particular user's teeth.

In particular embodiments, moldable tray 135 (e.g., trays B108 and B116) may comprise a polycaprolactone polymer or other aliphatic polyester. One or more of the polycaprolactone polymers may have the formula:

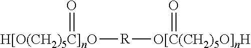

where R is an aliphatic hydrocarbon and n may range from approximately 300 to approximately 650. Certain embodiments may utilize polycaprolactone polymers using other suitable formulas. One particular embodiment may utilize Nylon.

Moldable tray 135 (e.g., trays B108 and B116) may include any suitable polycaprolactone polymer or other aliphatic polyester, for example, and not by way of limitation, the TONE P 700, TONE P 767, or TONE P 787 polycaprolactone polymers manufactured by Union Carbide Corporation, taken singly or in any combination. A suitable light cured material, another polymer, or any other suitable material, such as a filler, coloring agent, stabilizer, antioxidant, or antimicrobial agent, may be used to replace or combine with one or more of the polycaprolactone polymers in forming a deformable material 20 having any number of characteristics, properties, or uses.

The TONE polycaprolactone polymers are described in U.S. Pat. Nos. 5,112,225 and 4,784,123, and in literature distributed by Union Carbide Corporation, as homopolymers, block copolymers, graft copolymers, or other polymers that contain epsilon caprolactone. Polymerization may be initiated using one or more diols, for example, and not by way of limitation, ethylene glycol; diethylene glycol; neopentyl glycol; butane diol; hexane diol; or any other suitable diol.

In particular embodiments, moldable tray 135 (e.g., trays B108 and B116) may be custom molded to a user's teeth. For example, moldable tray 135 may comprise a material that is moldable when heated. Once heated, the material may be pressed around a user's dental arch to form a moldable tray 135 that conforms to the user's teeth. In particular embodiments, moldable tray 135 may be used with arched frame 100 to form a custom dental device. For example, arched frame 100 may comprise a hard plastic material. When moldable tray 135 is forming around a user's teeth, arched frame 100 may be pressed against moldable tray 135, so that mold tray 135 forms through plurality of apertures 110 defined by arched body 105. As moldable tray 135 cools and hardens, moldable tray 135 may couple to arched frame 100 through plurality of apertures 110. In some embodiments, moldable tray 135 may couple to arched frame 100 through a slot or by forming into a plurality of grooves. In particular embodiments, arched frame 100 may provide structural support for moldable tray 135 as moldable tray 135 engages the user's teeth. For example, as moldable tray 135 engages the user's teeth, arched frame 100 may prevent moldable tray 135 from deforming or shifting under the stresses caused by movement of the user's mouth.

In particular embodiments, a custom dental device may comprise arched frame 100 and moldable tray 135. A dentist may be able to construct the custom dental device for a patient without having to send the patient's dental impressions to a lab. The dentist may heat moldable tray 135 and press moldable tray 135 around the user's teeth. The dentist may then press arched frame 100 against moldable tray 135 to construct the custom dental device. As a result, the patient may not have to wait for the lab to create the dental device, nor does the patient have to pay an extra fee charged by the lab.

FIGS. 3B and 3D illustrate example arched frames each comprising a receiving mechanism, and example moldable trays. As shown in FIGS. 3B and 3D, an arched frame 100 and a moldable tray 135 are provided. Arched frame 100 may comprise an arched body 105 defining a plurality of apertures 110 and a receiving mechanism 130. Receiving mechanism 130 may be coupled to arched body 105. In particular embodiments, receiving mechanism 130 may be a bar that spans a portion of the arch of arched body 105. Moldable tray 135 may comprise a channel 140 that is configured to engage at least some of the teeth of a user's dental arch.

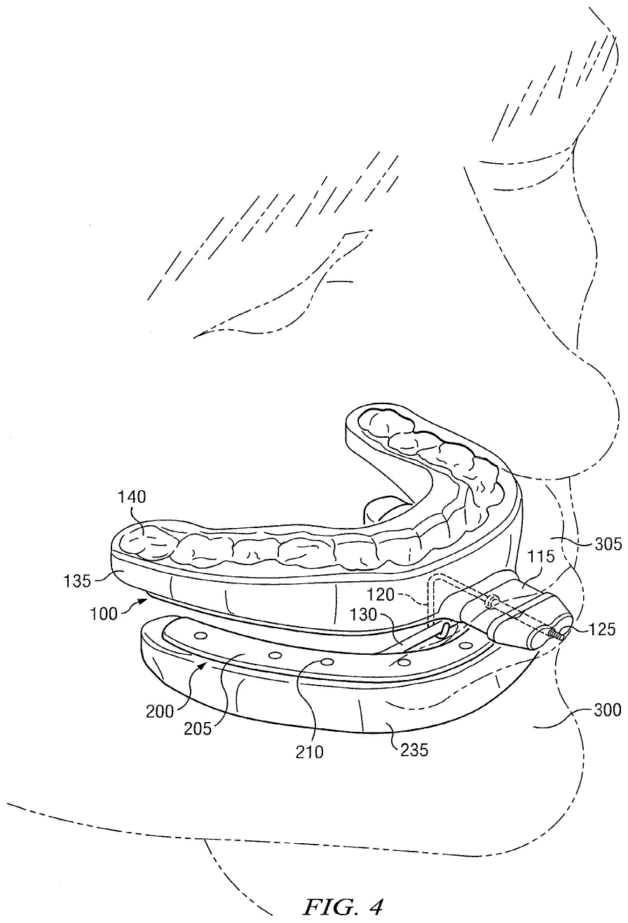

FIG. 4 illustrates an example dental device in a user's mouth. As shown in FIG. 4, a dental device is provided that comprises an arched frame 100, a moldable tray 135, a second arched frame 200, and a second moldable tray 235. Arched frame 100 may comprise an adjustment mechanism 115 that comprises a hook 120 and a threaded adjustor 125. Moldable tray 135 may be coupled to arched frame 100. Moldable tray 100 may comprise a channel 140. In some embodiments, channel 140 may be shaped to conform to a generic user's maxillary arch 305. In other embodiments, channel 140 may be a smooth channel that covers some of teeth of a user's maxillary arch 305. In particular embodiments, channel 140 may be further shaped to conform to a particular user's maxillary arch 305. Second arched frame 200 may comprise a second arched body 205 defining a second plurality of apertures 210. Second arched frame 200 may further comprise a receiving mechanism 130 coupled to the lingual portion of second arched body 205. In some embodiments, receiving mechanism 130 may be a bar that spans a portion of the arch of second arched body 205. Second moldable tray 235 may be coupled to second arched frame 200 and may engage second plurality of apertures 210. Second moldable tray 235 may be configured to engage some of the teeth of the user's mandibular arch 300. In particular embodiments, hook 120 may engage receiving mechanism 130. Threaded adjustor 125 may be used to adjust the forward position of arched frame 100 relative to second arched frame 200. The relative positions of the two arched frames 100 and 200 may adjust the position of the user's maxillary arch 305 relative to the user's mandibular arch 300. In some embodiments, the relative position of the user's maxillary and mandibular arches may help to improve a user's breathing and/or prevent the user from snoring while sleeping.

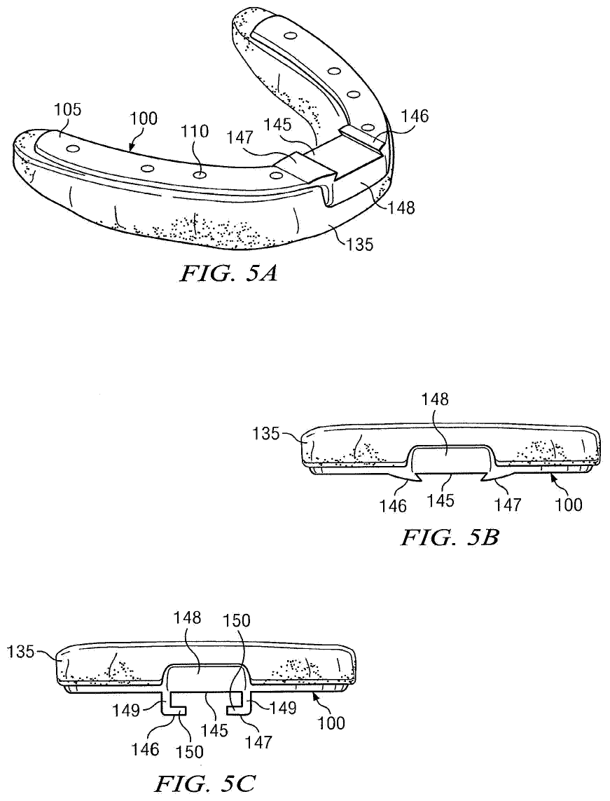

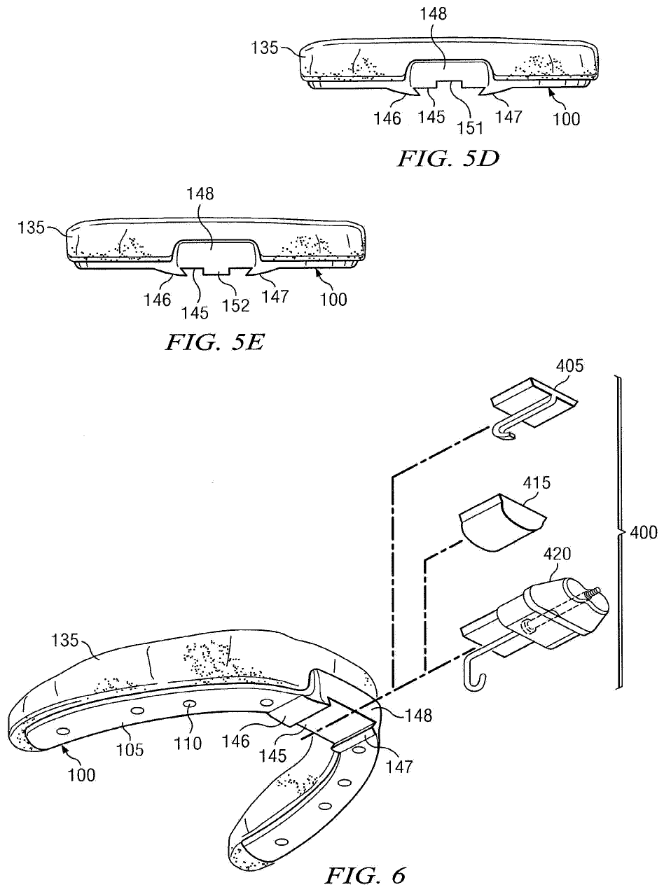

FIGS. 5A and 5B each illustrate an example universal oral appliance comprising a universal coupler. As shown in FIGS. 5A and 5B, a universal oral appliance is provided comprising an arched frame 100 and a moldable tray 135 coupled to arched frame 100. Arched frame 100 may comprise an arched body 105 defining a plurality of apertures 110. In particular embodiments, arched frame 100 may be configured to be positioned proximate to the occlusal surface of a user's dental arch such that arched frame 100 extends beyond the cuspids of the user's dental arch when arched frame 100 is inserted in the user's mouth. Arched frame 100 may have a midline that aligns substantially with the anterior midline of the user's mouth when arched frame 100 is inserted in the user's mouth. Arched frame 100 may further comprise a universal coupler. In particular embodiments, the universal coupler may comprise a substantially planar surface 145, a first rail 146, and a second rail 147. Substantially planar surface 145 may be proximate to and extend across the midline of arched frame 100. In particular embodiments, substantially planar surface 145 may be configured to be positioned proximate to the occlusal surface of a user's incisors when the universal oral appliance is inserted in the user's mouth. First rail 146 may be coupled to a first end of substantially planar surface 145. In particular embodiments, first rail 146 may be distal to the midline of arched frame 100. In other embodiments, first rail 146 may be anterior to arched frame 100. Second rail 147 may be coupled to a second end of substantially planar surface 145. In particular embodiments, second rail 147 may be distal to the midline of arched frame 100. In other embodiments, second rail 147 may be posterior to arched frame 100. First rail 146 and second rail 147 may form an acute angle with substantially planar surface 145. In particular embodiments, first rail 146, second rail 147, and substantially planar surface 145 may define a slot. In particular embodiments, a dental attachment may slide into the slot and engage arched frame 100. In some embodiments, the universal coupler may comprise a locking mechanism (such as, for example, a screw, a tab, or a groove). The screw may secure a dental attachment to the universal coupler by screwing through the dental attachment and into the universal coupler. The tab may secure the dental attachment by engaging the exterior of the dental attachment or by engaging a slot in the dental attachment. The groove may secure the dental attachment by frictionally engaging the dental attachment. In particular embodiments, the universal coupler may further comprise a stop 148 coupled to substantially planar surface 145. Stop 148 may be coupled to the labial or lingual ends of substantially planar surface 145. Alternatively, stop 148 may be coupled to a distal end of substantially planar surface 145. Although this disclosure describes a universal oral appliance comprising arched frame 100, moldable tray 135, and a universal coupler coupled to arched frame 100, this disclosure contemplates a one-piece universal oral appliance and a universal coupler coupled to the universal oral appliance.

FIG. 5C illustrates an example universal oral appliance comprising a universal coupler. As shown in FIG. 5C, a universal oral appliance is provided comprising an arched frame 100 and a moldable tray 135 coupled to arched frame 100. Arched frame 100 may comprise a universal coupler comprising a substantially planar surface 145, a first rail 146, a second rail 147, and a stop 148. In particular embodiments, each rail 146 and 147 may comprise a first segment 149 and a second segment 150. First segment 149 may be coupled at a first end to substantially planar surface 145, and second segment 150 may be coupled to a second end of first segment 149. In particular embodiments, first segment 149 and second segment 150 may be substantially perpendicular to each other.

FIG. 5D illustrates an example universal oral appliance comprising a universal coupler comprising a guided channel. As shown in FIG. 5D, a universal oral appliance is provided comprising an arched frame 100 and a moldable tray 135. Arched frame 100 may comprise a universal coupler comprising a substantially planar surface 145, a first rail 146, a second rail 147, and a stop 148. First rail 146, second rail 147, and substantially planar surface 145 may define a slot. In particular embodiments, the universal coupler may further comprise a guided channel 151. Guided channel 151 may be configured to guide a dental attachment through the slot.

FIG. 5E illustrates an example universal oral appliance comprising a universal coupler comprising a raised surface 152. As shown in FIG. 5E, a universal oral appliance is provided comprising an arched frame 100 and a moldable tray 135. Arched frame 100 may comprise a universal coupler comprising a substantially planar surface 145, a first rail 146, a second rail 147, and a stop 148. First rail 146, second rail 147, and substantially planar surface 145 may define a slot. In particular embodiments, the universal coupler may further comprise a raised surface 152. Raised surface 152 may be configured to guide a dental attachment through the slot. In particular embodiments, raised surface 152 may be further configured to secure or lock the dental attachment.

FIG. 6 illustrates an example universal oral appliance comprising a universal coupler, and an example plurality of dental attachments 400. As shown in FIG. 6, an example universal oral appliance is provided that comprises an arched frame 100 and a moldable tray 135. Arched frame 100 comprises an arched body 105 that defines a plurality of apertures 110. Arched frame 100 further comprises a universal coupler. The universal coupler may comprise a substantially planar surface 145, a first rail 146, a second rail 147, and a stop 148. In particular embodiments, first rail 146, second rail 147, and substantially planar surface 145 may define a slot. FIG. 6 also illustrates a plurality of dental attachments 400. In particular embodiments, the plurality of dental attachments 400 may comprise dental attachments configured to treat different disorders. For example, the plurality of dental attachments 400 may include a hook 405, a substantially rounded projection 415, and an adjustable hook 420. Other attachments may include a handle or any other appropriate attachment configured for use with an oral appliance. A user or a medical professional may choose which dental attachment to use without having to hire a lab to construct a new oral appliance. In some embodiments, dental attachments 400 may be configured to engage the slot,

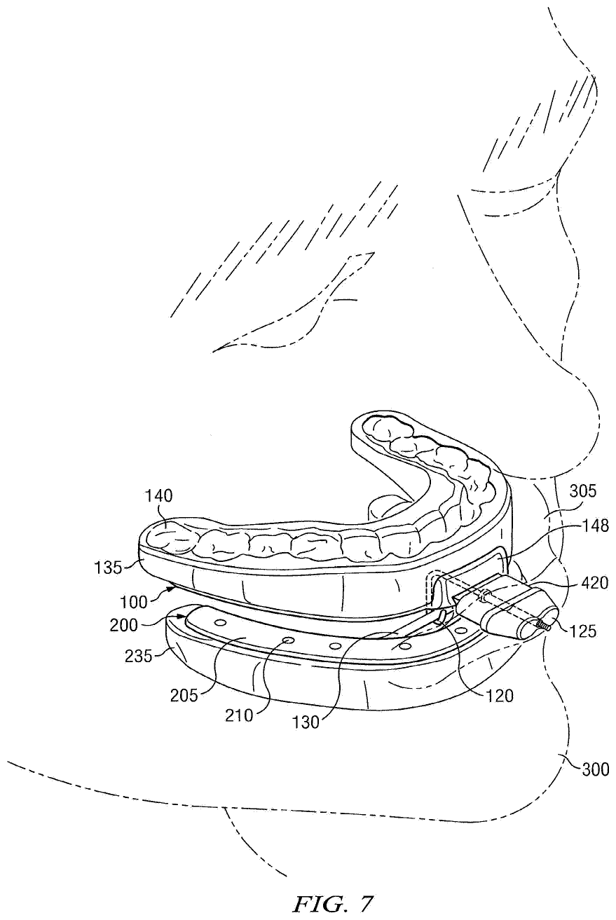

FIG. 7 illustrates an example dental device in a user's mouth. As shown in FIG. 7, a dental device is provided that comprises an arched frame 100, a moldable tray 135 coupled to arched frame 100, a second arched frame 200, and a second moldable tray 235 coupled to arched frame 200. Arched frame 100 may comprise a universal coupler. The universal coupler may comprise a stop 148. Moldable tray 135 may comprise a channel 140 that is configured to engage at least some of the teeth of the user's maxillary arch 305. Second arched frame 200 may comprise a second arched body 205 that defines a second plurality of apertures 210. Second arched frame 200 may further comprise a receiving mechanism 130 that spans the lingual portion of second arched frame 200. In particular embodiments, receiving mechanism 130 may be a bar. Second moldable tray 235 may engage second plurality of apertures 210. The dental device further comprises a dental attachment that is configured to engage the universal coupler. In some embodiments, the dental attachment may be an adjustable hook 420 that comprises a hook 120 and a threaded adjustor 125. Hook 120 may engage receiving mechanism 130. Threaded adjustor 125 may be used to adjust the forward position of second arched frame 200 relative to arched frame 100. This adjustment may adjust the forward position of the user's mandibular arch 300 relative to the position of the user's maxillary arch 305. In some embodiments, this adjustment may help to prevent the user from snoring while sleeping.

FIG. 8A illustrates an example arched frame 700, which may be the milled frames B106 and B114. Arched frame 700 may include an occlusal surface 702 and a flange 706. In particular embodiments arched frame 700 may be configured to be positioned proximate to a user's dental arch, with occlusal surface 702 positioned proximate to the occlusal surface of the user's dental arch. In certain embodiments, occlusal surface 702 may be contiguous throughout the length of arched frame 700. In alternative embodiments, as shown in FIG. 8A, occlusal surface 702 may not be contiguous throughout the length of arched frame 700. For example, occlusal surface 702 may have a first portion configured to be positioned proximate to the user's left bicuspid and first molar; and have a second portion configured to be positioned proximate to the user's right bicuspid and first molar. As shown in FIG. 8A, in certain embodiments, occlusal surface 702 may not extend to the area proximate to the user's incisors. Certain embodiments in which the occlusal surface 702 is not contiguous throughout the length of arched frame 700 may allow for improved flexibility of arched frame 700. In certain embodiments, arched frame 700 may be capable of flexing inward and/or outward, allowing arched frame 700 to conform to a wider variety of dental arch shapes and sizes. Such embodiments may also improve the ability of arched frame 700 to accommodate the overlap of the user's maxillary and mandibular incisors, allowing the user's jaw to close more fully. In certain embodiments, occlusal surface 702 may have a thickness of approximately 1.5 millimeters, although other thicknesses may be used.

Flange 706 may run along the labial edge of arched frame 700. In certain embodiments, flange 706 may be contiguous throughout the length of arched frame 700. In alternative embodiments, as shown in FIG. 8A, flange 706 may not be contiguous throughout the length of the arched frame. For example, flange 706 may include a distal flange portion 708 and a mesial flange portion 710, separated by a flange recess 712. In certain embodiments, because flange 706 is positioned proximate to the labial surface of the user's dental arch, it may be pushed outward by the labial surface of the user's dental arch when arched frame 700 is inserted into the user's mouth during the molding process, allowing arched frame 700 to automatically flex and align with the user's dental arch, which may improve the ability of arched frame 700 to accommodate different dental arch sizes and shapes. In certain embodiments, flange recesses 712 may allow for improved flexibility of arched frame 700. In addition, when arched frame 700 is used with deformable material, flange recesses 712 may allow the deformable material to form an improved mold of the user's teeth. In some embodiments, flange recess 712 may improve the user's ability to press moldable material against their teeth during the molding process, which allow for improved dental molds. In certain embodiments, mesial flange portion 710 may allow for an improved mold when arched frame 700 is pressed toward the user's teeth during fitting. As shown in FIG. 8A, in certain embodiments mesial flange portion 710 may have a thickness greater than that of distal flange portion 708. For example, mesial flange portion 710 may have a thickness of approximately 1 to 2 millimeters and distal flange portion 708 may have a thickness of approximately 1.5 millimeters, although other thicknesses may be used. In such embodiments, the greater thickness of mesial flange portion 710 may improve the stability of arched frame 700 during flexion and may provide a more secure anchor point for other attached structures, such as anterior structure 716 shown in FIG. 8B.

FIG. 8B illustrates another example arched frame 700, which may be the milled frames B106 and B114, having occlusal surface 702, flange 706, and an anterior structure 716. As shown in FIG. 8B, in certain embodiments, occlusal surface 702 may include an occlusal surface recess 704. When arched frame 700 is used with deformable material, occlusal surface recess 704 may allow the deformable material to form a closer mold of the user's teeth. As shown in FIG. 8B, certain embodiments may include anterior structure 716 which extends forward from mesial flange portion 710 in an anterior direction. In certain embodiments, anterior structure 716 may be fixed to arched frame 700, while in other embodiments anterior structure 716 may removeably coupled to arched frame 700. FIGS. 8C and 8D illustrate side views of example arched frames 700, which may be the milled frames B106 and B114, having occlusal surface 702 and flange 706 with distal flange portion 708, flange recess 712, and anterior structure 710.

FIG. 8E illustrates an isometric view of an example arched frame 700, which may be the milled frames B106 and B114. As shown in FIG. 8E, arched frame 700 may include anterior structure 710, occlusal surface 702 that is not contiguous throughout the length of arched frame 700, and flange 706 that includes a distal flange portion 708, a flange recess 712, a mesial flange portion 710, and a mesial flange recess 714. As shown in FIG. 8E, flange 706 may include mesial flange recess 714 located approximately at the midline of the arched frame. In such embodiments, mesial flange recess 714 may allow for improved conformity with the shape of the user's mouth. In certain embodiments, the distal ends of arched frame 700 may extend approximately to the user's first molar when the frame is inserted into the user's mouth. In alternative embodiments, arched frame 700 may extend to the user's second molar or to the user's third molar.

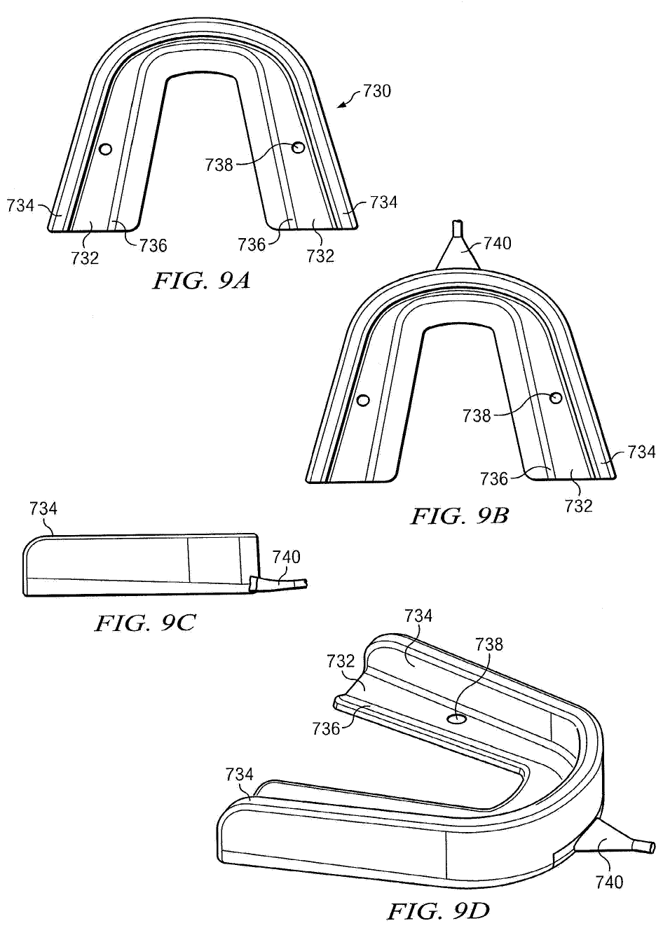

FIGS. 9A through 9D illustrate example moldable trays 730. As shown in FIG. 9A, moldable tray 730 may include an occlusal surface 732, an outer rim 734, an inner rim 736, and recesses 738. Occlusal surface 732 may be configured to be placed proximate to the occlusal surface of a user's dental arch. Outer rim 734 may be configured to be positioned proximate to the labial surface of a user's dental arch. In certain embodiments, inner rim 736 may be configured to be positioned proximate to the lingual surface of a user's dental arch. In certain embodiments, inner rim 736 may lie mostly flat relative to the plane of occlusal surface 732 or may angle upward slightly. Such embodiments may make moldable tray 730 easier to slide into the user's mouth. In certain embodiments, inner rim 736 may be capable of being pushed upward or downward to engage with the lingual surface of the user's dental arch during the molding process.

As shown in FIG. 9A, in certain embodiments, outer rim 734 may have a thickness greater than that of inner rim 736. For example, in certain embodiments, outer rim 734 may have a thickness of approximately 3 millimeters, while inner rim 736 may have a thickness of approximately 2 millimeters, although these dimensions are not required. Reduced thickness of inner rim 736 may allow moldable tray 730 to take up less space in the inner mouth area behind the teeth, which may allow the user to breath, swallow, and speak more easily and experience greater comfort. Reduced thickness of inner rim 736 may also help obviate any need to offer multiple sizes of moldable tray 730 and arched frame 700. In certain embodiments, reduced thickness of inner rim 736 may allow other medical and/or dental devices to be more easily inserted into the user's mouth. In certain embodiments, as shown in FIG. 9D, inner rim 736 may be shorter than outer rim 734. A shorter inner rim 736 may allow for easier insertion of moldable tray 730 into the user's mouth. A shorter inner rim 736 may also reduce the amount of moldable material in the inner mouth area, which may provide additional advantages as described above. In certain embodiments, distal portions of moldable tray 730 may have a reduced height, which may improve the fit of moldable tray 730 in the user's mouth.

As shown in FIG. 9A, in certain embodiments, occlusal surface 732 may have one or more recesses 738, which may result from clamping or otherwise holding in place arched frame 700 during an overmolding process. In certain embodiments, arched frame 700 illustrated in FIGS. 8A through 8E may have a corresponding recess, which may allow for improved clamping and alignment during the manufacturing process.

FIG. 9B shows another example moldable tray 730 having occlusal surface 732, outer rim 734, and inner rim 736. As shown in FIG. 9B, in certain embodiments, moldable tray 730 may further include an anterior structure 740. It should be appreciated that in certain embodiments the optional anterior structure 740 may be fixed to moldable tray 730 or it may be removeably coupled to moldable tray 730.

In certain embodiments, moldable tray 730 may be composed of a material that can be heated to a temperature at which the material softens and becomes capable of being molded to a different shape. In certain embodiments, the material can be heated in hot water. In some embodiments, the temperature range at which the material softens may be approximately 40-80 degrees Celsius, although materials with other softening ranges may be used. In a particular embodiment, the target softening temperature may be approximately 60 degrees Celsius. In certain embodiments, this material may be a thermoplastic. Such thermoplastic materials may be heated to a temperature at which the thermoplastic becomes soft and moldable, at which point it may be molded to the shape of at least a portion of a user's dental arch and become at least temporarily fixed in that shape. As one example, moldable tray 730 may comprise a polycaprolactone polymer or other aliphatic polyester, as discussed above in reference to moldable tray 135. In particular embodiments, the thermoplastic material may comprise a cross-linked polycaprolactone reinforced with an aramid fiber such as the short length aramid fiber sold by Dupont under the brand name Kevlar®. In certain embodiments, using polycaprolacton combined with Kevlar® may allow moldable tray 730 to soften at low temperatures and set hard at temperatures of approximately 60 degrees Celsius. In certain embodiments, using polycaprolacton combined with Kevlar® may improve the hardness of moldable tray 730 following the molding process, which may improve the ability of moldable tray 730 to hold its shape when being used to adjust the user's jaw position and/or hold a mask or other breathing device in place. In certain embodiments, this increased hardness may also improve the ability of moldable tray 730 to hold its shape for longer periods of time. For example, in certain embodiments, this may allow moldable tray 730 to substantially hold its shape for periods longer than approximately 1 month, though such period is not required. Using polycaprolacton combined with Kevlar® may also allow for thinner embodiments of moldable tray 730, which may allow moldable tray 730 to take up less space in the user's mouth. Examples of polycaprolactone combined with an aramid fiber, including Kevlar® and a variety of other fibers, are described in U.S. application Ser. No. 11/368,991, publication number U.S. 2007/0004993 A1, which is incorporated herein by reference. Such embodiments may provide an improved moldable material that better maintains its form when heated, providing increased viscosity which may prevent the material from flowing excessively around the user's teeth and/or getting stuck on the user's teeth during the molding process. Such embodiments may also possess increased strength after molding. In certain embodiments, the thermoplastic material may be cross-linked by radiation, which may create cross-linking of certain molecules to improve the material's shape retention characteristics and/or make the material better able to return to its original shape after reheating. In certain embodiments, radiation may be applied after moldable tray 730 has been overmolded with arched frame 700, but before being molded to the user, though this is not required. Cross-linking by radiation is further described in U.S. Pat. No. 5,415,623, which is incorporated herein by reference. In certain embodiments, the material may exhibit slight shrinkage after being molded to the user's dental arch. In particular embodiments, such shrinkage may be less than 1%. Slight shrinkage of the material following the molding process may allow for improved fit with the user's dental arch. In some embodiments, slight shrinkage of the material following the molding process may allow moldable tray 730 to have a “snap” fit with the user's dental arch.

In some embodiments, arched frame 700 may be primarily composed of a substantially rigid material, such as Nylon or any other material providing substantial rigidity while allowing moderate flexion. In certain embodiments, arched frame 700 may be composed of a material whose form does not substantially changed when heated to the temperature required to soften the moldable material of moldable tray 730. For example, in some embodiments, arched frame 700 may be composed of a material that substantially maintains its shape when heated up to at least 100 degrees Celsius. Such materials may include polycarbonate, Nylon, acrylonitrile butadiene styrene (ABS), or polyethylene. In certain embodiments, arched frame 700 may be composed of a semi-flexible material approximately having a Shore 30-90 hardness, although this particular hardness is not required.

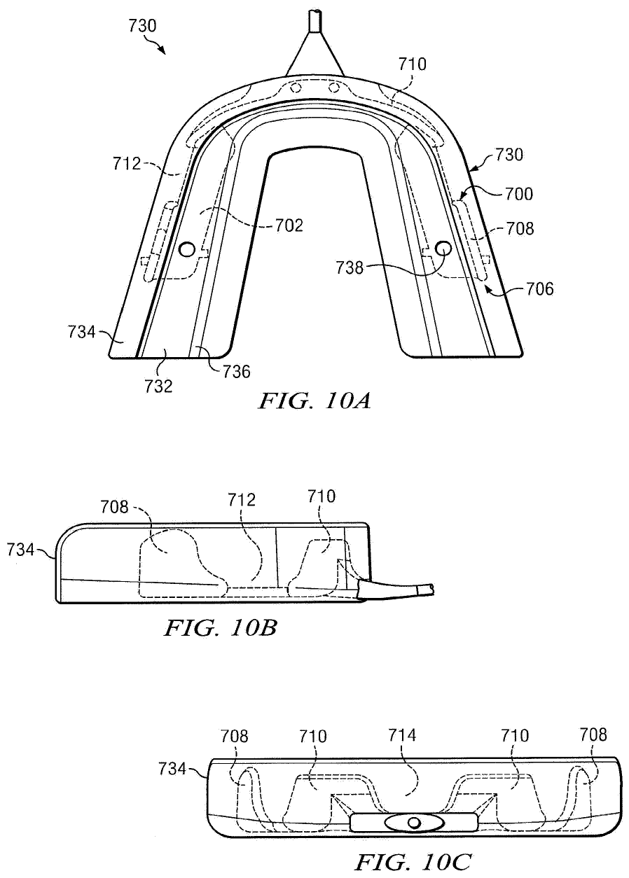

FIGS. 10A through 10C illustrate an example moldable tray 730 substantially surrounding an example arched frame 700. As shown in FIG. 10A, example moldable tray 730 may include occlusal surface 732, outer rim 734, and inner rim 736; and arched frame 700 may include occlusal surface 702 and flange 706. As shown in FIG. 10A, in certain embodiments the labial edge of outer rim 734 may extend outward beyond the labial edge of flange 706. The lingual edge of inner rim 736 may also extend inward beyond the labial edge of occlusal surface 702. As seen in FIG. 10B, in certain embodiments the distal end of moldable tray 730 may extend distally beyond the distal end of arched frame 700. In certain embodiments, the distal end of arched frame 700 may extend approximately to the user's first molar, while the distal end of moldable tray 730 extends approximately to the user's second or third molar. In alternative embodiments, the distal end of arched frame 700 may extend approximately to the user's second molar, while the distal end of moldable tray 730 extends approximately to the user's third molar. In still other embodiments, the distal ends of arched frame 700 and moldable tray 730 may be approximately coextensive.

In certain embodiments, when moldable tray 730 is oriented for placement on, for example, a user's maxillary arch, the superior surface of outer rim 734 may extend beyond the superior surface of flange 706 by approximately 2.5 millimeters while the inferior surface of moldable tray 730 may extend below the inferior surface of arched frame 700 by approximately 1.5 millimeters, although these dimensions are not required. In certain embodiments, moldable tray 730 may extend outward beyond the labial edge of arched frame 700 by approximately 1.5 millimeters, though other dimensions are possible. In certain embodiments, moldable tray 730 may extend inward beyond the lingual edge of arched frame 700 by approximately 1.5 millimeters, though other dimensions are possible.

In certain embodiments, flange 706 may help maintain the shape of outer rim 734. Moldable trays that substantially surround an arched frame may allow for reduced bulk between a user's incisors when the tray(s) are inserted into the user's mouth. By providing moldable trays with less material between the user's incisors, certain embodiments may allow users to close their mouths further with the trays inserted, which may improve comfort and/or effectiveness. Furthermore, moldable trays that substantially surround arched frame may allow for mouth pieces where only the moldable material touches the inner surfaces of the user's mouth, such as the user's gums, lips, and tongue. Such moldable trays may also allow for improved molding to the user's front teeth. Having arched frame 700 substantially surrounded by moldable tray 730 may also reduce the chances of damage to arched frame 700 and may help hold any broken pieces of arched frame 700 in place, preventing any such broken pieces from contacting the user's mouth or entering the user's airway.

In certain embodiments, arched frame 700 may include apertures in occlusal surface 702 and/or flange 706, though such apertures are not required. Such apertures may allow the moldable material to flow through arched frame 700 during the molding process, which may provide greater stiffness following the molding process and may allow for improved alignment of arched frame 700 with moldable tray 730.

FIG. 11A illustrates another example moldable tray 730 having occlusal surface 732, outer rim 734, inner rim 736, and notches 742. In this embodiment, moldable tray 730 is attached to a post 802 having slot 804, channels 806, and tension element channel 834. The post 802 may be a receiving mechanism B110 coupled to the frame B106. The tension element channel 832 may be configured to receive a post B118. FIG. 11B also illustrates a lower isometric view of the same embodiment showing outer rim 734, notch 742, and a lower surface 744. As shown in FIG. 11A, in certain embodiments, moldable tray 730 may be custom molded to fit a particular user's dental arch. In particular embodiments, moldable tray 730 may include one or more notches 742 which may facilitate grasping the moldable tray for improved insertion into and removal from the user's mouth. As shown in FIG. 11B, in certain embodiments, lower surface 744 of the moldable tray 730 may also be molded to fit the user's second dental arch. In certain embodiments, molding lower surface 744 to the user's mandibular dental arch may be performed with the user's mandibular dental arch placed in a particular position relative to the user's maxillary dental arch. For example, the user's mandibular dental arch may be extended in the anterior direction, which may help open a user's airway allowing for improved breathing. Molding lower surface 744 to the user's mandibular dental arch may also help hold the user's jaw in a desired position, such as, for example, when upward force is applied to the user's mandible by a chin strap or other device.

In certain embodiments, a second moldable tray configured to engage with the user's second dental arch may be fused with moldable tray 730, locating the user's mandibular arch in a particular position relative to the user's maxillary arch. In such embodiments, the second moldable tray may be fused to moldable tray 730 prior to forming a mold of the user's dentition. In alternative embodiments, the second moldable tray may form a separate piece prior to being molded to the user's dentition. In such embodiments, the second moldable tray and moldable tray 730 may be heated and fused together during the molding process.

Alternative embodiments may utilize a custom-made tray rather than a moldable tray. In some embodiments, a custom-made tray may be pre-fitted and then molded from a substantially rigid material, such as, for example, acrylic. Certain embodiments may have two separate custom-made trays coupled together via an adjustment mechanism, such as, for example, those described in U.S. Pat. No. 7,748,386, which is incorporated herein by reference. In certain embodiments, such an adjustment mechanism may have wedges in the side that interact to move the user's lower jaw forward.

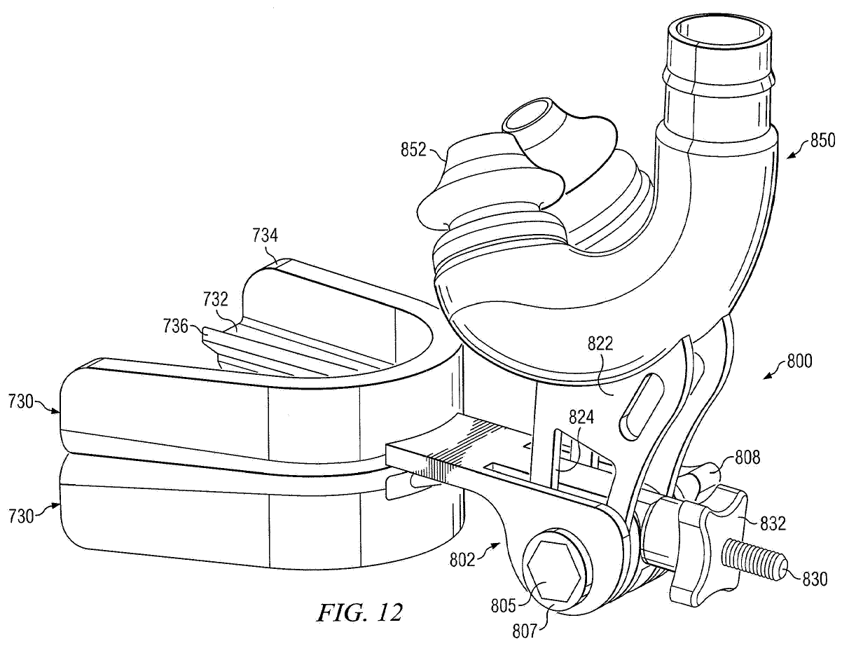

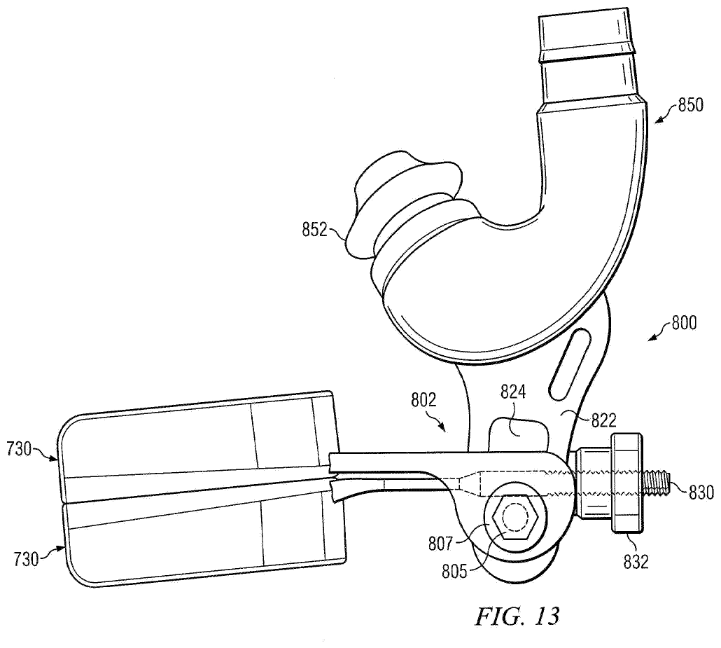

FIG. 12 illustrates two moldable trays 730, a mask 850, and a coupler 800. FIG. 13 illustrates a side view of the components shown in FIG. 12. As shown, moldable trays 730 include occlusal surface 732, outer rim 734, and inner rim 736. Mask 850 is a device for directing the flow of air and/or other gases to a user. Coupler 800 adjustably couples mask 850 to at least one moldable tray 730. In the embodiment shown, two moldable trays 730 cooperate to form an adjustable oral appliance configured to adjustably position the lower arch of a user relative to the user's upper arch. As shown, upper moldable tray 730, includes post 802 that extends anterior to the user's mouth when upper moldable tray 730 is positioned proximate to the user's maxillary dentition. Similarly, lower moldable tray 730 includes tension element 830 (which may be the post B118 coupled to the frame B114) that extends anterior to the user's mouth when lower moldable tray 730 is positioned proximate to the user's mandibular dentition. In this embodiment, post 802 includes a tension element channel 834 to receive tension element 830. In certain embodiments, tension element 830 may be threaded and may be coupled to adjustment knob 832, which may be turned to adjust the position of lower moldable tray 730 relative to upper moldable tray 730. Although tension element 830 is described as being threaded, other configurations may be used to adjust the relative positions of upper and lower moldable trays 730. In alternative embodiments, tension element 830 may attach to an adjustable oral appliance, such as the oral appliance described in U.S. Pat. No. 7,748,386. In certain embodiments, upper moldable tray 730 and lower moldable tray 730 may be used with or without a mask. In these embodiments, moldable trays 730 may function as an oral appliance only or may be used during surgery or post-surgery to maintain the user's airway during the administering of anesthetics or during ventilation, or they may be in place in the event that resuscitation becomes necessary.

In certain embodiments, the receiving mechanism B110 may take the form of the post 802, and the post 118 may take the form of the tension element 830. In other words, the post 802 may be coupled to the frame B106 along a midline of the frame B106 and extend from the frame B106 in an anterior direction when the frame B106 is positioned in a user's mouth. Additionally, the tension element 830 may be coupled to the frame B114 along a midline of the frame B114 and extend from the frame B114 in an anterior direction when the frame B114 is positioned in the user's mouth. The adjustment knob 832 may serve as the adjustment nut B120. Stated differently, the adjustment knob 832 may operably couple to the tension element 830 such that the adjustment knob 832 may be turned to adjust its position on the tension element 830. The post 802, tension element 830, and the adjustment knob 832 may control a forward position of the frame B114 relative to the frame B106. As a result, the arch B114 may push or pull the user's jaw forward to open the user's air passageways to treat snoring or sleep apnea.

Mask 850 includes one or more flanges 822, with each flange 822 including a slot 824. Flange 822 may be fixed to or integrally formed with mask 850; or flange 822 may be removably coupled to mask 850. However, it should be appreciated that flange 822 may be fixed to or integrally formed with other mask types, or flange 822 may be removably coupled to and/or interchangeable with other mask types. In embodiments in which a single flange 822 is used, flange 822 may have a thickness of between 10-22 millimeters, though such dimensions are not required. In other embodiments, flange 822 may have a thickness of between 12-18 millimeters. In a particular embodiment, flange 822 may have a thickness of approximately 14 millimeters. In embodiments having multiple flanges 822, each flange 822 may have a thickness of between 1-4 millimeters, though this range is not required. In a particular embodiment having a multiple flanges 822, one or more of the flanges 822 may have a thickness of approximately 3 millimeters. In certain embodiments having multiple flanges 822, when the mask is oriented to the user's face, the distance between the right edge of the rightmost flange 822 and the left edge of the leftmost flange 822 may be similar to the ranges described above for a single flange 822. For example, in a particular embodiment having two flanges 822, the span between the inner edges of the flanges may be approximately 6 millimeters and the span between the outer edges of the flanges may be approximately 14 millimeters, though other dimensions may be used. Such embodiments may improve the ability of coupler 800 to prevent deformation outside of the sagittal plane.

As shown in FIG. 12, mask 850 is a pillow mask with nasal inserts 852 that may be configured to seal against the user's nostrils. In certain embodiments, nasal inserts 852 may be fitted independently to mask 850 and may be capable of rotating independently to the angle of the user's nostrils. In certain embodiments, nasal inserts 852 may be removeably coupled to mask 850 and may be interchangeable with different sizes of nasal inserts 852. In some embodiments, the user may select different sizes of nasal inserts 852 for each nostril. In alternative embodiments, nasal inserts 852 may be formed together as a pair and attached as one unit to mask 850. In other embodiments, nasal inserts 852 may be fixed permanently to mask 850. In certain embodiments, mask 850 may have an inlet that is fixed on the top of the frame for delivering air and/or other gases to mask 850. In some embodiments, mask 850 may have a ball joint, elbow, or a combination thereof delivering air and/or other gases to mask 850. In alternative embodiments, air and/or other gases may be delivered in the side or the bottom of mask 850. In certain embodiments, air and/or other gases may be delivered through several different tubes. In certain embodiments, the user may be able to select one or more connection points for delivery of air and/or other gases and plug or otherwise disable other connection points. In other embodiments, a main hose may attach directly to mask 850 or to an elbow joint or a ball joint. In certain embodiments, mask 850 may have a length of flexible tubing that may connect with a main hose. In certain embodiments, the optional flexible tubing may be approximately 50-300 millimeters long, though this is not required. In one example embodiment, mask 850 may have a 250 millimeter-long flexible tube. In certain embodiments, such tubing may be light, flexible, and have a smaller diameter than the main hose. In some embodiments, the flexible tubing may have a diameter of approximately 12-19 millimeters, while the main hose may have a diameter of approximately 22 millimeters, though these dimensions are not required. In one example embodiment, the flexible tubing may have an internal diameter of approximately 17 millimeters. In certain embodiments, there may be a connector between the short flexible tube and the main tube, and in some embodiments this connector may be capable of swiveling. In particular embodiments, the connector may be a ball joint or a straight connector. In certain embodiments, optional headgear may be supplied that attaches to mask 850, coupler 800, and/or moldable tray 730. Such headgear may pass along the side of the user's face and may be capable of holding the main hose or other air-delivery device in a particular position. For example, in certain embodiments, such headgear may hold the main hose in place on top of the user's head or to one or both sides of the user's head. In certain embodiments, such headgear may also be configured to help hold moldable tray 730, or any other oral appliance, in the user's mouth. In some embodiments, such headgear may be adjustable at a connection point on mask 850 and/or at one or more places around the user's head. In alternative embodiments, the headgear may be formed from a stretchable material and may require little or no manual adjustment. In one example embodiment, the headgear may be at least partially made from Breath-o-Prene®, which is a soft, breathable laminate. In another example embodiment, the headgear may be at least partially made from silicone or a molded thermoplastic/fabric composite. In other embodiments, the headgear may be formed from a combination of these materials, or from a combination of these and other materials. In certain embodiments, a chin strap may attach to mask 850, headgear, or moldable tray 730 or any other oral appliance. In some embodiments, mask 850 may have bias flow (vent holes) to flush out the user's exhaled breath. In such embodiments, mask 850 may have a plurality of holes to enable bias flow. In certain embodiments, mask 850 may have approximately 10-50 holes, though this is not required. In one example embodiment, mask 850 may have approximately 35 holes. In these embodiments, the holes may be approximately 0.75 millimeters in diameter, though these dimensions are not required. In certain embodiments, the holes may have non-uniform cross-sectional shapes throughout the length of the holes. In one example embodiment, one or more of the holes may be rounded and have an opening diameter of approximately 1.2 millimeters, the diameter of the hole falling to approximately 0.75 millimeters when moving through the hole and then expanding again to a diameter greater than 0.75 millimeters when moving through to the other end of the hole. In alternative embodiments, the holes may be tapered from one side or the other, or the holes may be straight throughout. In certain embodiments, having many small holes may slow the flow of gas and may reduce the draft and noise of such flow. In other embodiments, mask 850 may have no holes, which may enable closed-loop ventilation. In certain embodiments, mask 850 may be first formed in two or more distinct pieces and then joined, for example, by welding, gluing, clipping, screwing, latching, strapping, or otherwise fixing the pieces together. In other embodiments, the mask may initially be formed as a single piece. Furthermore, those skilled in the art will appreciate that the headgear, tubes, bias holes, chin straps, attachments, assembly features, and other aspects described above may also apply to other masks described herein.

Post 802 may include one or more channels 806 and a slot 804. In the embodiment shown, coupler 800 is formed by two flanges 822 engaging two channels 806. The movement of flanges 822 relative to channels 806 is limited by fastener 805 in slot 804. Fastener 805 may represent any structure that can restrict the movement of flanges 822 relative to channels 806. In certain embodiments, fastener 805 may be a pin, screw, or bolt. In the embodiment shown, fastener 805 is a threaded hex-head bolt that engages a hex-head counter sink 807 on one side of post 802 and a tightening knob 808 on the other side of post 802. In certain embodiments, a hex-head (or other appropriately shaped) countersink may prevent rotation of fastener 805 while tightening knob 808 or other appropriate structure is fixing the position of fastener 805. In a particular embodiment, both sides of post 802 may include a countersink, such that a user may select to position tightening knob 808 on either side of post 802. This flexibility may make the use of tightening knob 808 equally convenient to left-handed and right-handed users. In alternative embodiments, post 802 may include an additional tightening knob opposite tightening knob 808, enabling adjustment from either side of post 802.

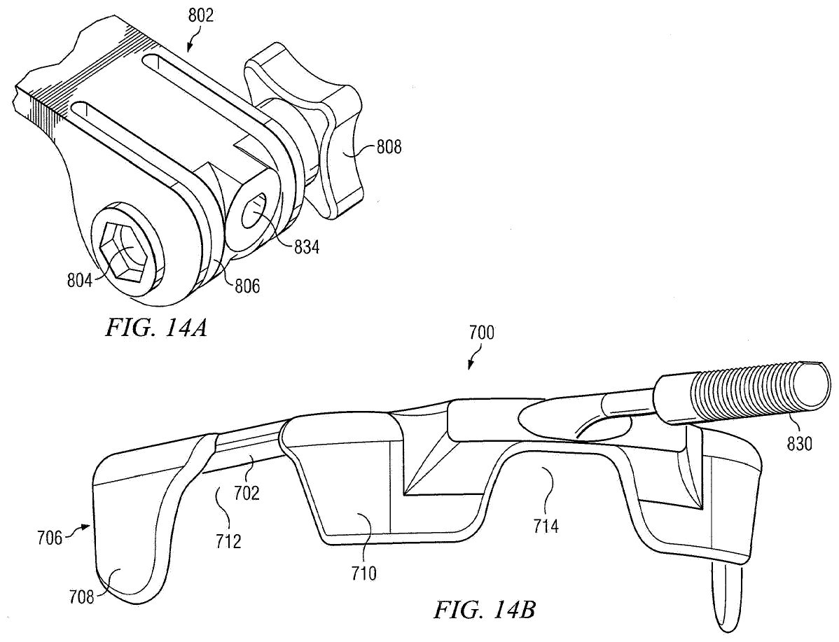

FIG. 14A illustrates the anterior end of an example post 802 and FIG. 14B illustrates an example anterior view of an example arched frame 700 with a tension element 830. As shown in FIG. 14B, in certain embodiments at least a portion of the tension element may be threaded, and the threaded portion may engage with the tension element adjustor 832. In the embodiments shown, post 802 includes D-shaped slot 834 and tension element 830 has a corresponding D-shaped cross-section. In certain embodiments, the D-shaped slot 834 and tension element 830 may substantially prevent tension element 830 from rotating when adjustment knob 832 is used to adjust tension element 830. Although a D-shape is illustrated, other cross-sections may be used to prevent the rotation of tension element 830 in slot 834. As one example, slot 834 may have a “key” structure that corresponds with a channel in tension element 830.

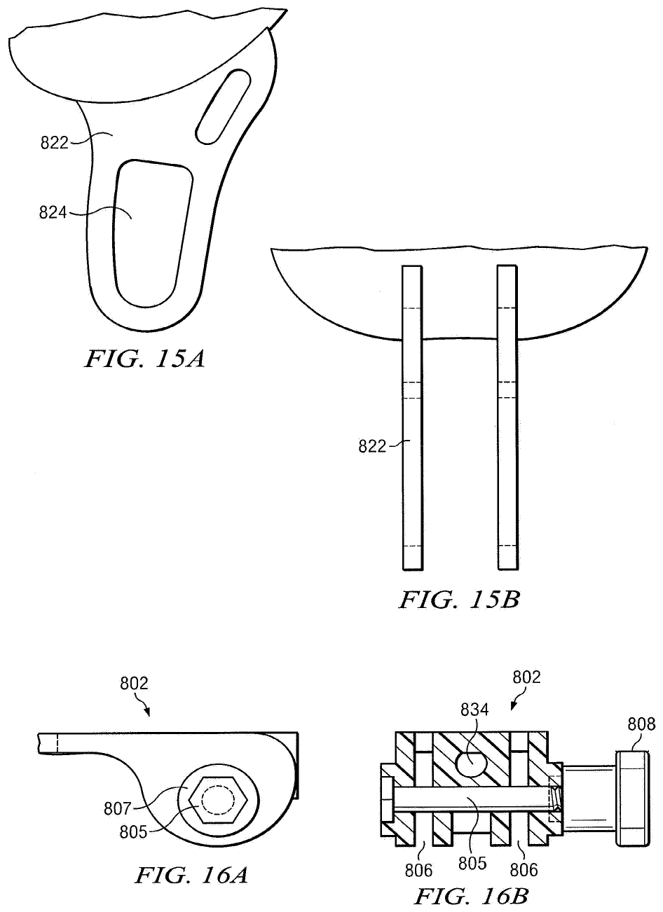

FIGS. 15A and 15B illustrate example flanges 822. As shown in FIG. 15A, flange 822 may include a slot 824. While FIG. 15B depicts two distinct flanges 822, alternative embodiments may have a single flange, multiple flanges, or any other structure which may be secured in place relative to post 802 by fastener 805. In alternative embodiments, slot 824 may have various shapes, sizes, and orientations. In certain embodiments, flanges 822 may be formed and/or molded as one part. In other embodiments, flanges 822 may be formed from multiple parts that may be assembled, clipped, screwed, or overmolded. In various embodiments, flanges 822 may consist of plastic and/or metal such as stainless steel.

FIGS. 16A and 16B illustrate an example post 802 having a fastener 805, channels 806, countersink 807, tightening knob 808, and a tension element channel 834. As shown in FIG. 16A, an end of fastener 805 may be configured to engage with countersink 807. In certain embodiments, as shown in FIG. 16B, at least a portion of fastener 805 may be threaded. As shown in FIG. 16B, in some embodiments slot 804 (not shown) may cross laterally through post 802, allowing fastener 805 to pass laterally through post 802 across channels 806. In some embodiments, when flanges 822 are disposed in channel 806, slots 824 may substantially align with slot 804, allowing fastener 805 to pass through both slot 804 and slots 824. In such an embodiment, tightening knob 808 may be adjusted to increase or decrease lateral force exerted along the long axis of fastener 808. Adjusting tightening knob 808 in such an embodiment may operate to secure flanges 822 in place relative to post 802. In certain embodiments, an attached mask or breathing device may be moved into the desired position relative to the user's face and then fixed into that position by adjusting tightening knob 808.

In certain embodiments, post 802 may be formed and/or molded as one part. In other embodiments, post 802 may be formed from multiple parts that may be assembled, clipped, screwed, or overmolded. In various embodiments, post 802 may consist of plastic and/or metal such as stainless steel.

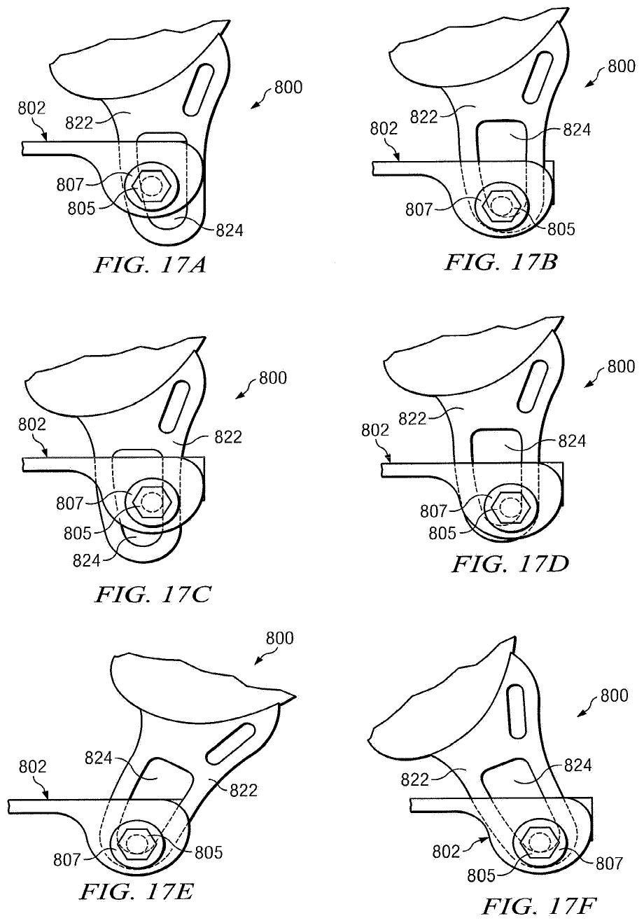

FIGS. 17A through 17F illustrate various positions of an example coupler 800. As shown in FIG. 17A, coupler 800 may include a flange 822 with slot 824 and a post 802 having a fastener 805 and countersink 807. As shown in FIGS. 17A through 17F, in certain embodiments, flange 822 may be capable of moving in the superior-inferior direction relative to post 802, moving in the anterior-posterior direction relative to post 802, and rotating around fastener 805. In alternative embodiments, flange 822 may be capable of moving in the superior-inferior direction relative to post 802 and rotating around fastener 805. In certain embodiments, flange 822 may be limited to adjustment, rotation, and/or movement within the sagittal plane. In some embodiments, post 802 may include an additional joint that may provide adjustment, rotation, and/or movement in one or more additional directions. In certain embodiments, flange 822 may be adjusted vertically approximately +/−10 mm, though other ranges may be used. For example, other embodiments may have vertical adjustment ranges of between +/−7 mm and +/−14 mm. In certain embodiments, flange 822 may be adjusted in the anterior-posterior direction approximately +/−5 mm, though other ranges may be used. For example, other embodiments may have horizontal adjustment ranges of between +/−3 mm and +/−8 mm. In certain embodiments, when flange 822 has a desired position and orientation, tightening knob 808 may be adjusted to secure flange 822 in place relative to post 802.

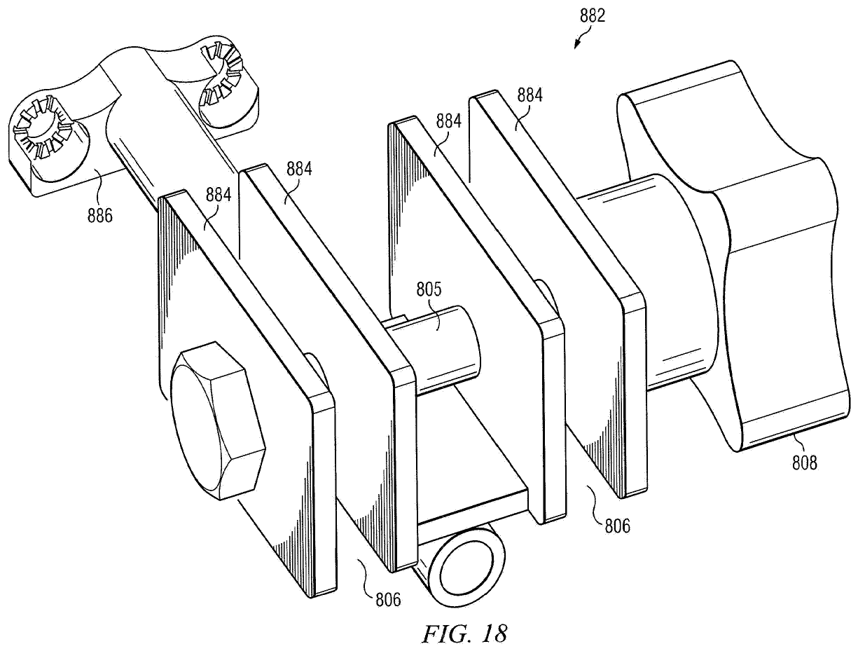

FIG. 18 illustrates another example post 882 having a fastener 805, plates 884, channels 806, tightening knob 808, and plate 886. In particular embodiments, plates 884 may define channels 806, which are configured to receive flanges 822. As shown in FIG. 18, post 882 may be cylindrical and hollow. In a particular embodiment, post 882 may consist of metal, such as stainless steel. In alternative embodiments, post 882 may have various structures, shapes, and densities and can be made from a wide variety of rigid materials. In some embodiments, plate 886 may be attached at the posterior end of post 882. Plate 886 may be configured to couple to the front of an oral appliance such as those described, for example, in U.S. Pat. No. 7,748,386, which is incorporated herein by reference.

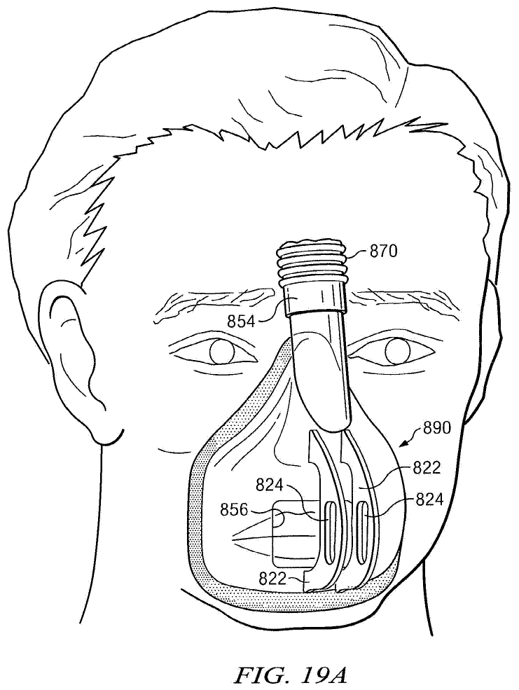

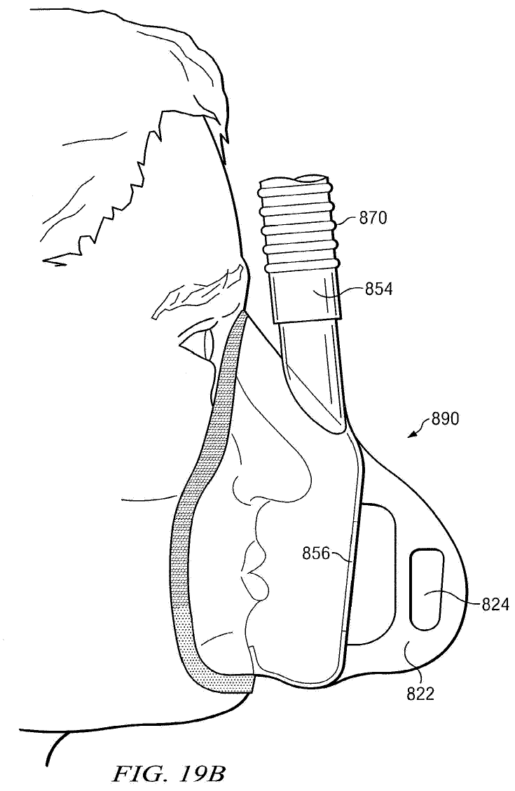

FIG. 19A illustrates an example mask 890 having flanges 822 with slots 824 and a hose coupler 854 coupled to a hose 870. FIG. 19B illustrates a side view of mask 890, showing opening 856 and flanges 822. In certain embodiments, as shown in FIG. 19B, flanges 822 may be fixed to or integrally formed with mask 890. In alternative embodiments, flanges 822 may be removably coupled to the anterior surface of mask 890. In some embodiments, opening 856 may allow structures, such as post 802 or post 882, to pass through the front of mask 890 and couple with flanges 824. In certain embodiments, opening 856 may be sized to accommodate various positions and orientations of post 802 relative to mask 890.

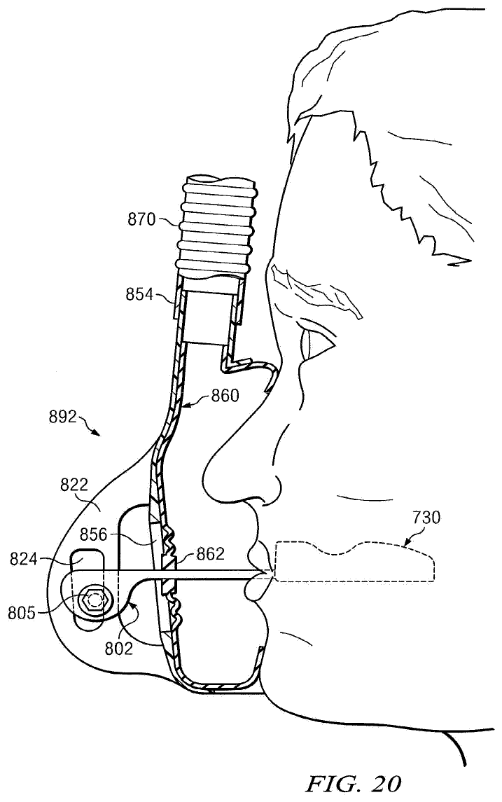

FIG. 20 illustrates an example mask 892 coupled to an example post 802. As shown, mask 892 includes a seal 860, opening 856, flanges 822, and a hose coupler 854. As shown, post 802 is attached to moldable tray 730 inside the user's mouth, allowing mask 892 to be adjustably oriented to the user's face. In certain embodiments, mask 892 may be adjusted vertically, adjusted in the anterior-posterior direction, and/or rotated in the sagittal plane. In certain embodiments, as shown in FIG. 20, seal 860 may include flexible gasket 862 which may be configured to allow post 802 to pass through it and couple with flanges 824, forming an air-tight seal around post 802. Flexible gasket 862 may also allow mask 892 to be adjusted to various positions and orientations relative to the user's face without significantly disturbing post 802 or breaking the airtight seal of seal 860. In some embodiments, as shown in FIG. 20, flexible gasket 862 may incorporate or be surrounded by creases, which may improve the ability of flexible gasket 862 to accommodate various positions of post 802, though such creases are not required. In certain embodiments, post 802, or another suitable post such as post 882, may attach to various oral appliances, allowing for various combinations of oral appliances, posts, and masks. In alternative embodiments, flanges 822 may be contained within a mask, providing the substantially similar movement and adjustment to mask 892. In such embodiments, fastener 805 may pass through a gasket in the mask's seal to a position outside the mask where it could be operated by a user.

Having mask 892 secured to the user's oral appliance may obviate the need for the user to wear stabilizing headgear. Such straps may shift accidentally, may be uncomfortable for the user, may leave marks on the user's face, and may irritate the user's face and scalp. Furthermore, since having mask 892 secured to the user's oral appliance may prevent substantial movement of mask 892 relative to the user's face and prevent leakage, these embodiments may reduce the need to tighten the mask to the user's face, which may result in reduced pressure on the user's face and reduced pressure sores. These embodiments may also provide greater mask stability during sleep for users who exhibit substantial movement during sleep. It should be appreciated that all such embodiments and advantages described with respect to mask 892 may also apply to other mask described herein, such as, for example, masks 850 and/or 894.

In alternative embodiments, mask 892 may be held in place by a tension element attached to an oral appliance, with the tension element pulling mask 892 toward the oral appliance and the user's face. In certain embodiments, the pull of the tension element may be adjusted by a screw, tightening knob, or other adjustment mechanism. Following adjustment, in certain embodiments, mask 892 may be secured via a fastener, such as a hook.

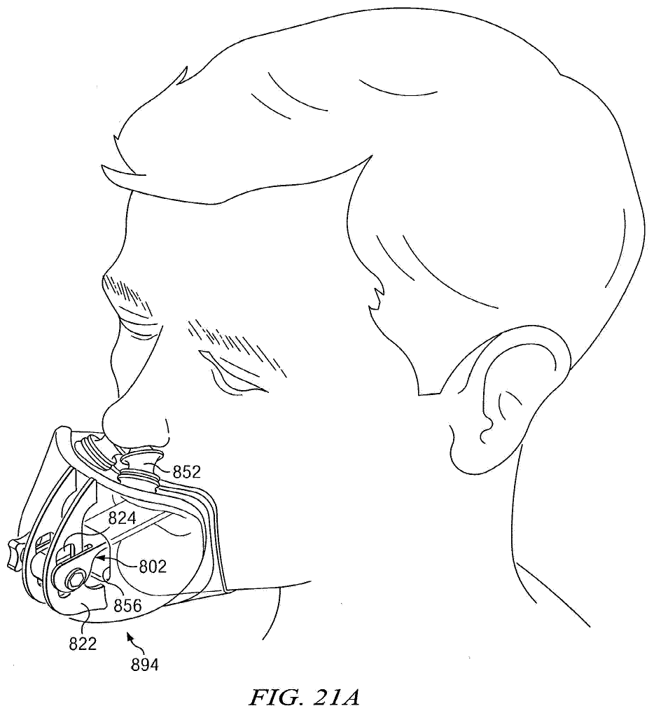

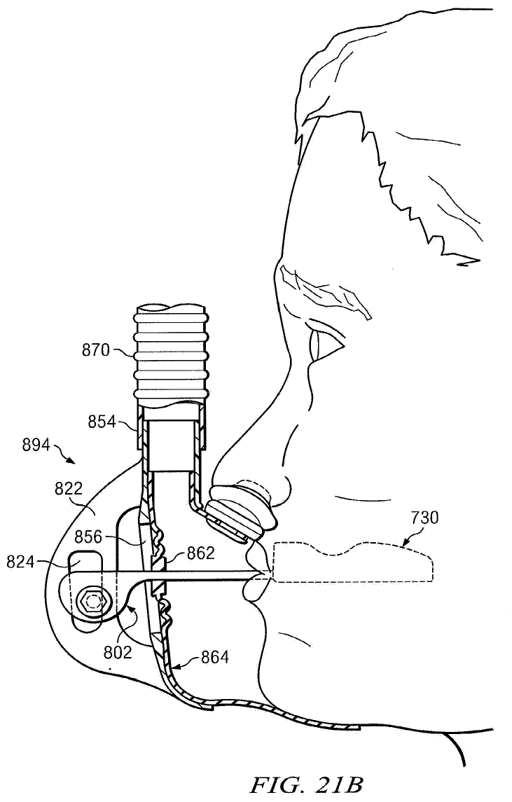

While FIG. 20 shows mask 892 as a full face mask covering the user's nose and mouth, FIGS. 21A and 21B illustrate an alternative mask 894 covering the user's mouth and delivering air and/or other gases to the user's nose via nasal inserts 852. In certain embodiments, as shown in FIG. 21B, seal 860 may extend below the user's chin. Masks with portions that extend below a user's chin may improve the function of the mask by preventing and/or reducing the occurrence of the user opening their mouth while using the mask. Still other embodiments incorporating different types of masks will be apparent to those skilled in the art. In certain embodiments, when flanges 822 of mask 894 are disposed in channels 806 of post 802, movement of mask 894 outside of the sagittal plane is strongly resisted, which may help prevent mask leakage if a user lays on his or her side, pushing mask 894 laterally against a surface such as a pillow.

Various types of masks may be used in other embodiments. For example, certain embodiments may use pillow masks, which seal against the user's nostrils; nasal masks, which cover the user's nose; full face masks, which cover both the user's mouth and nose; hybrid masks, which have one portion covering a user's mouth and another portion covering the user's nose or sealing against the user's nostrils; or oral masks, which cover the user's mouth. Such masks may be used for the delivery of pressurized air, oxygen, aerosols, gasses, or medication; and the masks may be vented or non-vented. Masks included in various embodiments may be used for continuous positive airway pressure treatment (CPAP), auto-CPAP, or bi-level or closed-loop ventilation; and masks may be custom-fitted to a particular user or they may be non-custom masks that conform to different face shapes.

In certain embodiments, a venting seal may be combined with the masks and/or oral appliances disclosed herein. In certain embodiments, the venting seal may be fixed or detachable. The venting seal may be positioned outside the user's mouth next to the user's lips or the venting seal may be positioned behind the user's lips next to the user's teeth. In certain embodiments, the venting seal may reduce or eliminate the venting of air or other gases from the user's mouth, such as for example when air or other gases are being supplied to the user's nose. An example venting seal is disclosed in U.S. Pat. No. 6,675,802, incorporated herein by reference. In certain embodiments, the venting seal may be attached to post 802, post 882, or other appropriate structure, either removably or permanently.

As seen in these figures, oral appliance B100 may use post 802 as receiving mechanism B110 and tension element 830 as post B118 so that oral appliance B100 may couple to a mask 850 to deliver gas to a user.

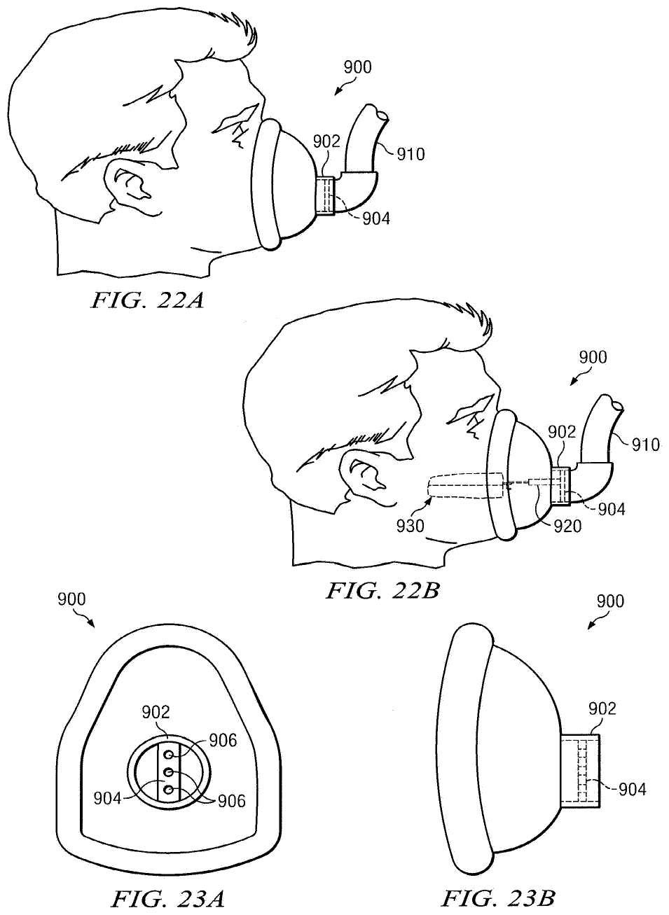

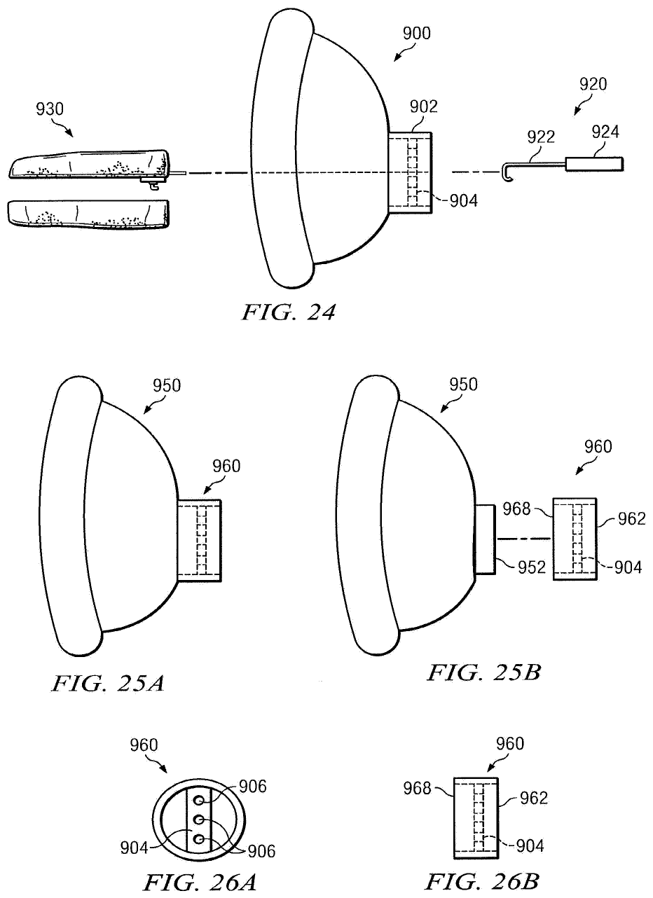

FIGS. 22A and 22B and FIG. 23 illustrate an example mask 900 having a hose coupler 902 and a strap 904 with a plurality of apertures 906. As shown in FIG. 22A, hose coupler 902 may be configured to attach to a hose 910 which may deliver air and/or other gases to mask 900. In certain embodiments, as shown in FIG. 23A, strap 904 may span the opening of hose coupler 902. As shown in FIG. 23A, strap 904 may have a plurality of apertures along its length. In certain embodiments, as shown in FIG. 22B, a tension element 920 may pass through one of the plurality of apertures 906 and attach to oral appliance 930, which may be any mouthpiece configured to couple to tension element 920. FIG. 24 illustrates an example oral appliance 930, mask 900, and tension element 920. As shown in FIG. 24, tension element 920 has a threaded knob 924 and a hook 922. Oral appliance 930 includes a receiver to engage tension element 920 to pull mask 900 towards oral appliance 930. In certain embodiments, the receiver in oral appliance 930 may be a loop, a latch, or a slot. In a particular embodiment, tension element 920 includes hook 922 and threaded knob 924. In alternative embodiments, tension element 920 may include one or more alternative structures to pull mask 900 towards oral appliance 930.

FIGS. 25A and 25B illustrate an example mask 950 and adapter 960. As shown in FIGS. 26A and 26B, in certain embodiments adapter 960 may include a hose coupler 962, a strap 904 having a plurality of apertures 906, and a mask coupler 968. In some embodiments, hose coupler 902 may be configured to couple with a hose 910. As shown in FIGS. 25A and 25B, mask coupler 968 may be configured to couple with hose coupler 952 of mask 950, allowing adapter 960 to couple with mask 950. When adapter 960 is coupled to mask 950, adapter 960 may allow mask 950 to interact with hose 910 and tension element 920 as described in the above description of mask 900.

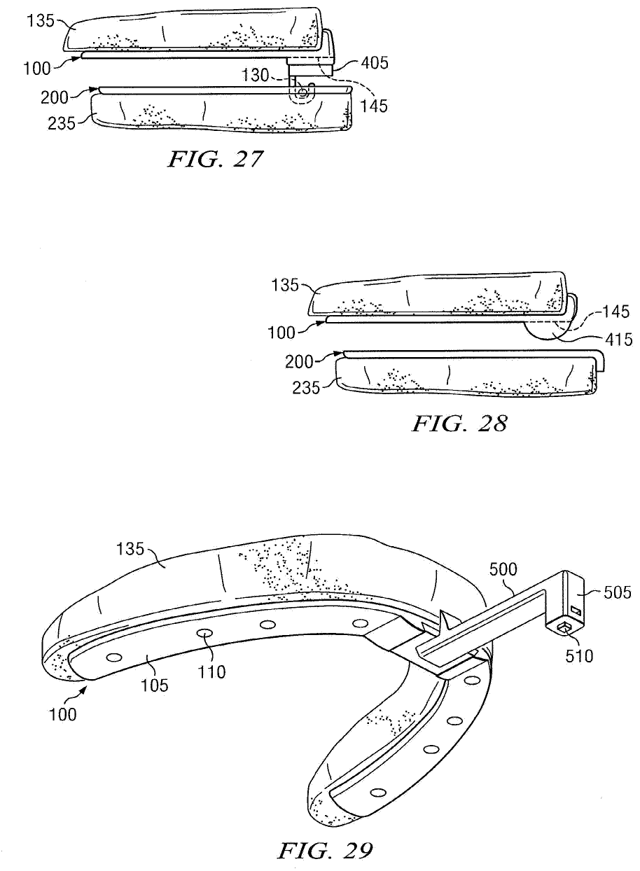

FIG. 27 illustrates an example dental device comprising a universal coupler and an example dental attachment. As shown in FIG. 27, a dental device is provided comprising an arched frame 100, a moldable tray 135, a second arched frame 200, and a second moldable tray 235. Arched frame 100 may comprise a universal coupler comprising a substantially planar surface 145. In particular embodiments, a hook 405 may be configured to engage the universal coupler. In particular embodiments, second arched frame 200 may comprise a receiving mechanism 130 coupled to the lingual portion of second arched frame 200. Receiving mechanism 130 may be a bar that spans the lingual portion of second arched frame 200. In particular embodiments, hook 405 may engage receiving mechanism 130 to adjust the forward position of arched frame 100 relative to second arched frame 200. In certain embodiments, this adjustment may help to prevent a user from snoring when the dental device is inserted in the user's mouth.

FIG. 28 illustrates an example dental device comprising a universal coupler and an example dental attachment. As shown in FIG. 28, a dental device is provided comprising an arched frame 100, a moldable tray 135, a second arched frame 200, and a second moldable tray 235. Arched frame 100 may comprise a universal coupler comprising a substantially planar surface 145. In particular embodiments, a substantially rounded projection 415 may be configured to engage the universal coupler. In particular embodiments, rounded projection 415 may be the only point of contact between the user's upper and lower dental arches to prevent a user from clenching his jaw when the dental device is inserted in the user's mouth. In particular embodiments, rounded projection 415 may contact an opposing arch or may contact one or more incisors of the opposing dental arch to prevent a user from clenching his jaw when the dental device is inserted in the user's mouth. The opposing arch may have a contact surface that may be planar.

The universal oral appliance comprising a universal coupler may provide several advantages for a user. In particular embodiments, a universal oral appliance comprising a universal coupler may offer more use options to a user. For example, a user's appliance may be fitted with several different dental attachment options. The user may choose which dental attachment is best suited for his situation without having to hire a lab to construct another appliance. In particular embodiments, a particular user may also adjust the dental attachment to better suit the shape and size of the user's mouth. This disclosure contemplates the universal oral appliance being created from parts in a kit. A user may purchase the kit instead of a dental device created in a laboratory.

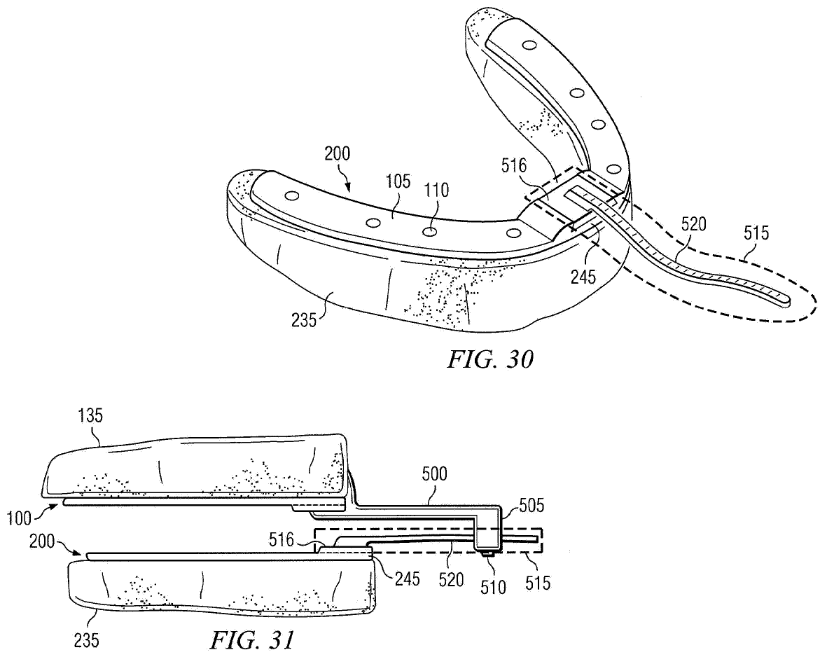

FIG. 29 illustrates an example arch comprising a dental attachment. As shown in FIG. 29, an arch is provided that comprises an arched frame 100 and a moldable tray 135 coupled to arched frame 100. Arched frame 100 comprises an arched body 105 that defines a plurality of apertures 110. The arch may further comprise a dental attachment configured to engage arched frame 100. In particular embodiments, the dental attachment is configured to engage arched frame 100 along the midline of arched frame 100. In particular embodiments, the dental attachment may comprise a post 500 and an anchoring element 505. Post 500 may be coupled at a first end to anchoring element 505. In particular embodiments, a second end of post 500 may engage arched frame 100. In some embodiments, post 500 may be configured to removably engage arched frame 100. In particular embodiments, anchoring element 505 may include a buckle, a slot, a clasp, a clamp, and/or any other appropriate element to anchor a tension element. In some embodiments, anchoring element 505 may be configured to be outside a user's mouth when the arch is inserted in the user's mouth. In some embodiments, the dental attachment may further comprise a release mechanism 510. As an example and not by way of limitation, release mechanism 510 may be a button or a latch. Although this disclosure describes certain types of release mechanisms 510, this disclosure contemplates any suitable release mechanism 510. Although this disclosure describes an arch comprising arched frame 100, moldable tray 135, and a dental attachment, this disclosure contemplates a one-piece arch comprising a dental attachment.

FIG. 30 illustrates an example arch comprising a second anchoring element and a tension element. As shown in FIG. 30, an arch is provided that comprises an arched frame 200 and a moldable tray 235 coupled to arched frame 200. Arched frame 200 comprises an arched body 205 that defines a plurality of apertures 210. The arch may further comprise a second anchoring element 245. In particular embodiments, second anchoring element 245 may be coupled to the arch along the midline of the arch. The arch may further comprise a tension element 515. In particular embodiments, tension element 515 may be flexible and may be configured to engage second anchoring element 245. In particular embodiments, tension element 515 may be further configured to couple to an anchoring element outside a user's mouth when the arch is inserted in the user's mouth. In some embodiments, tension element 515 may comprise a strap 520 and a coupler 516. Coupler 516 may be configured to engage the second anchoring element. In particular embodiments, coupler 516 may be configured to removably engage the second anchoring element. Strap 520 may be coupled to coupler 516. In particular embodiments, strap 520 may be configured to engage the anchoring element outside the user's mouth when the arch is inserted in the user's mouth. In particular embodiments, strap 520 may comprise a hard plastic, leather, or metal. In certain embodiments, strap 520 may be a zip tie. In other embodiments, strap 520 may be a wire, belt, string, or any other appropriate element to engage the anchoring element. Although this disclosure describes an arch comprising arched frame 200, moldable tray 235, and tension element 515, this disclosure contemplates a one-piece arch comprising tension element 515.

FIG. 31 illustrates an example dental device comprising a dental attachment, a second anchoring element, and a tension element. As shown in FIG. 31, a dental device is provided that comprises an arched frame 100 and a second arched frame 200. The dental device further comprises a moldable tray 135 coupled to arched frame 100 and a second moldable tray 235 coupled to second arched frame 200. The dental device may further comprise a dental attachment configured to engage arched frame 100. In particular embodiments, the dental attachment may comprise a post 500 and an anchoring element 505. The dental device may further comprise a second anchoring element 245. Second anchoring element 245 may be coupled to second arched frame 200. The dental device may further comprise a tension element 515. Tension element 515 may be configured to engage second anchoring element 245. In particular embodiments, tension element 515 may comprise a coupler 516 and a strap 520. In particular embodiments, strap 520 may be configured to engage anchoring element 505 outside the user's mouth when the dental device is inserted in the user's mouth. Anchoring element 505 may be configured to secure substantially the length of strap 520 engaged to anchoring element 505. In particular embodiments, increasing the length of strap 520 engaged to anchoring element 505 will adjust the forward position of arched frame 100 relative to second arched frame 200. In particular embodiments, the dental attachment may further comprise a release mechanism 510.

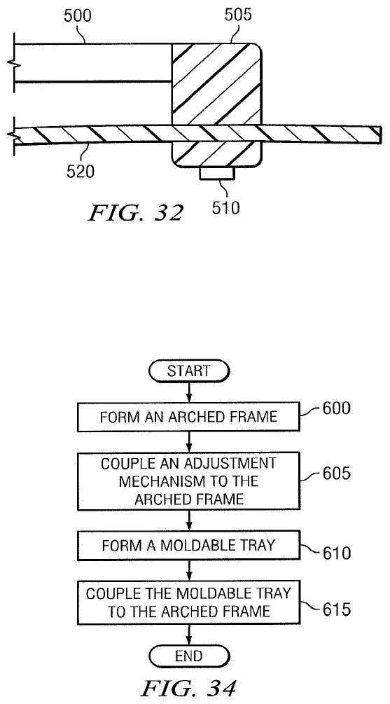

FIG. 32 illustrates an example dental attachment and tension element. As shown in FIG. 32, a dental attachment is provided comprising a post 500 and an anchoring element 505. Anchoring element 505 may be coupled to an end of post 500. A tension element is also provided comprising a strap 520. Strap 520 may be configured to engage anchoring element 505. Anchoring element 505 may be configured to secure the length of strap 520 engaged to anchoring element 505. In particular embodiments, the dental attachment may comprise a release mechanism 510. Release mechanism 510 may be configured to release strap 520 from anchoring element 505.

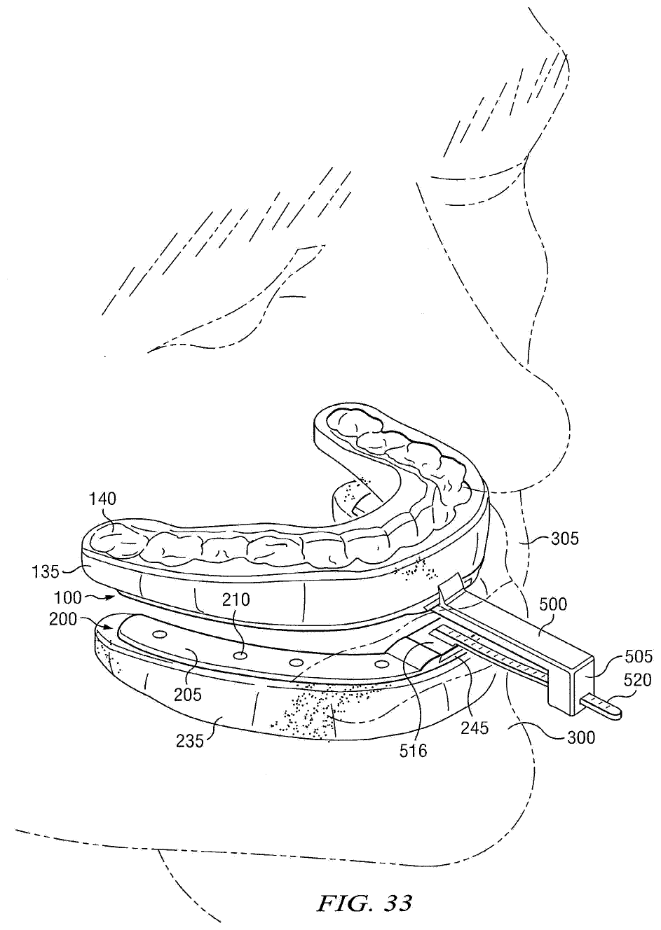

FIG. 33 illustrates an example dental device in a user's mouth. As shown in FIG. 33, a dental device is provided that comprises an arched frame 100, a second arched frame 200, a moldable tray 135 coupled to arched frame 100, and a second moldable tray 235 coupled to second arched frame 200. Moldable tray 135 may comprise a channel 140 configured to engage at least some of the teeth of the user's maxillary arch 305. Second arched frame may comprise a second arched body 205 that defines a second plurality of apertures 210. The dental device may further comprise a dental attachment. The dental attachment may comprise a post 500 and an anchoring element 505. Anchoring element 505 may be coupled to an end of post 500, and a second end of post 500 may be configured to engage arched frame 100. Anchoring element 505 may be configured to be outside the user's mouth when the dental device is inserted in the user's mouth. The dental device may further comprise a second anchoring element 245 coupled to second arched frame 200. The dental device may further comprise a tension element comprising a coupler 516 and a strap 520. Coupler 516 may be configured to engage second anchoring element 245. Strap 520 may be coupled to coupler 516 and may be configured to engage anchoring element 520 outside the user's mouth when the dental device is inserted in the user's mouth. Anchoring element 505 may be configured to secure substantially the length of strap 520 engaged to anchoring element 505. In particular embodiments, increasing the length of strap 520 engaged to anchoring element 505 may adjust the forward position of arched frame 100 relative to second arched frame 200. In particular embodiments, adjusting the forward position of arched frame 100 relative to second arched frame 200 may adjust the forward position of the user's maxillary arch 305 relative to the user's mandibular arch 300. In particular embodiments, adjusting the forward position of the user's maxillary arch 305 relative to the position of the user's mandibular arch 300 may help to improve the user's breathing and/or prevent the user from snoring.

In particular embodiments, the dental device comprising a dental attachment and a tension element may allow a third party faster access to a user's mouth and airway. For example, if the user is a patient sleeping in a sleep laboratory, a doctor in the laboratory may quickly pull on the tension element to open an airway that closed while the patient slept. As another example, if the user is a patient undergoing surgery in a hospital, a surgeon may quickly release the tension element to open the patient's mouth for intubation or for insertion of an instrument while the patient is sedated. In particular embodiments, the dental device comprising a dental attachment and a tension element may pull the user's lower jaw forward without locking the lower jaw in place. The user's lower jaw will maintain a certain range of lateral motion while the dental device is inserted in the user's mouth. This disclosure contemplates the dental device comprising a dental attachment and a tension element being created from a kit. A patient, doctor, or surgeon may purchase the kit and create the dental device quickly. In particular embodiments, the dental device may be a disposable device that may be thrown out after one or more uses,

FIG. 34 illustrates an example process for creating a dental device. At step 600, an arched frame is formed. In particular embodiments, the arched frame may be configured to be positioned proximate to the occlusal surface of a user's dental arch such that the arched frame extends beyond the cuspids of the user's dental arch. The arched frame may define a plurality of apertures. At step 605, an adjustment mechanism is coupled to the arched frame. In particular embodiments, the adjustment mechanism may comprise a hook and a threaded adjustor. At step 610, a moldable tray is formed. In particular embodiments, the moldable tray may comprise a channel configured to engage at least some of the teeth of the user's dental arch. In some embodiments, the channel may be shaped to conform to the teeth of a generic user's dental arch. In other embodiments, the channel may be a smooth channel configured to cover some of the teeth of the user's dental arch. In particular embodiments, the channel may be further shaped to conform to a particular user's dental arch. At step 615, the moldable tray is coupled to the arched frame. In particular embodiments, the moldable tray may engage the plurality of apertures. In particular embodiments the process may be repeated to form a second arched frame and a second moldable tray. In particular embodiments, the arched frame may comprise kevlar polycarbon, acrylic, polycarbonate resin thermoplastic, or any other suitable hard plastic polymer. In particular embodiments, the moldable tray may comprise polycaprolactone.

In particular embodiments, the process illustrated in FIG. 34 may lead to faster creation and production of dental devices. Users may avoid sending dental impressions to a laboratory to create a dental devices thus saving time and money.

Although example steps are illustrated and described, the present invention contemplates two or more steps taking place substantially simultaneously or in a different order. For example, step 605, coupling an adjustment mechanism to the arched frame, may be performed after step 610, forming a moldable tray. In addition, the present invention contemplates using methods with additional steps, fewer steps, or different steps, so long as the steps remain appropriate for creating a dental device.

Various embodiments disclosed herein may be used together in a variety of combinations. For example, in certain embodiments, the various posts, such as posts 802 and 882, may be coupled to any of the various oral appliances disclosed herein, including the oral appliances disclosed in U.S. Pat. No. 7,748,386. As another example, the various posts described herein may be coupled to any of the various masks disclosed, such as but not limited to masks 850, 890, 892, and 894. As another example, in certain embodiments, the various adjustment mechanisms may be used with the various oral appliances disclosed herein, including the adjustment mechanisms and oral appliances disclosed in U.S. Pat. No. 7,748,386. As another example, in certain embodiments the various oral appliances may be coupled with the various dental attachments disclosed herein.

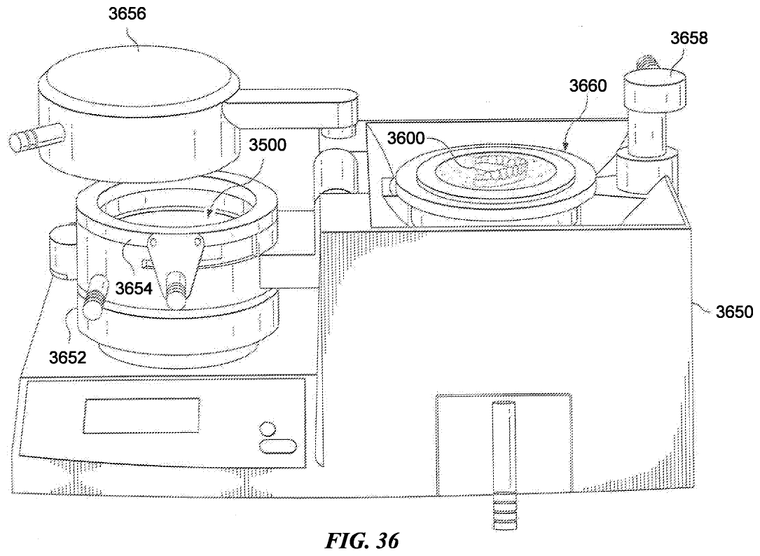

FIG. 35 illustrates an example thermoplastic polymer disk 3500. Disk 3500 may be configured to form a tray B108 or B116 in oral appliance B100. In some embodiments, disk 3500 may be configured to form a custom oral appliance for the dentition of a particular user's mouth. An oral appliance (e.g., oral appliance B100) may be formed by thermoforming disk 3500 over oral models (e.g., oral model 3600 of FIG. 36). Thermoforming may include the processes of pressure molding, vacuum forming, and blow down. Disk 3500 may be in any suitable shape. In some embodiments, disk 3500 resembles a sheet rather than a circular disk.

As illustrated in FIG. 35, disk 3500 may be round in shape and sufficient in size to form an oral appliance. In some embodiments, disk 3500 may be configured to fit into standard blow down machines or vacuum formers. For example, disk 3500 may have a diameter of 125 mm. Although this disclosure gives particular examples of the size and shape of disk 100, this disclosure contemplates that disk 3500 may be of any practical and/or suitable size and shape.

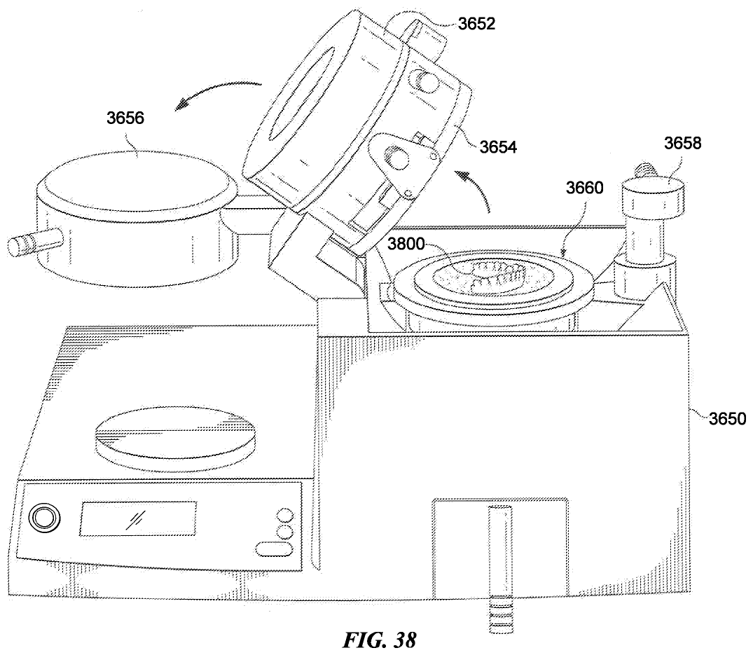

Disk 3500 may be formed using an irradiated, cross-linked thermoplastic polymer. In some embodiments, this material may form part an oral appliance (e.g., oral appliance 3800 of FIG. 38 and/or trays B108 and B116 of oral appliance B100). Disk 3500 may have a thickness between 0.3 and 3.0 mm. In certain embodiments, disk 3500 has a thickness between 0.5 mm and 0.7 mm (e.g., approximately 0.6 mm). Generally, disk 3500 may be thermoformed (e.g., by a blow down machine or vacuum former) over a custom oral model (e.g., oral model 3600 of FIG. 36) to form an oral appliance (e.g., oral appliance 3800 of FIG. 38 and/or trays B108 and B116 of oral appliance B100).

Disk 3500 is composed of a material (e.g., a thermoplastic) that can be heated to a temperature at which the material softens and becomes capable of being molded to a different shape. In certain instances, the material can be heated in hot or boiling water. The temperature range at which the material softens is approximately 40 to 80 degrees Celsius, although materials with other softening ranges may be used. In a particular embodiment, the target softening temperature may be approximately 60 degrees Celsius. In certain embodiments, this material may be a thermoplastic. Such thermoplastic materials may be heated to a temperature at which the thermoplastic becomes soft and moldable, at which point it may be molded to the shape of at least a portion of a user's dental arch and become at least temporarily fixed in that shape.

As one example, disk 3500 may comprise a polycaprolactone (“PCL”) polymer or other aliphatic polyester. As an example, disk 3500 may comprise CAPA 6500. In particular embodiments, the thermoplastic material may comprise a cross-linked polycaprolactone reinforced with an aramid fiber such as the short length aramid fiber sold by Dupont under the brand name Kevlar®. In certain embodiments, using polycaprolactone combined with Kevlar® may allow disk 3500 to soften at low temperatures and set hard at temperatures of approximately 60 degrees Celsius. In certain embodiments, using polycaprolactone combined with Kevlar® may improve the hardness of disk 3500 following the molding process, which may improve the ability of disk 3500 to hold its shape. In certain embodiments, this increased hardness may also improve the ability of disk 3500 to hold its shape for longer periods of time. For example, in certain embodiments, this may allow disk 3500 to substantially hold its shape for periods longer than approximately 1 month, though such period is not required. Using polycaprolactone combined with Kevlar® may also allow for thinner embodiments of disk 3500, which may allow an oral appliance comprising disk 3500 to take up less space in a user's mouth. Examples of polycaprolactone combined with an aramid fiber, including Kevlar® and a variety of other fibers, are described in U.S. application Ser. No. 11/368,991, publication number U.S. 2007/0004993 A1, which is incorporated herein by reference. Such embodiments may provide an improved moldable material that better maintains its form when heated, providing increased viscosity which may prevent the material from flowing excessively around the user's teeth and/or getting stuck on the user's teeth during the molding process. Such embodiments may also possess increased strength after molding.

The thermoplastic material may be cross-linked by radiation, which may create cross-linking of certain molecules to improve the material's shape retention characteristics and/or make the material better able to return to its original shape after reheating. In some embodiments, radiation is applied after disk 3500 has been thermoformed over an oral model (see e.g., oral appliance 3800 formed over oral model 3600 of FIG. 38), but before being molded to the user, though this is not required. Cross-linking by radiation may provide improved shape-retention characteristics, such that disk 3500 may be better able to return to its manufactured shape under certain conditions. Cross-linking by radiation is further described in U.S. Pat. No. 5,415,623, which is incorporated herein by reference.

Cross-linking certain molecules of disk 3500 by applying radiation may allow disk 3500 to be shaped to conform to the user's dentition while having improved memory, such that disk 3500 may be better able to return to its manufactured shape under certain conditions. Disk 3500 may have a first shape that may be partially or substantially defined by the memory. The term “memory” is used herein to describe the characteristic of plastics or polymeric materials to return to an original shape after distortion from the original shape into a second shape. Distortion from the original shape to the second shape may occur, for example, during post-manufacture molding processes such as when a user or dentist desires a better and/or more comfortable user fit for the oral appliance. Returning to the original or “preform” shape may occur under certain conditions, such as, for example, heating to a temperature greater than the melting temperature of the material of disk 3500. The first (or “preform”) shape can be imparted memory by various means depending upon the particular plastic or polymeric material used. For example, memory can be imparted to the first shape by mechanical forming, chemical radiation or other cross-linking, predetermined stretching, molding in place, or other known procedures.

Certain materials that are capable of having a memory imparted to them include, but are not limited to, caprolactone polymer (sometimes known as oxepanone polymer), which may be a polymer having the formula:

H[0(CH2)5CO]xO(CH2)4-H[O(CH2)5CO]yO

Caprolactone polymer may also be initiated with butane diol. Other materials may include poly(ethylene adipate), poly(epsilon-caprolactone), polyvinyl stearate cellulose acetate butyrate, ethyl cellulose, any suitable material, or any suitable combination thereof. In certain embodiments, second layer 120 is formed from a polymeric material, such as a caprolactone polymer, which has a molecular weight of about 50,000, a melting point of about 58 to 60 degrees Celsius, a specific gravity of 1.10 at 20 degrees Celsius, and a viscosity of 1.5 million centipoises at 100 degrees Celsius. In some embodiments, disk 3500 is formed from an extruded sheet of low temperature plastic stock material using, for example, the materials listed above or any suitable combination thereof.

After forming disk 3500, disk 3500 may be cross-linked by radiation. In some embodiments, disk 3500 is irradiated between 1 and 15 kGy (e.g., approximately 5 kGy) which may be performed, for example, using a cobalt gamma irradiator. In certain embodiments, disk 3500 is irradiated between 1.5 and 2.5 kGy (e.g., approximately 2 kGy). As another example, irradiation may be performed using electron beam irradiation. As described herein, irradiation may occur before and/or after disk 3500 is thermoformed over models (e.g., oral model 3600) in order to create a custom oral appliance (e.g., oral appliance 3800 or oral appliance B100). Because the custom oral appliance comprises cross-linked thermoplastic, the oral appliance may have certain properties that permit post-manufacture reshaping such that a user may submerge oral appliance 400 or B100 in heated liquid and remold the thermoplastic tray to conform to the user's dentition as described above. Following post-manufacture reshaping, the thermoplastic may remain stiff and substantially unyielding at ambient temperatures.

In certain embodiments, the material may exhibit slight shrinkage after being re-molded to the user's dental arch. In particular embodiments, such shrinkage may be less than 1%. Slight shrinkage of the material following the remolding process may allow for improved fit with the user's dental arch. In some embodiments, slight shrinkage of the material following the remolding process may allow oral appliance 400 or B100 to have a “snap” fit with the user's dental arch.

FIGS. 36-38 illustrate an example of a pressure molding machine 3650 at different stages of a molding process. Pressure molding machine 3650 may be configured to mold any number of items, including but not limited to oral appliances.

In some embodiments, such as the embodiment illustrated in FIGS. 36-38, pressure molding machine 3650 comprises a pressure chamber 3652, a clamping frame 3654, a heating element 3656, a locking handle 3658, and a molding platform 3660. As will be described in reference to FIGS. 36-38, pressure molding machine 3650 may be used to thermoform oral appliance 3800 (or the trays B108 and B116 of oral appliance B100) from disk 3500.

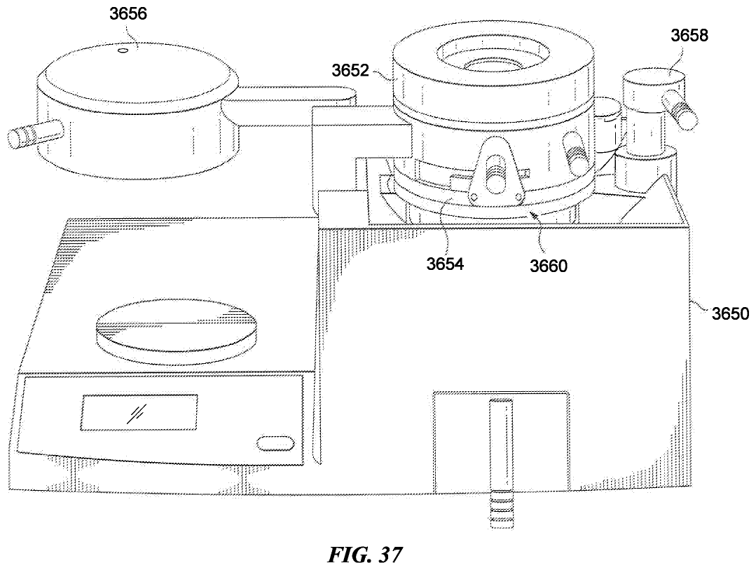

Pressure chamber 3652 is a compartment configured to receive and retain a disk of material (e.g., disk 3500) through one or more molding steps. For example, pressure chamber 3652 may be configured to receive a disk of material and retain the disk during the pendency of heating and/or forming steps of the molding process. Clamping frame 3654 may be configured to secure the disk of material to pressure chamber 3652. Heating element 3656 may be configured to apply heat to the disk of material. In some embodiments, such as the embodiment illustrated in FIGS. 36-38, heating element 3656 is configured to swivel from an active position to a resting position. As used herein, an “active position” refers to a usable position of heating element 3656 (such that heating element 3656 can apply heat to the disk of material) and a “resting position” refers to an unusable position of heating element 3656 (such that heating element 3656 is not properly positioned to apply heat to the disk of material). In the illustrated embodiment, pressure chamber 3652 (along with clamping frame 3654) is configured to swing from a first (preparatory) position (see e.g., FIG. 36) to a second (molding) position (see e.g., FIG. 37), wherein the pressure chamber 3652 is substantially positioned above molding platform 3660 when in the molding position. In some embodiments, molding platform 3660 is configured to support an oral model 3600. The embodiment of FIGS. 36-38 also includes locking handle 3658 which may be configured to move from an unlocked position (see e.g., FIGS. 36 and 38) to a locked position (see e.g., FIG. 36). In some embodiments, pressure chamber 3652 is secured in the molding position when locking handle 3658 is in the locked position. Additionally, in some embodiments, moving locking handle 3658 into the locked position may activate the pressurization of pressure chamber 3652.

FIG. 36 illustrates pressure molding machine 3650 in the preparatory position. In some embodiments, a disk of material (illustrated as disk 3500) is positioned on and/or in pressure chamber 3652. In some embodiments, the orientation of disk 100 on and/or in pressure chamber 3652 may be important. As described above, disk 3500 may have been irradiated such that the material is cross-linked. As explained above, cross-linking the material may have certain advantages. For example, cross-linking the material may prevent the material from becoming fluid and flowing away during the thermoforming process (e.g., at temperatures exceeding the melting/softening point of the material).

In some embodiments, disk 3500 may be secured in and/or to pressure chamber 3652 using clamping frame 3654 after being oriented as desired. In some embodiments, heat is applied to disk 3500 using heating element 3656. Heating element 3656 may be swiveled into the active position when applying heat to disk 3500 and returned to the resting position once heat has been applied to disk 3500. In some embodiments, disk 3500 is sufficiently heated when the material(s) comprising disk 3500 have reached their melting/softening points. The temperature and duration of the heat applied may depend on the composition and/or thickness of disk 3500. As stated above, cross-linking of the material may prevent the material from becoming fluid and flowing away.

As illustrated in FIG. 36, oral model 3600 may be positioned on/atop molding platform 3660. In some embodiments, oral model 3600 may be a custom mold of a particular user's dentition. Oral model 3600 may be received from a dental practitioner. In certain embodiments, oral model 3600 is a casting formed by pouring plaster into dental impressions taken by a dental practitioner. In other embodiments, oral model 3600 may be a custom mold printed (e.g., 3D-printed) from dental scans received from a dental practitioner. Although this disclosure describes particular exemplary origins for oral model 3600, this disclosure recognizes that oral model 3600 may result from any suitable origin, including but not limited to over-the counter impressions that a user took himself/herself.

FIG. 37 illustrates pressure molding machine 3650 in the molding position. In some embodiments, pressure chamber 3652 is swung from the preparatory position to the molding position after applying sufficient heating to disk 3500. As illustrated in FIG. 37, locking handle 3658 is in the locked position. As described above, moving locking handle 3658 into the locked position may secure pressure chamber 3652 in the molding position and activate the flow of air pressure into pressure chamber 3652. Additionally, when pressure chamber 3652 is in the molding position, the material(s) of heated disk 3500 will distribute over oral model 3600. Pressurizing pressure chamber 3652 forces the material(s) of disk 3500 into contact with all surfaces of oral model 3600, thereby creating oral appliance 3800 or trays B108 or B116 of oral appliance B100. In some embodiments, pressurizing pressure chamber 3652 also results in the cooling of the heated material(s). Duration of cooling may depend on the materials in disk 3500 and/or the thickness of disk 3500. As an example, cooling time of disk 3500 may be between 135-165 seconds. In some embodiments, an operator of pressure molding machine 3650 may configure various settings of the pressure molding machine 3650, including but not limited to the amount of pressure delivered to pressure chamber 3652, the amount of time that pressure is delivered to pressure chamber 3652, the temperature of the heat applied by heating element 3656, and/or the amount of time that heat is applied to pressure chamber 3652. Additionally, this disclosure recognizes that cooling time may also be adjusted. In some embodiments, cooling time may be adjusted based on a desired amount of retention. Less cooling time may lead to less retention and more cooling time may lead to more retention. Although this disclosure describes particular settings that may be adjusted by an operator of pressure molding machine 3650, this disclosure contemplates that an operator may adjust any desired setting to better form oral appliance 3800 or trays B108 and B116 of oral appliance B100.

FIG. 38 illustrates pressure molding machine 3650 after oral appliance 3800 is formed. As illustrated, locking handle 3658 is in the unlocked position, permitting the rotation of pressure chamber 3652 back to the preparatory position. In some embodiments, the pressure in pressure chamber 3652 must be released prior to moving locking handle 3658 into the unlocked position and/or moving pressure chamber 3652 to the preparatory position. Swiveling pressure chamber 3652 back to the preparatory position reveals oral appliance 3800 (which may be trays B108 or B116) around oral model 3600 on molding platform 3660. In some embodiments, oral appliance 3800 is manipulated to separate from oral model 3600. Oral appliance 3800 may then be delivered to a patient for use.

As described above, it is not uncommon for oral devices to not fit their intended user properly and/or comfortably even though a device may be customized for a particular user. In embodiments wherein the oral appliance 3800 comprises a thermoplastic material, oral appliance 3800 may be re-formed post-manufacture to ensure a proper and/or more comfortable user fit. Reformation may be performed by submerging oral appliance 3800 (e.g., oral appliance B100) in water having a temperature high enough to deform the thermoplastic material or oral appliance 3800 (e.g., the material of trays B108 and B116). As an example, reformation may occur by submerging oral appliance 3800 in water heated to a temperature between 40° C. and 80° C. In some embodiments, submerging oral appliance 3800 in heated liquid post-manufacture may soften the thermoplastic material of oral appliance 3800 into a moldable material which may then be pressed into the user's dentition to update the fit of oral appliance 3800. Accordingly, oral appliance 3800 may possess characteristics that permit remolding post-manufacture to accommodate user-specific comfort, oral changes and/or other modifications.

This remolding (refitting) can occur in any location, such as in the dental office (‘chair side’), in any other clinical setting, or in the users' home. This is a benefit over conventional practices, wherein an ill-fitting oral appliance 3800 had to be sent back to the laboratory that fabricated oral appliance 3800, or required the dental practitioner to engage in this activity. The refitting can be assisted by a dental/medical professional, medical/dental assistant, sales person or by the user. Refitting may, in some cases, simply involve heating the thermoplastic material of oral appliance 3800, for example in hot water, to above the melt or softening temperature. Once softened, oral appliance 3800 can be refitted to the user's mouth, such that the thermoplastic material (e.g., trays B108 and B116) will form to the shape of the user's teeth. The thermoplastic material may thereafter cool and set to the shape of the users teeth. Depending on the fit required, the user can leave oral appliance 3800 in his/her mouth for a longer or shorter period. The longer the period of setting, the firmer the fit will be as the thermoplastic will be more set to the user's teeth. Conversely, removing the oral appliance 3800 earlier will cause some of the areas of significant undercuts (areas of retention) to be smoothed out or removed as the semi-set thermoplastic is removed from the teeth.

In embodiments wherein disk 3500 is formed with cross-linked material, reheating the thermoplastic material causes the material to transition back to a relatively uniform layer, of for example 2.0 mm, as the cross-linked material has shape memory of its original form. In some embodiments, the oral appliance 3800 (e.g., tray B108 or B116) has a melt temperature that is higher (over 100 degrees Celsius).

One specific advantage of remolding oral appliance 3800 post-manufacture is the ability for oral appliance 3800 to achieve a desired amount of retention without blockout. This disclosure recognizes that retention may be controlled, at least in part, based on cooling times. As an example, longer cooling times may be associated with more retention and shorter cooling times may be associated with less retention. Conventionally, desired levels of retention are achieved by blockout, which as used herein, refers to the process of adding material to an oral model (e.g., oral model 3600) prior to thermofolding to prevent the oral appliance (e.g., oral appliance 3800) forming around small holes and gaps between the teeth that may result in excessive retention.

In some embodiments, oral appliance 3800 may be customized further post-manufacture. As an example, brackets and/or spacers may be added to oral appliance 3800. As another example, tension elements for repositioning a user's jaw may be added to oral appliance 3800. Although specific examples have been provided, this disclosure contemplates that oral appliance 3800 may be fabricated post-manufacture by adding any suitable or desirable hardware.

As described above in reference to FIG. 35, this disclosure contemplates forming oral appliance 3800 from disk 3500 using other methods of thermofolding such as vacuum forming. Generally, forming oral appliance 3800 by vacuum forming may involve one or more of the following steps: (1) heating disk 3500 (or each layer thereof) to a forming temperature; (2) stretching or draping the heated dual-layer disk 3500 over an oral model (e.g., oral model 3600); (3) applying a vacuum to force dual-layer disk 3500 against oral model 3600; and (4) separating the produced oral appliance 3800 from oral model 3600 once dual-layer disk has cooled. The orientation of disk 3500 may be important during the vacuum forming process. This disclosure recognizes certain benefits to orienting disk 3500 in a way that positions a thermoplastic layer nearest to oral model 3600.

FIGS. 39A-40D show different perspectives of a seal 3900. As shown, seal 3900 includes an arched body 3905, receiving mechanism 3910, pads 3915, and ridge 3920. Seal 3900 may be configured to engage an oral appliance 4000, as shown in FIGS. 40A-5D (which may be the oral appliance B100). This disclosure contemplates seal 3900 being made of a flexible material such as, for example, liquid silicon rubber or any other appropriate material, such as for example, shore A 40 hardness SLR, or similar rubber material, such as Santoprene.

Arched body 3905 may be configured to rest in a user's oral vestibule (e.g., the region of the user's mouth between the user's dentition and the user's lips) and to cover substantially the user's mouth when oral appliance 4000 (e.g., oral appliance B100) is positioned in the user's mouth. Arched body 3905 may be configured to extend beyond the cuspids of the user's maxillary dentition when seal 3900 and/or oral appliance 4000 is positioned in the user's mouth. In particular embodiments, by substantially covering a user's mouth, arched body 3905 inhibits the flow of air through the user's mouth. In this manner, arched body 3905 may prevent drooling and mouth dryness by encouraging the user to breathe through the user's nose when the user is sleeping. For clarity, this disclosure will describe arched body 3905 as resting in the user's mouth, however, this disclosure also contemplates arched body 3905 resting external to the user's oral vestibule.

In certain embodiments, the thickness of arched body 3905 may not be uniform. As an example, a portion of arched body 3905 may be thinner at an end closer to the user's mandibular arch than a portion at an end closer to the user's maxillary arch. In this manner, arched body 3905 may allow for movement of the user's mandibular arch when oral appliance 4000 is positioned in the user's mouth.

Receiving mechanism 3910 may be coupled to arched body 3905. Receiving mechanism 3910 may be configured to engage oral appliance 4000. In particular embodiments, receiving mechanism 3910 includes a tube that engages oral appliance 4000 (e.g., a receiving mechanism B110 and a post B118 of oral appliance B100). The tube is configured so that a post 4002 of oral appliance 4000 (e.g., a post B118) may go through the tube. In particular embodiments, the tube includes ridge 3920 that engages oral appliance 4000. Ridge 3920 may be located on the inside of the tube. When the post 4002 of oral appliance 4000 is positioned into the tube, ridge 3920 may engage a portion of oral appliance 4000 such that the position of seal 3900 is fixed relative to the position of oral appliance 4000.

Receiving mechanism 3910 may include a thin section on one side that may compress and/or fold as oral appliance 4000 moves forward. This allows for the end of receiving mechanism 3910 to remain stationary relative to oral appliance 4000, which allows seal 3900 to stay in contact with the upper and/or lower trays of oral appliance 4000. The thin section may be from 0.4 mm thick to 2.0 mm thick.

In certain embodiments, receiving mechanism 3910 includes a post that engages oral appliance 4000. The post may engage the arched frames of oral appliance 4000 so that the relative position of seal 3900 is fixed relative to the position of oral appliance 4000. In certain embodiments, seal 3900 does not include receiving mechanism 3910. In other embodiments, receiving mechanism 3910 extends towards the inside of the user's mouth when seal 3900 is positioned in the user's mouth.

Pad 3915 may be coupled to arched body 3905. In particular embodiments, pad 3915 may separate the arched frames of oral appliance 4000 when seal 3900 is engaged with oral appliance 4000. In this manner, pad 3915 may increase the vertical space in the oral cavity when oral appliance 4000 is positioned in the user's mouth, which may reduce the amount of protrusion of the user's mandible. Pad 3915 may also help prevent the user from clenching the user's jaw. Furthermore, pad 3915 may help the arched frames of oral appliance 4000 maintain their relative positions. Pad 3915 may be molded integrally, or may be assembled. Pad 3915 may be of a thickness ranging from 1 mm to 12 mm. In particular embodiments, seal 3900 may be molded and supplied with different integral pads 3915. In certain embodiments, pad 3915 may clip onto seal 3900. These pads 3915 may include any appropriate material. For example, pads 3915 may include SLR or harder thermoplastics such as nylon or polycarbonate. As another example, pads 3915 may include a compressible and resilient material that cushions the point of contact between the arched frames of oral appliance 4000. This disclosure contemplates seal 3900 including any appropriate number of pads 3915 coupled to arched body 3905 in any appropriate manner.

Similar to previous embodiments, oral appliance 4000 may include an upper arch and a lower arch (e.g., arches B102 and B104). The upper arch may include an upper arched frame (e.g., frame B106) and the lower arch may include a lower arched frame (e.g., frame B114). The upper arched frame may be configured to be positioned proximate a user's maxillary dentition when the upper arch is positioned in the user's mouth. The lower arched frame may be configured to be positioned proximate the user's mandibular dentition when the lower arch is positioned in the user's mouth. The upper arch and the lower arch may include polycarbonate or any similar rigid or semi-rigid thermoplastic that can withstand deforming and/or melting at 100 degrees Celsius, such as for example polycarbonate resin thermoplastic and/or nylon.

In certain embodiments, the upper arch and the lower arch of oral appliance 4000 may be coupled to moldable trays (e.g., trays B108 and B116). Each moldable tray may be configured to receive a portion of the user's dentition when oral appliance 4000 is positioned in the user's mouth. For example, an upper moldable tray (e.g., tray B108) may be configured to receive a portion of the user's maxillary dentition and a lower moldable tray (e.g., tray B116) may be configured to receive a portion of the user's mandibular dentition. Each moldable tray may include polycaprolactone.

Seal 3900 may include a receptacle 3920 and an electronic compliance monitor 3925. Receptacle 3920 may be any appropriate structure for holding electronic compliance monitor 3925, such as for example, a pocket or a sleeve. This disclosure also contemplates electronic compliance monitor 3925 being molded in to seal 3900 using silicon rubber. For example, a quickform silicon may be applied over a surface of the electronic compliance monitor 3925 to enclose electronic compliance monitor 3925 and to attach electronic compliance monitor 3925 to seal 3900.

Electronic compliance monitor 3925 may monitor certain features of the environment around electronic compliance monitor 3925, such as for example, temperature, air flow, movement, pulse, blood oxygen levels (such as for example through pulse oximetry), etc. In certain embodiments, electronic compliance monitor 3925 may include a chip and/or sensors that measures such features and logs the measurements for further analysis. These measurements may be used, for example, to determine if seal 3900 and/or oral appliance 4000 are positioned properly in the user's mouth or if they are being used appropriately. An example of electronic compliance monitor 3925 includes the DentiTrac® product.

Electronic compliance monitor 3925 communicates measurements to a device for real-time monitoring. For example, electronic compliance monitor 3925 may communicate measurements to a device, such as a mobile phone, over Bluetooth. A doctor and a user may then monitor the measurements when seal 3900 and electronic compliance monitor 3925 are positioned in the user's mouth. Adjustments may then be made to seal 3900 based on the observed measurements.

In certain embodiments, electronic compliance monitor 3925 is removable from receptacle 3920 without altering the structure of seal 3925. In this manner, seal 3900 may be manufactured without electronic compliance monitor 3925, which reduces the cost of electronic compliance monitor 3925. It may not be desirable to mold electronic compliance monitor 3925 into seal 3900 in some embodiments because electronic monitoring may not be performed at all times when seal 3900 is positioned in the user's mouth. As a result, a user need not unnecessarily position electronic compliance monitor 3925 in the user's mouth.

This disclosure contemplates electronic compliance monitor 3925 being used with any appropriate oral appliance, and not merely with seal 3900. For example, electronic compliance monitor 3925 may be coupled to seal 200. As another example, any of the upper arch, the lower arch, the oral appliance 4000, and the oral appliance 4100 may be configured to couple to electronic compliance monitor 3925. This disclosure contemplates using any appropriate mechanism to couple electronic compliance monitor 3925 to any of the devices disclosed herein. For example, a sleeve may be fitted over a portion (such as a post) of oral appliance 4000 and/or oral appliance 4100 and electronic compliance monitor 3925 may be coupled to the sleeve.

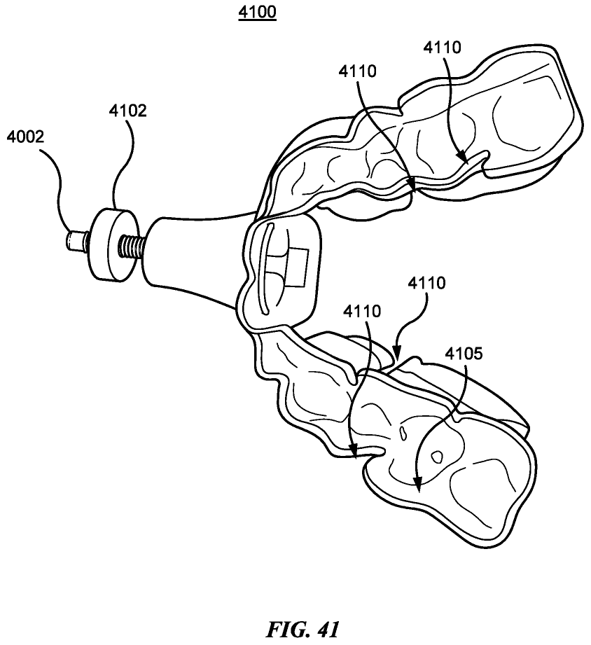

FIG. 41 shows an oral appliance 4100 (which may be an embodiment of oral appliance B100). Oral appliance 4100 includes arched frames 4105. Arched frames 4105 define slots 4110. Slots 4110 may be located on the facial and lingual surfaces of arched frames 4105. In this manner, slots 4110 may be positioned proximate the facial and lingual surfaces of a user's dental arches when arched frames 4105 are positioned in the user's mouth. In particular embodiments, slots 4110 improve the flexibility of arched frames 4105 when arched frames 4105 are being molded based on a user's teeth.

As in previous embodiments, arched frames 4105 are configured to be positioned proximate to the occlusal surface of a user's maxillary and mandibular arches such that the arched frames extend beyond the cuspids of the user's maxillary and mandibular arches when arched frames 4105 are positioned in the user's mouth. Arched frames 4105 may be coupled to each other by a mechanism. Additionally, a post 4002 may extend from one of the arched frames (e.g., a post B118).

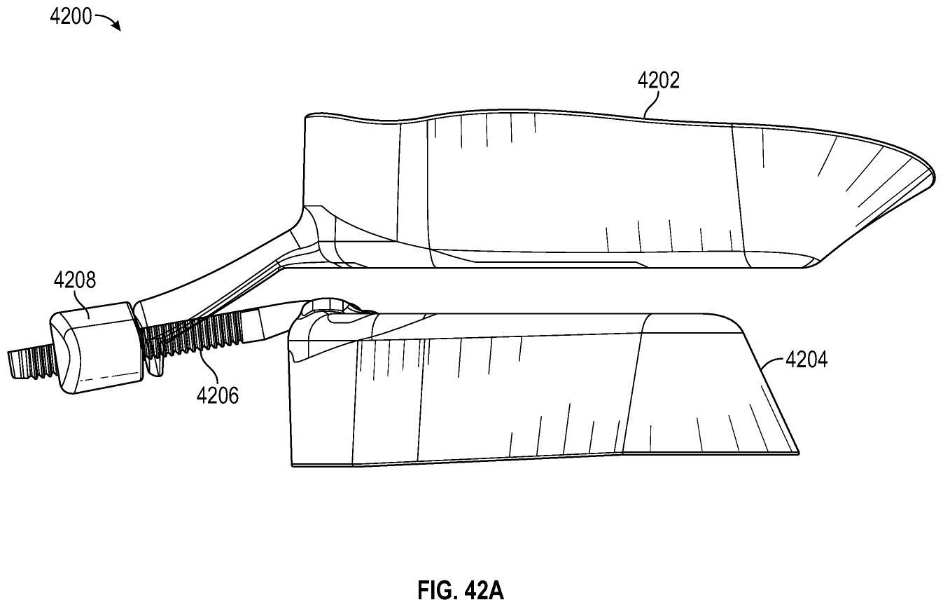

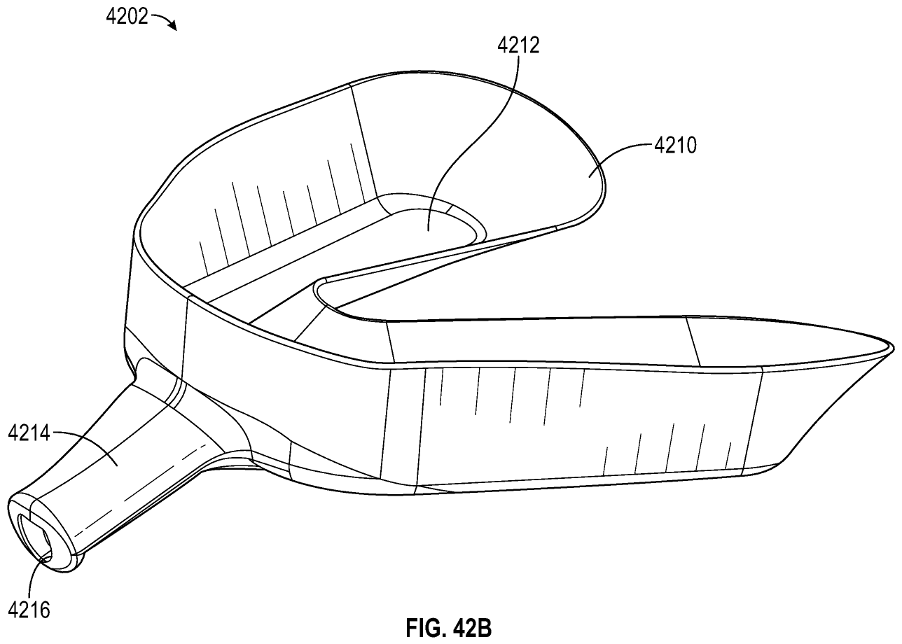

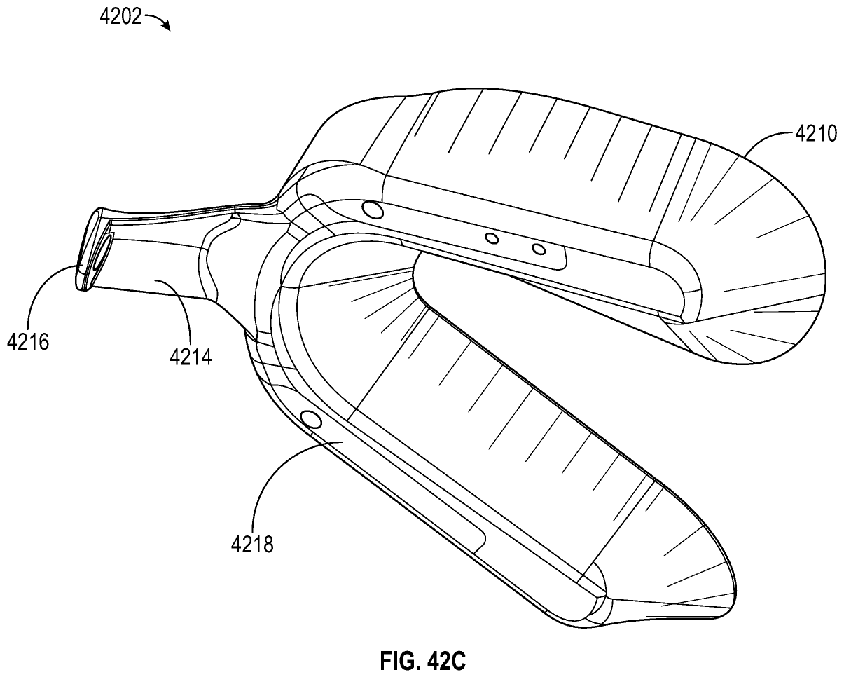

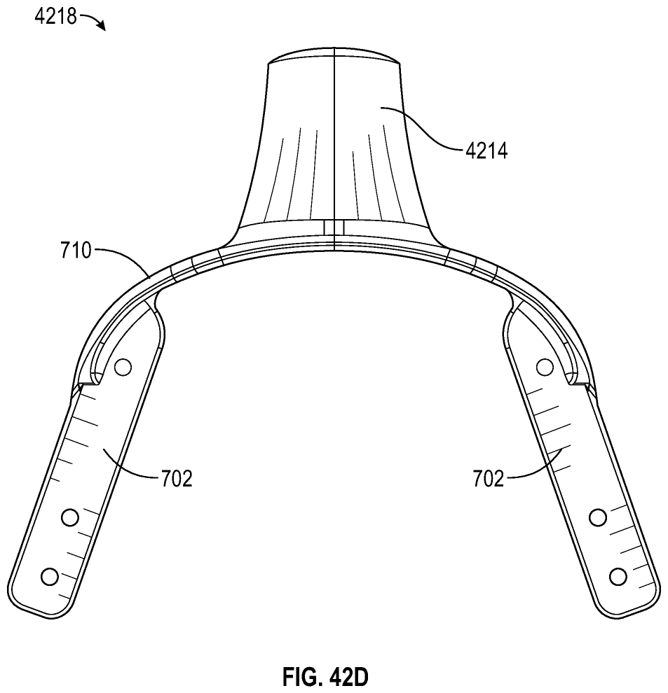

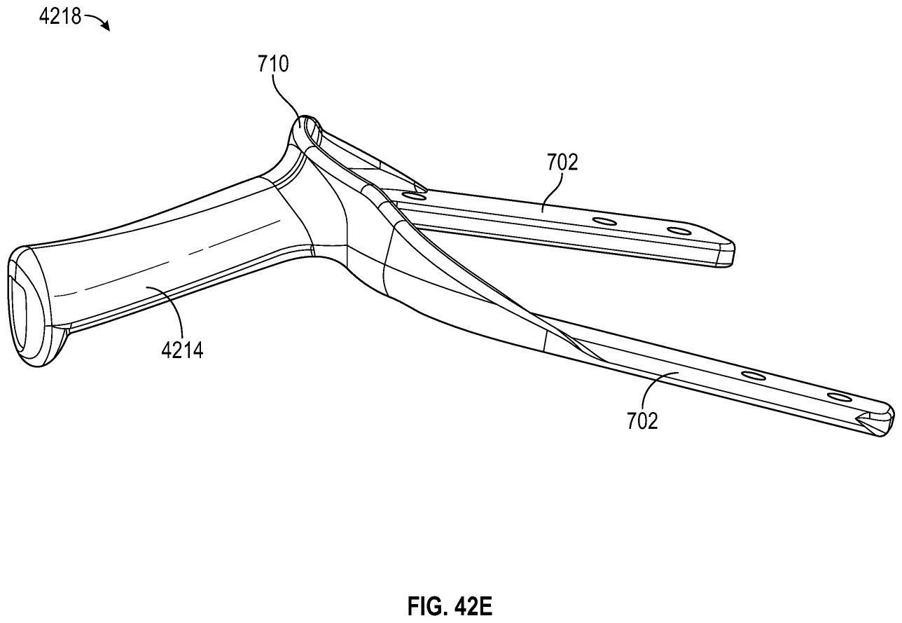

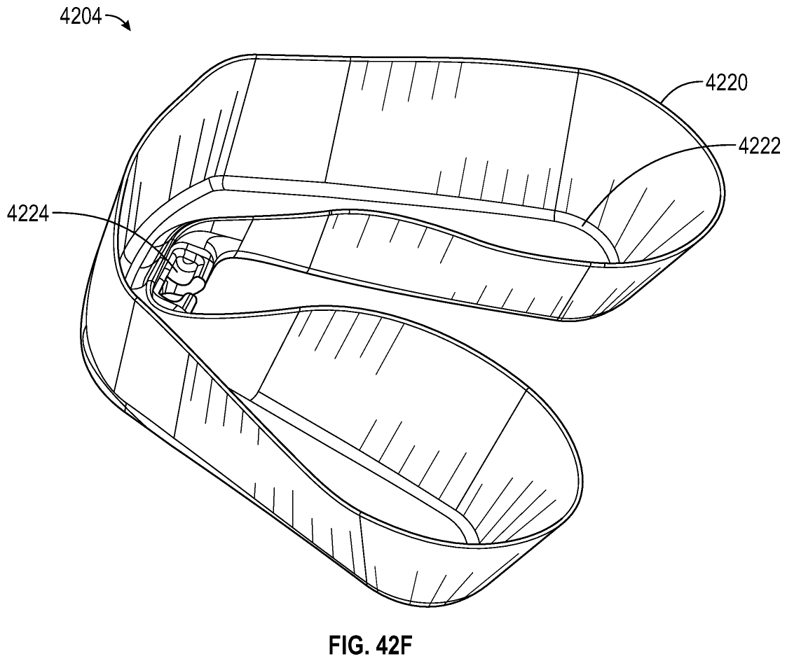

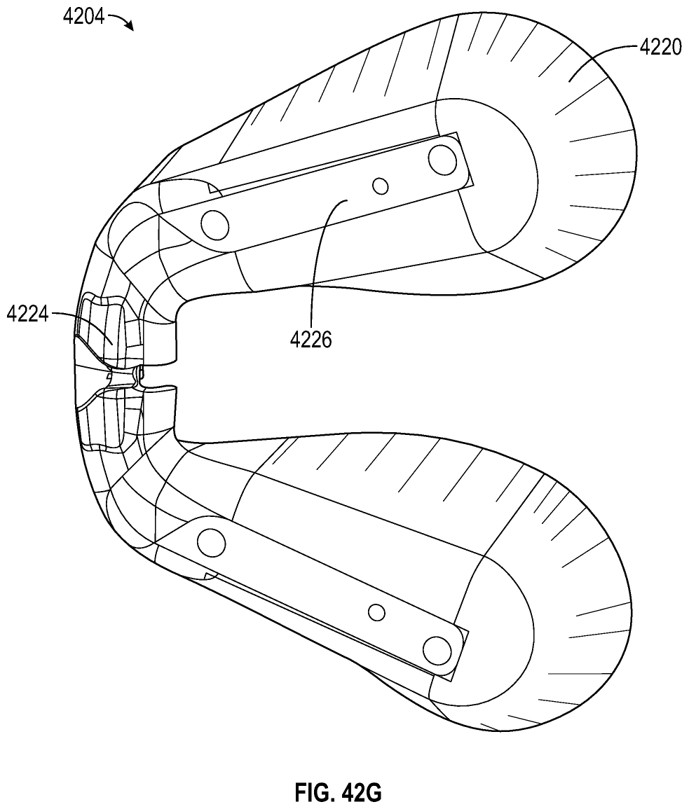

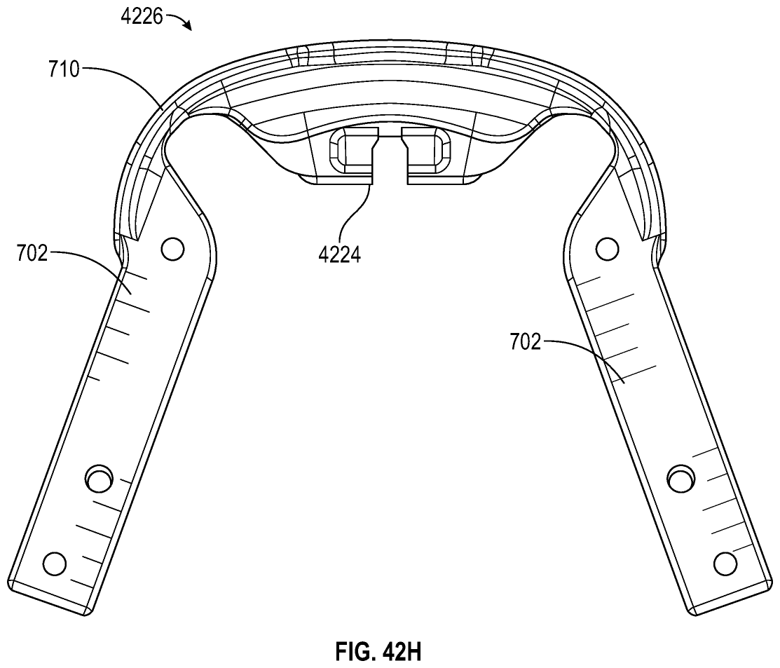

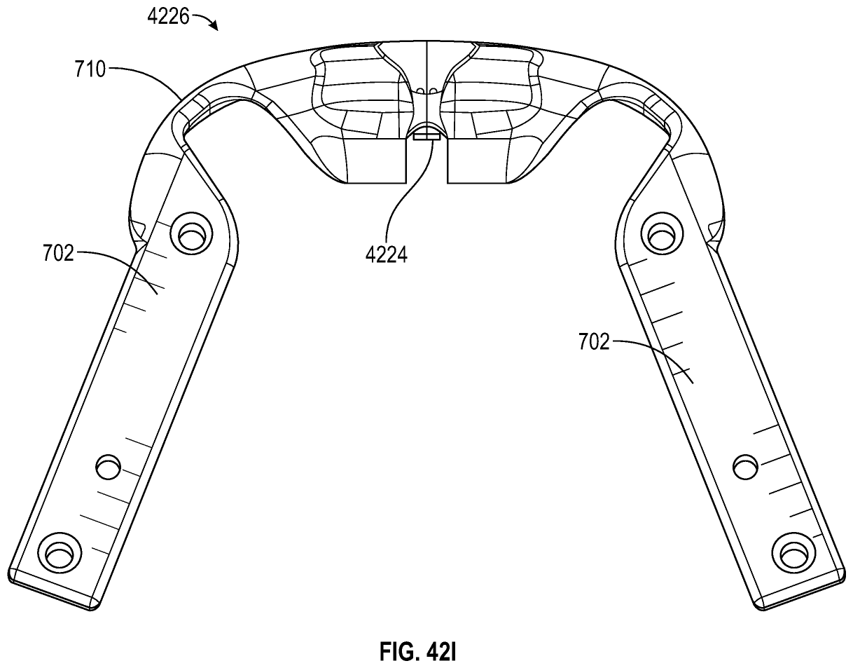

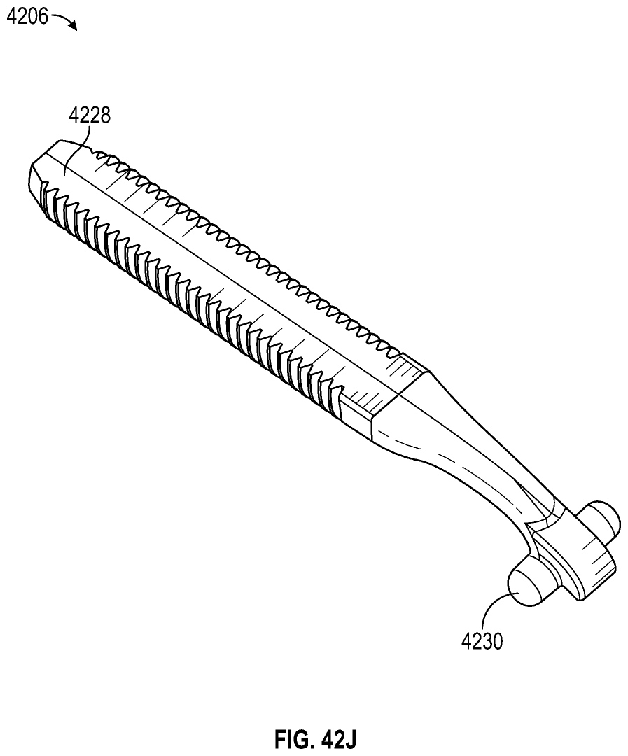

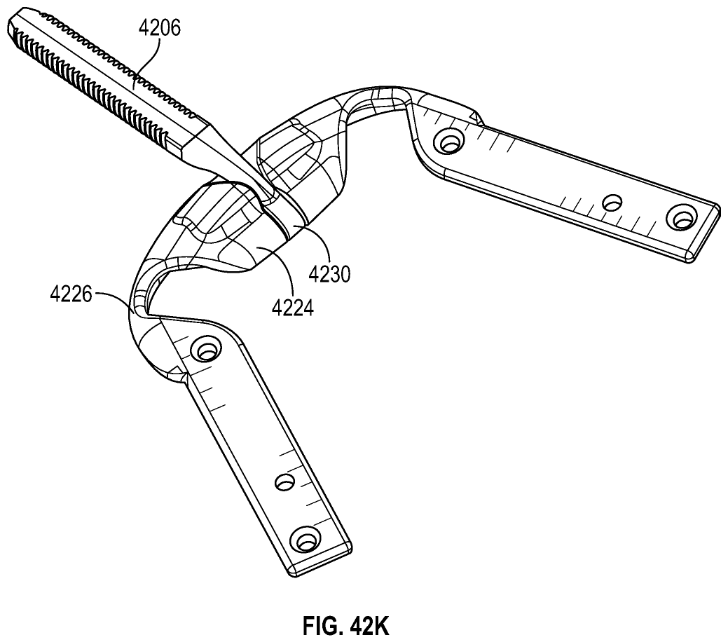

FIGS. 42A through 42K illustrate an example oral appliance 4200 and/or components of the example oral appliance 4200. As seen in FIG. 42A, the oral appliance 4200 includes an upper arch 4202, a lower arch 4204, a post 4206, and an adjustment nut 4208. The upper arch 4202 is coupled to the lower arch 4204 by the post 4206 and the adjustment nut 4208. Generally, the adjustment nut 4208 may be turned to adjust a forward position of the upper arch 4202 relative to the lower arch 4204. When the oral appliance 4200 is positioned within a patient's mouth, turning the adjustment nut adjusts a forward position of the patient's jaw. Additionally, the post 4206 is angled away from the upper arch 4202 (e.g., in an inferior direction) such that turning the adjustment nut 4208 also adjusts a vertical position of the upper arch 4202 relative to the lower arch 4204. When the oral appliance is positioned within the patient's mouth, turning the adjustment nut adjusts an opening of the user's mouth.

FIG. 42B illustrates the upper arch 4202. As seen in FIG. 42B, the upper arch 4202 includes an upper tray 4210 and a receiving mechanism 4214. The upper tray 4210 may be similar to the moldable tray 730 in the examples of FIGS. 9A through 9D and FIGS. 10A through 10C. The upper tray 4210 may be made from a thermoplastic (e.g., polycaprolactone). Additionally, the upper tray 4210 may be cross-linked through irradiation.

The upper tray 4210 forms a channel 4212 that is shaped similar to an oral arch of a patient. An upper oral tray (e.g., similar to the oral appliance 3800) formed using the disk 3500 and the pressure molding machine 3650 described with respect to FIGS. 35 through 38 may be inserted into the channel 4212 to configure the upper arch 4202 to receive a patient's upper dentition. The pressure molding machine 3650 may heat and apply pressure to the disk 3500 over an oral model 3600 of the patient's upper dentition to shape the disk 3500 into an upper oral tray that fits the patient's upper dentition. The upper oral tray and the upper tray 4210 may then be heated, and the upper oral tray may be inserted into the channel 4212. Due to the heating, the upper oral tray may adhere to the upper tray 4210. The upper arch 4202 is then configured to receive the patient's upper dentition.

The receiving mechanism 4214 extends in an anterior direction from the upper arch 4202. The receiving mechanism 4214 may be a tube structure that receives the post 4206 to couple the upper arch 4202 to the lower arch 4204. As seen in FIG. 42B, the receiving mechanism 4214 includes a ring 4216 at an end of the receiving mechanism 4214. The post 4206 extends through the ring 4216 to couple the upper arch 4202 to the lower arch 4204.

FIG. 42C illustrates an inferior side of the upper arch 4202. As seen in FIG. 42C, the upper arch 4202 further includes an upper frame 4218. The upper frame 4218 may be similar to the arched frame 700 in the examples of FIGS. 8A through 8E. The upper tray 4210 is coupled to the upper frame 4218 such that the upper tray 4210 is superior to the upper frame 4218 when the oral appliance 4200 is positioned in the patient's mouth. The upper frame 4218 may be formed from a rigid material, such as polycarbonate.

FIGS. 42D and 42E illustrate an example upper frame 4218. As seen in FIGS. 42D and 42E, the upper frame 4218 includes the receiving mechanism 4214, which extends from the upper frame 4218 in an anterior direction and along a midline of the upper frame 4218. Like the arched frame 700, the upper frame 4218 includes a mesial flange portion 710 and occlusal surfaces 702. The receiving mechanism 4214 is coupled to the mesial flange portion 710 along a midline of the upper frame 4218. The receiving mechanism 4214 extends in an anterior direction from the mesial flange portion 710. The occlusal surfaces 702 are coupled to buccal ends of the mesial flange portion 710. The occlusal surfaces 702 are not directly coupled to each other. Rather there is a separation between the occlusal surfaces 702 that is crossed by the mesial flange portion 710. Additionally, the mesial flange portion 710 extends only partway along the occlusal surfaces 702. As seen in FIGS. 42D and 42E, the occlusal surfaces 702 extend beyond the mesial flange portion 710 in a distal direction (e.g., towards the back of the patient's mouth).

FIG. 42F illustrates an example lower arch 4204. As seen in FIG. 42F, the lower arch 4204 includes a lower tray 4220 and a receiver 4224. The lower tray 4220 may be similar to the moldable tray 730 in the examples of FIGS. 9A through 9D and FIGS. 10A through 10C. The lower tray 4220 may be made from a thermoplastic (e.g., polycaprolactone). Additionally, the lower tray 4220 may be cross-linked through irradiation.

The lower tray 4220 forms a channel 4222 that is shaped similar to an oral arch of a patient. A lower oral tray (e.g., similar to the oral appliance 3800) formed using the disk 3500 and the pressure molding machine 3650 described with respect to FIGS. 35 through 38 may be inserted into the channel 4222 to configure the lower arch 4204 to receive a patient's lower dentition. The pressure molding machine 3650 may heat and apply pressure to the disk 3500 over an oral model 3600 of the patient's lower dentition to shape the disk 3500 into a lower oral tray that fits the patient's upper dentition. The lower oral tray and the lower tray 4220 may then be heated, and the lower oral tray may be inserted into the channel 4222. Due to the heating, the lower oral tray may adhere to the lower tray 4220. The lower arch 4204 is then configured to receive the patient's lower dentition.

The receiver 4224 is positioned along a midline of the lower tray 4220 and lingual to the lower tray 4220. The receiver 4224 is shaped to receive a portion of the post 4206. For example, the receiver 4224 and the post 4206 may be shaped such that the receiver 4224 and the post 4206 form a snap-fit connection. The post 4206 may snap into the receiver 4224 such that the post 4206 cannot easily disengage the receiver 4224 (although proper handling can decouple the post 4206 from the receiver 4224). In some embodiments, the receiver 4224 and the post 4206 may be shaped such that the post 4206 can rotate about the snap-fit connection with the receiver 4224.

FIG. 42G illustrates a superior side of the lower arch 4204. As seen in FIG. 42G, the lower arch 4204 further includes a lower frame 4226. The lower frame 4226 may be similar to the arched frame 700 in the examples of FIGS. 8A through 8E. The lower tray 4220 is coupled to the lower frame 4226 such that the lower tray 4220 is inferior to the lower frame 4226 when the oral appliance 4200 is positioned in the patient's mouth. The lower frame 4226 may be formed from a rigid material, such as polycarbonate.

FIGS. 42H and 42I illustrate an example lower frame 4226. FIG. 42H illustrates an inferior surface of the lower frame 4226. FIG. 42I illustrates a superior surface of the lower frame 4226. As seen in FIGS. 42H and 42I, the lower frame 4226 includes the receiver 4224 positioned along a midline of the lower frame 4226 and lingual to the lower frame 4224. Like the arched frame 700, the lower frame 4226 includes a mesial flange portion 710 and occlusal surfaces 702. The receiver 2442 is coupled to the mesial flange portion 710 along a midline of the lower frame 4226. The receiver 4224 extends in a posterior direction from the mesial flange portion 710. The occlusal surfaces 702 are coupled to buccal ends of the mesial flange portion 710. The occlusal surfaces 702 are not directly coupled to each other. Rather there is a separation between the occlusal surfaces 702 that is crossed by the mesial flange portion 710. Additionally, the mesial flange portion 710 extends only partway along the occlusal surfaces 702. As seen in FIGS. 42H and 42I, the occlusal surfaces 702 extend beyond the mesial flange portion 710 in a distal direction (e.g., towards the back of the patient's mouth).

FIG. 42J illustrates an example post 4206. As seen in FIG. 42J, the post 4206 includes a threaded portion 4228 and a coupler 4230. The coupler 4230 is shaped to engage the receiver 4224 of the lower arch 4204 (e.g., by forming a snap-fit connection with the receiver 4224). In some embodiments, the coupler 4230 allows the post 4206 to rotate about the connection point with the receiver 4224. The threaded portion 4228 is shaped to engage the receiving mechanism 4214 of the upper arch 4202 by extending through the ring 4216 of the receiving mechanism 4214. When the post 4206 is engaged with the receiver 4224 and the receiving mechanism 4214, the upper arch 4202 is coupled to the lower arch 4204. Additionally, the threaded portion 4228 is configured to engage the adjustment nut 4208. The adjustment nut 4208 may be turned while engaged with the post 4206 to adjust a position of the adjustment nut 4208 on the post 4206. The position of the adjustment nut 4208 on the post 4206 controls how much of the post 4206 extends through the ring 4216 of the receiving mechanism 4214. As a result, the position of the adjustment nut 4208 controls a forward position of the upper arch 4202 relative to the lower arch 4204, which affects a forward position of a patient's jaw. In some embodiments, the post 4206 is angled away from the upper arch 4202 in the inferior direction such that the position of the adjustment nut 4208 also controls a vertical distance between the upper arch 4202 and the lower arch 4204, which affects how far a patient can open or close the patient's mouth. Causing the patient's mouth to open further creates extra volume in the mouth and space for the tongue, which improves clinical outcomes (e.g., when treating sleep apnea).

In some embodiments, the post 4206 and/or the threaded portion 4228 is curved such that the threaded portion 4228 angles even further in the inferior direction when coupled to the lower arch 4204. In this manner, the post 4206 and the adjustment nut 4208 can create an even greater vertical distance between the upper arch 4202 and the lower arch 4204, which can cause the patient to open the patient's mouth even more.

In certain embodiments, posts 4206 with different lengths and/or curvatures are provided to allow for different ranges of advancement and vertical adjustment. These posts 4206 may be interchangeably coupled to the lower arch 4204 depending on the needs of the patient. For example, a longer post 4206 may be used for a patient who needs a greater forward adjustment of the jaw. As another example, a post 4206 with more curvature may be used for a patient who needs more space in the patient's mouth.

The posts 4206 may include any suitable mechanism for engaging and coupling to the receiving mechanism 4214 of the upper arch 4202. For example, instead of having threads that engage an adjustment nut 4208 to prevent the posts 4206 from disengaging the receiving mechanism 4214, the posts 4206 may be shaped to couple to the ring 4216 near an end of the posts 4206 (e.g., through a snap-fit connection). The posts 4206 have different lengths and/or curvatures, which provide different amounts of advancement in the anterior and vertical direction. For example, the posts 4206 may provide different levels of advancement in 1 millimeter increments. The patient may select a post 4206 that provides a desired amount of advancement and couple that post 4206 to the lower arch 4204. The patient may then couple an end of the post 4206 to the ring 4216 of the receiving mechanism 4214. When the patient desires a different level of advancement, the patient selects a different post 4206.

FIG. 42K illustrates the post 4206 engaged with the lower frame 4226. As seen in FIG. 42K, the coupler 4230 of the post 4206 engages with the receiver 4224 of the lower frame 4226. For example, the coupler 4230 may form a snap-fit connection with the receiver 4224. In some embodiments, the post 4206 may rotate about the snap-fit connection. When the post 4206 is engaged with the receiver 4224, the post 4206 extends in an anterior direction.

In some embodiments, the oral appliance 4200 includes a bilateral coupler to couple the upper arch 4202 to the lower arch 4204 instead of a receiving mechanism 4214 and a post 4206. The oral appliance 4200 may include couplers on the upper arch 4202 and the lower arch 4204, on opposite sides of the midlines of the upper arch 4202 and the lower arch 4204. The couplers on the upper arch 4202 engage the couplers on the lower arch 4204 to couple the upper arch 4202 to the lower arch 4204.

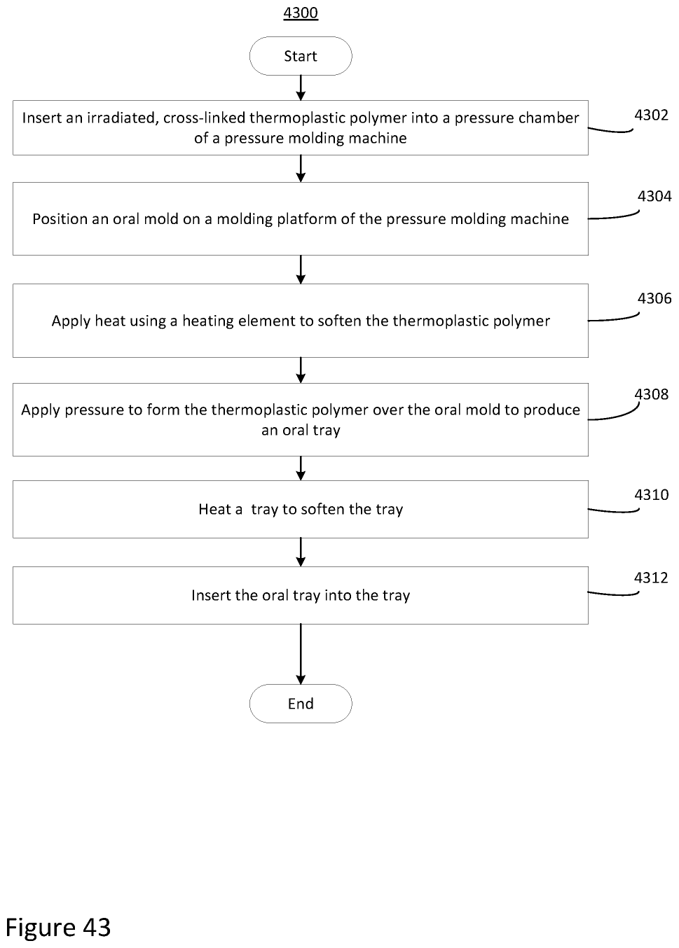

FIG. 43 is a flowchart of an example method 4300 for forming an oral appliance 4200. An operator in a dental lab or dentist office may perform the method 4300. In particular embodiments, the oral appliance 4300 may be used to treat breathing disorders in a patient (e.g., sleep apnea).

In step 4302, the operator inserts an irradiated, cross-linked thermoplastic polymer into a pressure chamber of a pressure molding machine. For example, the operator may insert the disk 3500 into the pressure molding machine 3650 described with respect to FIGS. 35 through 38. The thermoplastic polymer may be polycaprolactone (PCL) and may soften to be moldable when heated to between 40 and 80 degrees Celsius. The thermoplastic polymer may be in the form of a disk or a sheet with a thickness between 0.5 mm and 2.0 mm. In step 4304, the operator positions an oral model (e.g., oral model 3600) on a molding platform of the pressure molding machine 3650. The oral model may be a mold of a patient's teeth or dentition. The oral model may be created by a dentist taking the patient's dental impression. Alternatively, the oral model may be created by a dental lab shaping plaster based on a dental impression. The oral model may be cast or printed.

In step 4306, the operator applies heat using a heating element to soften the thermoplastic polymer. The operator then applies pressure (e.g., through vacuum or blowdown) on the thermoplastic polymer to form the thermoplastic polymer over the oral model to produce an oral tray in step 4308. In this manner, the thermoplastic polymer is shaped to fit over the oral model of the user's dentition to form an oral tray (e.g., an upper or lower tray).

In step 4310, the operator heats an upper tray 4210 or a lower tray 4220 to soften the upper tray 4210 or the lower tray 4220. When the upper tray 4210 or lower tray 4220 is heated, the operator inserts the oral tray into an upper channel 4212 of the upper tray 4210 or a lower channel 4222 of the lower tray 4220 in step 4312. The oral tray may adhere to the upper tray 4210 or the lower tray 4220 (e.g., by bonding to the upper tray 4210 or the lower tray 4220). The oral appliance 4200 is then configured to receive the patient's upper or lower dentition. This process may be repeated to configure the oral appliance 4200 to receive the other dentition of the patient.

In some embodiments, the operator further trims the upper tray 4210 or the lower tray 4220 according to the upper or lower gumline of the patient. In this manner, the oral appliance 4200 better fits within the patient's mouth and improves the comfort of the patient.

Although the present invention has been described above in connection with several embodiments, changes, substitutions, variations, alterations, transformations, and modifications may be suggested to one skilled in the art, and it is intended that the present invention encompass such changes, substitutions, variations, alterations, transformations, and modifications as fall within the spirit and scope of the appended claims.

What is claimed is:

1. A method comprising:
inserting an irradiated, cross-linked thermoplastic polymer into a pressure chamber of a pressure molding machine;
positioning an oral model on a molding platform of the pressure molding machine;
applying heat using a heat element to soften the thermoplastic polymer;
applying pressure to form the thermoplastic polymer over the oral model to produce a tray;
heating an arch to soften the arch, the arch comprising a channel; and
inserting the tray into the channel such that the arch adheres to the tray.

2. The method of claim 1, further comprising coupling a post to the arch such that the post extends from the arch in an anterior direction and an inferior direction when the arch is positioned in a user's mouth.

3. The method of claim 2, further comprising:
inserting a second irradiated, cross-linked thermoplastic polymer into the pressure chamber;
positioning a second oral model on the molding platform;
applying heat using the heat element to soften the second thermoplastic polymer;
applying pressure to form the second thermoplastic polymer over the second oral model to produce a second tray;
heating a second arch to soften the second arch, the second arch comprising a second channel; and
inserting the second tray into the second channel such that the second arch adheres to the second tray, the second arch further comprising a receiving mechanism configured to extend from the second arch in an anterior direction when the second arch is positioned in the user's mouth, wherein the receiving mechanism is configured to engage the post such that the post extends through the receiving mechanism.

4. The method of claim 3, wherein the post is configured to engage an adjustment mechanism when the post is extending through the receiving mechanism such that the adjustment mechanism is operable to adjust a forward position of the arch relative to the second arch when the arch and the second arch are positioned in the user's mouth.

5. The method of claim 2, wherein the post is coupled to the arch by a snap-fit connector such that the post is rotatable about the snap-fit connector.

6. The method of claim 5, further comprising decoupling the post from the arch.

7. The method of claim 2, wherein the post comprises a threaded portion and wherein the threaded portion is curved in an inferior direction.

8. The method of claim 1, wherein the thermoplastic polymer softens to be moldable to a shape of the oral model when the thermoplastic polymer is heated to to 80 degrees Celsius.

9. The method of claim 1, wherein the tray is between the arch and a dental arch of a user when the arch is positioned in the user's mouth.

10. The method of claim 1, further comprising trimming the arch according to a gumline of a user.

11. The method of claim 1, further comprising coupling a first coupling mechanism and a second coupling mechanism to the arch on opposite sides of a midline of the arch.

12. A method comprising:
applying heat to soften an irradiated, cross-linked thermoplastic polymer positioned in a pressure chamber of a pressure molding machine;
forming the softened thermoplastic polymer over an oral model positioned on a molding platform of the pressure molding machine to produce a tray; and
inserting the tray into an arch such that the arch adheres to the tray.

13. The method of claim 12, further comprising coupling a post to the arch such that the post extends from the arch in an anterior direction and an inferior direction when the arch is positioned in a user's mouth.

14. The method of claim 13, further comprising:
applying heat to soften a second irradiated, cross-linked thermoplastic polymer positioned in the pressure chamber;
applying pressure to form the softened second thermoplastic polymer over a second oral model positioned on the molding platform to produce a second tray; and
inserting the second tray into a second arch such that the second arch adheres to the second tray, the second arch comprising a receiving mechanism configured to extend from the second arch in an anterior direction when the second arch is positioned in the user's mouth, wherein the receiving mechanism is configured to engage the post such that the post extends through the receiving mechanism.

15. The method of claim 14, wherein the post is configured to engage an adjustment mechanism when the post is extending through the receiving mechanism such that the adjustment mechanism is operable to adjust a forward position of the arch relative to the second arch when the arch and the second arch are positioned in the user's mouth.

16. The method of claim 13, wherein the post is coupled to the arch by a snap-fit connector such that the post is rotatable about the snap-fit connector.

17. The method of claim 16, further comprising decoupling the post from the arch.

18. The method of claim 13, wherein the post comprises a threaded portion and wherein the threaded portion is curved in an inferior direction.

19. The method of claim 12, wherein the thermoplastic polymer softens to be moldable to a shape of the oral model when the thermoplastic polymer is heated to to 80 degrees Celsius.

20. An apparatus comprising:
a first arch;
a first tray coupled to the first arch, the first tray comprising an irradiated, cross-linked thermoplastic polymer shaped according to a first oral model;
a post coupled to the first arch by a snap-fit connector such that the post is rotatable about the snap-fit connector and such that the post extends from the first arch in an anterior direction and an inferior direction when the first arch is positioned in a user's mouth;
a second arch;
a second tray coupled to the second arch, the second tray comprising an irradiated, cross-linked thermoplastic polymer shaped according to a second oral model; and
a receiving mechanism on the second arch that extends from the second arch in an anterior direction when the second arch is positioned in the user's mouth, wherein the receiving mechanism is configured to engage the post such that the post extends through the receiving mechanism, and wherein the post is configured to engage an adjustment mechanism when the post is extending through the receiving mechanism such that the adjustment mechanism is operable to adjust a forward position of the first arch relative to the second arch when the first arch and the second arch are positioned in the user's mouth.
